(19) United States
(12) Patent Application Publication
(10) Pub. No.: US 2026/0044830 A1
(43) Pub. Date: Feb. 12, 2026

(54) SYSTEM, METHOD, AND APPARATUS FOR SERVICING INQUIRIES USING A FREELANCE WORK GROUP

(71) Applicant: Limitless Technology Group Ltd., Esher (GB)

(72) Inventors: Roger James Beadle, Cobham (GB); Megan Elizabeth Jane Neale, London (GB); Paul James Widden, Berkshire (GB); James Edward Cozens, Surrey (GB)

(21) Appl. No.: 19/361,561

(22) Filed: Oct. 17, 2025

Related U.S. Application Data
(63) Continuation of application No. PCT/GB2024/051122, filed on Apr. 26, 2024.
(60) Provisional application No. 63/462,579, filed on Apr. 28, 2023.

(51) Int. Cl. G06Q 10/1053; G06Q 30/0601

(52) U.S. Cl. CPC G06Q 10/1053; G06Q 30/0625

(57) ABSTRACT

Systems and procedures disclosed herein relate to a freelance service management platform including a freelance worker definition component configured to interpret a freelance work group comprising a plurality of freelance workers, a work intake component configured to interpret a work request, a worker segmentation component configured to determine a plurality of worker segments in response to the freelance work group, and a work dispatch component configured to differentially offer a resolution action to the work request to the plurality of worker segments, and repeating the differentially offering until at least one freelance worker accepts the resolution action.

### CLAIM TO PRIORITY

This application claims priority to and is a continuation of International Patent Application Serial No. PCT/GB2024/051122, filed on Apr. 26, 2024, now published on Oct. 31, 2024 as WO 2024/224108 (Attorney Docket No. LMTL-0001-WO).

International Patent Application Serial No. PCT/GB2024/051122 claims priority to U.S. Provisional Application Ser. No. 63/462,579, filed Apr. 28, 2023 (Attorney Docket No. LMTL-0001-P01).

Each of the foregoing applications is incorporated herein by reference in its entirety for all purposes.

### BACKGROUND

Presently known systems for engaging freelance workers suffer from a number of challenges, including maintaining flexibility of work for freelance workers, and ensuring that a sufficient number of freelance workers with the appropriate technical and soft skills to support prompt and high quality customer service participate with the system.

### SUMMARY

Embodiments of the present disclosure support the provision of providing an agile, passionate, and readily available pool of workers to provide satisfying outcomes for the workers while ensuring excellent customer service on behalf of brands and/or companies. Embodiments herein further provide management of a freelance, distributed work force that provides prompt, knowledgeable customer service with a high quality customer experience.

Embodiments herein to match work elements to a freelance work group improve the operation of computing devices by greatly reducing the processing operations, memory utilization (e.g., including intermediate memory utilization), and network communications required to determine available freelance workers that are capable to respond to the work request, and to match an appropriate and accepting freelance worker to the work request. For example, worker segmentation and/or other matching operations performed on the work group reduce the number of workers, evaluations of worker properties, and comparisons of properties between workers, that need to be performed to provide quality segmentation and matching that is likely to be successful in responding to the work request with high quality and responsiveness, as well as preserving system resources for determinations which enhances the capacity of the system to service work requests and improves the response time for those work requests. Additionally, utilization of a freelance work group improves the outcomes of related embodiments by allowing for practical determination of worker segments, and utilizing the worker segments to improve customer response times, freelance worker satisfaction, and quality of resolution actions performed on behalf of the customer and/or other beneficiary of the work request. Example embodiments include, without limitation, embodiments set forth in FIGS. 1-11 and the related descriptions.

Embodiments herein to perform scheduled matching of work requests to freelance workers improve the operation of computing devices by reducing the processing operations, memory utilization, and network communications required to perform matching of freelance workers to work requests in a manner that is likely to be responsive and successful. The utilization of worker segments allows for the creation of blocks of workers that can perform in a statistically predictable manner, while performing evaluation, comparison, and communication operations with a smaller subset of all available workers, allowing the system/platform/component, or other embodiment herein to perform such operations more quickly, efficiently, utilizing reduced computing resources, and/or improving the outcome of such operations utilizing a given amount of computing resources. The scheduled matching provides for flexibility in offering resolution actions for work requests between various worker segments, allowing for the progression time (and/or any other progression parameter) between segments, the progression staging between segments (e.g., offering serially to the segments, adding segments to the offering, keeping a rolling buffer of offered segments, offering certain work requests to segments in an alternative sequencing, etc.), and/or providing flexibility of these in response to operating conditions of the platform (e.g., the total number of active work requests, time of day, calendar, time, etc.). Additionally or alternatively, the scheduled matching provides a framework for iterative improvement of matching operations over time, for example based on expert analysis, artificial intelligence operations, machine learning operations, or the like, which may be based on any properties available to the platform and that relate to freelance workers and/or the work requests. Example embodiments include, without limitation, embodiments set forth in FIGS. 1-11, and 25-38, and the related descriptions.

Embodiments herein to organize a freelance worker corpus into freelance work groups and/or worker segments provide, without limitation, any one or more of the foregoing benefits as set forth preceding. Example embodiments include, without limitation, embodiments set forth in FIGS. 39-40, and the related descriptions.

Embodiments herein to match freelance workers to work requests provide, without limitation, any one or more of the foregoing benefits as set forth preceding. Example embodiments include, without limitation, embodiments set forth in FIGS. 41-47.

Embodiments herein to classify work requests for urgency provide, without limitation, any one or more of the foregoing benefits as set forth preceding. Additionally or alternatively, utilization of urgency values for work requests allows for the platform to provide excellent and responsive customer service without requiring that the platform perform perfectly on matching of work requests, and/or during time periods where operations to determine work groups, segments, segment schedules, and/or other operations in a matching sequence are converging on optimal outcomes, after recent changes in platform conditions that are not yet reflected in the matching sequence, and/or while iterative improvement operations for the matching sequence are still in a response period for such changes. Example embodiments include, without limitation, embodiments set forth in FIGS. 48-51, and the related descriptions.

Embodiments herein set forth granular and high quality creation of worker segments, which may be performed periodically, at selected times, in response to events (e.g., the addition or removal of freelance workers from the corpus, changes in freelance worker properties, changes in the content, frequency, source, and/or properties of work requests, etc.), and/or continuously (e.g., performed for each work request, and/or for related similar batches of work requests, etc.). Such embodiments provide, without limitation, any one or more of the foregoing benefits as set forth preceding, and may enhance be utilized, in whole or part, with any other embodiments, in whole or part, as set forth throughout the present disclosure. Example embodiments include, without limitation, embodiments set forth in FIGS. 12-24, and the related descriptions.

Embodiments herein to provide configurable rewards to freelance workers completing resolution actions for work requests enhance the performance and/or outcomes of other embodiments as set forth herein, and provide, without limitation, any one or more of the foregoing benefits as set forth preceding. Example embodiments include, without limitation, embodiments set forth in FIGS. 49, 52-54, and the related descriptions.

Embodiments herein to provide divisible rewards to freelance workers completing resolution actions for work requests, for example where more than one worker contributes resolution actions, and/or portions thereof, for work requests, enhance the performance and/or outcomes of other embodiments as set forth herein, and provide, without limitation, any one or more of the foregoing benefits as set forth preceding. Example embodiments include, without limitation, embodiments set forth in FIGS. 55-63, and the related descriptions.

Embodiments herein provide for flexible rewards to freelance workers completing resolution actions for work requests, which may be based on, without limitation to any other aspect of the present disclosure, a difficulty of the actions, quality of the actions, overall contribution of the freelance worker(s) to the platform, properties of the worker and/or work request, or the like. Such embodiments provide additional levers to improve the effectiveness of segmentation and/or matching operations to achieve any of the foregoing benefits, and/or allow for improved response times, response quality, and/or customer satisfaction, with reduced computing resources to perform matching operations and facilitate completion of the resolution actions. Example embodiments include, without limitation, embodiments set forth in FIGS. 64-71, and the related descriptions.

Embodiments herein provide for incentive based actions on the platform, providing additional levers to improve the effectiveness of segmentation and/or matching operations to achieve any of the foregoing benefits, and/or allow for improved response times, response quality, customer satisfaction, and/or maintenance of health values (e.g., corpus, work group, and/or segment) on the platform. Operations to maintain the health values reduce the ongoing utilization of computing resources by reducing time to solicit and/or maintain freelance worker engagement, as well as improving response times, quality, and customer satisfaction by preventing or reducing disruptive periods that would result from other mechanisms that repair the health values in a feedback manner after health values have deteriorated. Example embodiments include, without limitation, embodiments set forth in FIGS. 72-76, and the related descriptions.

Embodiments herein provide for quality management to determine resolution action quality, and to support quality improvements utilizing reward mechanisms, adjusting segmentation operations, segmentation scheduling, or the like. Such embodiments provide additional levers to improve the effectiveness of segmentation and/or matching operations to achieve any of the foregoing benefits, and/or allow for improved response times, response quality, and/or customer satisfaction, with reduced computing resources to perform matching operations and facilitate completion of the resolution actions. Example embodiments include, without limitation, embodiments set forth in FIGS. 77-82, and the related descriptions.

Embodiments herein provide for technical aspects that improve freelance worker productivity, engagement, and performance with the platform, including for example providing tools to readily accept work requests, monitor activity on the platform, track resolution aspects that are contributing to success or detracting from success on the platform, productivity tools to perform resolution actions, or the like. In certain embodiments, such aspects may include a customizable dashboard, engagement interfaces, and/or worker assistance components. Such embodiments provide additional levers to improve the effectiveness of segmentation and/or matching operations to achieve any of the foregoing benefits, and/or allow for improved response times, response quality, and/or customer satisfaction, with reduced computing resources to perform matching operations and facilitate completion of the resolution actions. Additionally or alternatively, such embodiments reduce the resources utilized to maintain health values, recruit freelance workers to the platform, and improve overall performance of freelance workers on the platform. Example embodiments include, without limitation, embodiments set forth in FIGS. 24, 83-90, 95-97, and the related descriptions.

Embodiments herein provide for technical aspects to determine health values for the corpus, work groups, and/or worker segments, and/or to maintain and/or improve the health values. Such embodiments improve the overall health of the platform, resulting in improved work request response times, freelance worker satisfaction, improved customer satisfaction, reduced resource utilization to respond to off-nominal conditions (e.g., enhanced rewards, high utilization of urgency schemes, etc.), and/or reduced resource utilization to respond to platform disruptions such as emergency recruiting operations. In certain embodiments, the determination and management of health values improve the operations of any of the foregoing embodiments, and/or provide additional levers to improve on any of the foregoing benefits. Example embodiments include, without limitation, embodiments set forth in FIGS. 91-94, and the related descriptions.

Any improvements, benefits, or the like, as set forth foregoing, are non-limiting examples. Any particular benefit may be present in certain embodiments, and not present in another embodiment. Further, additional benefits and/or improvements may be relevant to listed embodiments, or other embodiments.

These and other systems, methods, objects, features, and advantages of the present disclosure will be apparent to those skilled in the art from the following detailed description of the preferred embodiment and the drawings.

All documents mentioned herein are hereby incorporated in their entirety by

reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts an example system for servicing customer related work elements.

FIG. 2 depicts a schematic of an example data store.

FIG. 3 depicts a schematic of an example data store.

FIG. 4 depicts an example system including a freelance service management platform.

FIG. 5 depicts example work requests.

FIG. 6 depicts an example procedure to offer a resolution action to a work request to worker segments until it is accepted.

FIG. 7 depicts an example flowchart to offer a resolution action to a work request to worker segments until it is accepted.

FIG. 8 depicts an example procedure to determine a work request as a customer inquiry in response to customer interactions with a customer request interface.

FIG. 9 depicts an example procedure to interpret a worker disengagement communication, optionally update a work request, optionally update worker segments, and offer a resolution action.

FIG. 10 depicts an example procedure to adjust a freelance work group in response to worker interactions with a worker engagement interface.

FIG. 11 depicts an example procedure to implement a worker engagement interface, and adjust the plurality of worker segments in response to worker interactions with the worker engagement interface.

FIG. 12 depicts an example system including an example freelance service management platform.

FIG. 13 depicts examples of a platform capability value.

FIG. 14 depicts an example system including an example freelance service management platform.

FIG. 15 depicts examples of a capacity trajectory.

FIG. 16 depicts examples of a responsiveness trajectory.

FIG. 17 depicts examples of the work request property.

FIG. 18 depicts examples of the work request quality of service.

FIG. 19 depicts an example procedure of determining a plurality of worker segments.

FIG. 20 depicts an example procedure of determining a plurality of worker segments.

FIG. 21 depicts an example procedure of determining a plurality of worker segments.

FIG. 22 depicts an example procedure of determining a plurality of worker segments.

FIG. 23 depicts example worker properties.

FIG. 24 depicts an example procedure for providing a productivity communication including a worker dialog prompt.

FIG. 25 depicts an example system including an example freelance service management platform.

FIG. 26 depicts example worker properties.

FIG. 27 depicts example work capacity values.

FIG. 28 depicts an example procedure of determining individual worker capacity/responsiveness, determining segment capacity/responsiveness, and determining platform capacity/responsiveness.

FIG. 29 depicts the capacity/responsiveness of various segments on a bar graph.

FIG. 30 depicts the capacity/responsiveness of various segments on a bar graph.

FIG. 31 depicts the capacity/responsiveness of various segments on a bar graph.

FIG. 32 depicts the capacity/responsiveness of various segments on a bar graph.

FIG. 33 depicts the capacity/responsiveness of various segments on a bar graph.

FIG. 34 depicts an example procedure offering a resolution action to a work request to worker segments, and repeating the offering until at least one freelance worker accepts the resolution action.

FIG. 35 depicts an example procedure of determining the plurality of worker segments further in response to the segment capacity values.

FIG. 36 depicts an example procedure of determining/adjusting worker segments having a selected capacity trajectory.

FIG. 37 depicts an example procedure of determining/adjusting worker segments having a selected responsiveness trajectory.

FIG. 38 depicts an example procedure of updating the work history of the at least one freelance worker that accepted the resolution action in response to the resolution action completion value.

FIG. 39 depicts an example system including an example freelance service management platform.

FIG. 40 depicts an example procedure of determining a plurality of worker segments in response to the freelance work group and the plurality of worker properties.

FIG. 41 depicts an example system including an example freelance service management platform.

FIG. 42 depicts examples of worker segments.

FIG. 43 depicts examples of customer inquiry properties.

FIG. 44 depicts an example procedure of differentially offering a resolution action to a customer inquiry to a plurality of worker segments, and repeating the differentially offering until at least one freelance worker accepts the resolution action.

FIG. 45 depicts an example procedure of selecting a predetermined worker segmentation in response to a comparison of properties between a selected customer inquiry and the customer inquiry.

FIG. 46 depicts an example procedure of adjusting a predetermined worker segmentation in response to a comparison of properties between the selected customer inquiry and the customer inquiry.

FIG. 47 depicts an example procedure of updating selected predetermined worker segmentations in response to properties of a customer inquiry.

FIG. 48 depicts an example freelance service management platform.

FIG. 49 depicts example customer inquiries.

FIG. 50 depicts example urgency values.

FIG. 51 depicts an example procedure for differentially offering a resolution action.

FIG. 52 depicts an example freelance service management platform.

FIG. 53 depicts an example procedure for differentially offering a resolution action.

FIG. 54 depicts an example procedure for adjusting the reward value in response to a change value.

FIG. 55 depicts an example freelance service management platform.

FIG. 56 depicts example contribution values.

FIG. 57 depicts an example procedure for distributing reward values to workers.

FIG. 58 depicts an example procedure for tracking contribution values.

FIG. 59 depicts an example procedure for tracking contribution values.

FIG. 60 depicts an example procedure for tracking contribution values.

FIG. 61 depicts an example procedure for tracking contribution values.

FIG. 62 depicts an example procedure for providing a reward index value to freelance workers.

FIG. 63 depicts an example procedure for providing a reward description to freelance workers.

FIG. 64 depicts an example freelance service management platform.

FIG. 65 depicts example platform operating conditions.

FIG. 66 depicts an example procedure for differentially offering a resolution action.

FIG. 67 depicts an example relationship between reward value and incrementing parameter.

FIG. 68 depicts an example relationship between reward value and incrementing parameter.

FIG. 69 depicts an example relationship between reward value and incrementing parameter.

FIG. 70 depicts an example relationship between reward value and incrementing parameter.

FIG. 71 depicts an example relationship between reward value and incrementing parameter.

FIG. 72 depicts an example freelance service management platform.

FIG. 73 depicts example incentive communications.

FIG. 74 depicts example incentive values.

FIG. 75 depicts an example procedure for providing an incentive communication to at least one worker of a corpus of freelance workers.

FIG. 76 depicts an example of procedure for providing an incentive communication to at least one worker of a corpus of freelance workers in response to an incentive value.

FIG. 77 depicts an example freelance service management platform.

FIG. 78 depicts an example procedure for determining a response quality value for the accepting freelance worker.

FIG. 79 depicts an example procedure for adjusting the worker segments in response to the response quality value.

FIG. 80 depicts an example procedure for determining a reward value in response to the response quality value.

FIG. 81 depicts an example procedure for adjusting a work history of accepting freelance workers in response to the response quality value and/or a property of the customer inquiry.

FIG. 82 depicts an example procedure for determining a response quality value for the accepting freelance workers.

FIG. 83 depicts an example freelance service management platform.

FIG. 84 depicts an example assistance dashboard.

FIG. 85 depicts an example worker engagement interface.

FIG. 86 depicts example notifications and/or alerts.

FIG. 87 depicts an example procedure for updating the assistance dashboard for the freelance worker on the worker engagement interface in response to acceptance and/or completion of the resolution action.

FIG. 88 depicts an example freelance service management platform.

FIG. 89 depicts an example procedure for assigning a new user to at least one worker segment in response to a property of the new user.

FIG. 90 depicts an example procedure for providing a notification to a prospective new user and/or to an existing freelance worker in response to a need value.

FIG. 91 depicts an example freelance service management platform.

FIG. 92 depicts example crowd health values.

FIG. 93 depicts an example procedure for performing a crowd health management operation in response to a crowd health value.

FIG. 94 depicts example crowd health management operations.

FIG. 95 depicts an example freelance service management platform.

FIG. 96 depicts example productivity communications.

FIG. 97 depicts an example procedure for providing a productivity communication on the worker engagement interface.

### DETAILED DESCRIPTION

The modern workforce has fundamentally changed, including in the customer service field. Systems and procedures disclosed herein enable distributed labor models and workforce structures while managing to the performance standards and ultimately the bottom line. Systems and procedures disclosed herein enable empowering freelance workers to earn money for providing brilliant customer service for brands they love. Organizations can route their customer service inquiries securely from their own systems through the disclosed platform, which distributes them to a crowd of knowledgeable gig experts who can answer questions and provide support on behalf of the brands they know and love. The result is a more authentic, genuine experience for customers and improved customer satisfaction for brands that use the disclosed platform. The corpus of freelance workers can flex with demand, reducing timeouts and wastage, and giving greater resilience during unexpected events.

Example embodiments herein are configured to operate a platform that services inquiries using a freelance work group. Example inquiries include customer inquiries relating to specific products, brands, services, or the like, and may include inquiries of any type, including customer service inquiries, technical assistance inquiries, scheduling or appointment inquiries, subscription inquiries, and/or combinations of one or more of these. The example inquiries are non-limiting examples, and any type of inquiry that may relate to a product, service, company, entity, brand, industry, technology, or the like are contemplated herein. Throughout the present disclosure, work elements are described for clarity, which may include customer inquiries, and/or platform supporting work elements that may be assigned to freelance workers, such as peer review operations for work elements, and/or quality review operations for work elements.

The term freelancer, freelance worker, and/or related terminology, as utilized herein, should be understood broadly. Without limitation to any other aspect of the present disclosure, a freelancer includes a user of the platform that responds to inquiries, that is capable to respond to inquiries, that engages the platform with the intent to respond to inquiries, and/or that engages the platform with the intent to evaluate inquiries and potentially respond to inquiries. In certain embodiments, a freelancer has one or more distinguishing characteristics from other potential customer service, troubleshooting, experts, or user types that perform similar functions and/or have similar roles. For example, a freelancer may have one or more characteristics such as: the freelancer utilizes equipment that is owned by, or otherwise provided or obtained by the freelancer, and/or that is provided, accessed, or obtained independently of any engagement with the platform; the freelancer has or obtains training, credentials, certifications, or other knowledge aspects independently of any engagement with the platform; the freelancer is not constrained in hours of working (e.g., time spent evaluating or responding to inquiries, and/or developing any knowledge aspects that may be useful in evaluating or responding to inquiries) in relation to the platform; the freelancer is not constrained in taking time away from engagement with the platform; the freelancer is not required to engage with the platform on any scheduled basis; the freelancer is not constrained from choosing to respond to, evaluate, or engage with inquiries on the platform (except as otherwise set forth throughout the present disclosure-for example the freelancer may only have access to a subset of available inquiries, and/or may access inquiries in response to an invitation from the platform and/or in response to exposed inquiries by the platform for that freelancer, which may be as a part of a group of freelancers as set forth herein); and/or the freelancer may be freely able to disengage with an inquiry at any time, including for example after the freelancer has initiated actions to respond to a particular inquiry. In certain embodiments, operations of the platform may promote one or more additional aspects of engagement with freelancers, such as: promotion of freelancer compensation to avoid dependency of freelancer compensation on a single client and/or a limited set of clients; promotion of transparency of freelancer compensation before commitment of the freelancer to a work element; freelancer engagement with the platform that is free from performance management processes; freelancer engagement with the platform that is free from disciplinary processes; freelancer engagement with the platform that is free from tracking of hours and/or regular work patterns; and/or ensuring that freelancer compensation meets scheduled minimums based on actual time spent performing work elements on the platform. In certain embodiments, a platform is configured to work with freelancers with one or more, or all, of the freelancer aspects described preceding. In certain embodiments, a platform is configured to work with freelancers without one or more of the aspects of a freelancer as set forth preceding, which nevertheless yields some of the benefits of embodiments herein. In certain embodiments, characteristics of engagement of the platform with a freelancer includes engagement sufficient for the freelancer to be classified as a contractor, or non-employee, with regard to the platform and/or with regard to clients or administrators of the platform. In certain embodiments, characteristics of engagement of the platform with a freelancer includes engagement with one or more freelancers that are employees, with regard to the platform and/or with regard to clients or administrators of the platform, but the engagement nevertheless yields certain benefits over previously known systems, for example providing employees with benefits relating to flexible scheduling, compensation transparency, and/or selected work culture elements (e.g., employee work quality feedback, guidance for improvement, work-life balance support, etc.). Accordingly, embodiments are explicitly contemplated wherein freelancers are not employees, where freelancers are or may be considered to be employees, and/or a combination thereof. One of skill in the art can readily configure a platform, and engagement operations with the platform, to determine which aspects of a freelancer are supported on the particular platform, including whether any or all freelancers on the platform are contractors or employees. Certain considerations for determining which aspects of a freelancer are embodied in the platform and the engagement strategy for the platform include, without limitation: the quantity, type, and nature (e.g., activity that is typically performed to respond to an inquiry) of customer inquiries on the platform, including the distribution of inquiries among clients of the platform; the compensation model of inquiry responses; the quality control scheme of inquiry responses; the intended working model of freelancers (e.g., contractors versus employees); the time sequencing and distribution of customer inquiries on the platform (e.g., how many inquiries come in according to time-of-day, calendar date, day-of-the-week, average inquiry rates, peak inquiry rates, inquiry gap times, etc.); and/or distinct requirements between clients and/or inquiries to qualify freelancers to respond to inquiries (e.g., certifications, security clearances, technical expertise requirements, access requirements to tools, proprietary information, databases, etc.). In certain embodiments, one or more classes of freelancers may engage with a particular platform at different times and/or during distinct operating conditions, where each of the one or more classes of freelancers may have distinct aspects on the platform, for example with a first class of freelancers having full capability to disengage from a customer inquiry at any time, with a second class of freelancers having some constraint from disengaging from a customer inquiry at some point in a customer inquiry response workflow. In certain embodiments, a given freelancer may be considered as being in different freelancer classes at different times and/or at distinct operating conditions-for example a freelancer that is in a first freelancer class with regard to a first client, and in a second freelancer class with regard to a second client.

The term client as utilized herein should be understood broadly. A client, as used herein, includes an entity that provides customer inquiries to the platform for resolution. The client may be a beneficiary of the platform, for example where customer inquiries for the client are serviced directly by the platform without direct engagement by the client (e.g., client service requests are routed directly to the platform, without direct client involvement). Additionally or alternatively, the client may utilize the platform to service customer inquiries in a process where the client may be directly engaged, for example where the client routes received customer inquiries to the platform, which may be all of the customer inquiries received by the client, and/or a portion of customer inquiries received by the client—for example where the client routes customer inquiries of a particular type, inquiries that require certain resources or expertise to respond, and/or general inquiries that are routed to the platform for process reasons (e.g., overflow inquiries, inquiries at particular times, days of the week, calendar dates, etc.). In certain embodiments, a client may be an identifiable entity, such as a company, organization, corporation, etc. In certain embodiments, a client may be a related group of entities, whether specifically identifiable or not, for example all products and/or services related to a specific brand, related to an industry, related to a particular project, or the like.

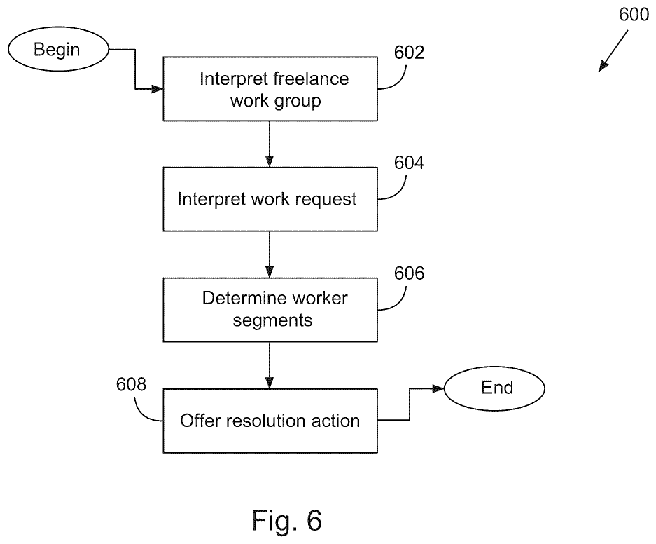

A number of example procedures, methods, operations, or the like are set forth throughout the present disclosure. Any such procedures, for example and without limitation as set forth in FIGS. 6-11, 19-22, 24, 28, 34-38, 40, 44-47, 51, 53-54, 57-63, 66, 75-76, 78-82, 87, 89-90, 93, 97, and the related descriptions, may be performed, in whole or part, by any system, platform, component, processor, apparatus, computing device, or portion thereof, as set forth throughout the present disclosure.

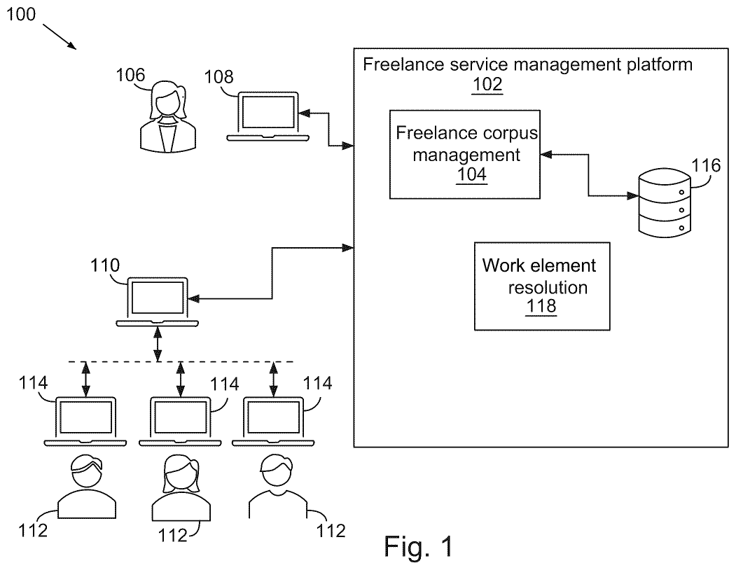

Referencing FIG. 1, an example system 100 for servicing customer related work elements, for example customer inquiries, interacting with a corpus of freelance workers is schematically depicted. The example system 100 includes a freelance service management platform 102 having a number of components configured to functionally execute operations of the platform 102. The platform 102 is communicatively coupled to various users and/or supported systems of the platform 102 (e.g., freelance workers, client users, client systems, external data storage, external devices, customer users, etc.), which may be through any communication means including wired network communications, wireless network communications, cellular communications (e.g., for direct communications to devices for clients, administrators, freelance workers, etc.), internet based communications, web portal communications, and/or mobile application based communications. The platform 102 is depicted as a single device for clarity of the present description, but the platform 102 may be implemented, in whole or part, as a distributed device, for example utilizing external resources such as data storage and/or processing resources, servers, or the like. Similarly, components of the platform 102 are depicted as single individual devices for clarity of the present description, but a given component may be implemented, in whole or part, as a distributed element of the system 100, for example positioned in whole or part on distributed elements of the platform 102, and/or on user devices in communication with the platform 102, and/or such embodiments may be considered as having a portion of the platform 102 positioned on such user devices. In certain embodiments, the location of the platform 102 and/or components thereof may change over time (e.g., depending on supporting servers, connected devices, etc. on different days or times of the day) and/or based upon operating conditions (e.g., a component of the platform 102 may be installed on a user device during certain operations, and removed at a later time and/or based on certain events such as updates, user login/logout operations, uninstall operations by the user, and/or in response to expiration of a time period). The specific configurations and relationships between the platform 102, external devices, user devices, and the like as depicted herein are non-limiting examples utilized to provide a specific context for the present disclosure to enhance the clarity of the description.

The example platform 102 includes a freelance corpus management 104 component. Components, as set forth herein, include any combination of processors, computing devices, circuits, sensors, input/output devices, communication infrastructure, any other hardware devices, logic circuits, and/or aspects configured as computer readable instructions executable by a processor to perform one or more operations of the component, arranged and/or in communication that, taken together, perform the operations set forth for a given component. The constituent elements of a given component may change over time and/or operating conditions, for example due to utilizing different servers, installing or removing portions of the component on devices, performing updates, corrections, or upgrades to computer readable instructions, or the like. The example freelance corpus management 104 component is configured to perform operations to communicate with freelance workers 106 (e.g., via communications with a freelance user device 108), including operations to perform intake (e.g., registering the freelance worker 106 with the platform 102; determine information associated with individual freelance workers 106 such as technical skills, certifications, brand affinities, or the like; and/or determine contact information and/or communication preferences), operations related to accepting, addressing, and/or responding to inquiries, and/or any other interactions between the platform 102 and freelance workers 106. In certain embodiments, operations of the freelance corpus management 104 component include direct communications, such as through phone calls, e-mails, messages, or the like, and/or through a web portal (e.g., the freelance worker 106 logs in to a web portal implemented, at least in part, by the freelance corpus management 104 component), through a mobile application, and/or over network communications with the freelance user device 108, for example communicating with an application installed on the freelance user device 108.

The freelance corpus management 104 component retains a corpus of freelance workers, for example on a data store 116, and which may include an identifier for each freelance worker, properties and/or preferences for each freelance worker, a history of activity for each freelance worker, or the like. In certain embodiments, the corpus of freelance workers includes all workers eligible to perform work elements of any type at a given time, prospective workers that are working to become eligible, and/or workers that are temporarily ineligible to perform work elements on the platform, but may become eligible at a later time. In certain embodiments, the corpus of freelance workers may be formally maintained, for example with a registry of available workers for the platform, and with workers added or removed from the data store 116. In certain embodiments, the corpus of freelance workers may be informally maintained, generated in real time as needed (e.g., surveying for eligible workers in response to pending work elements), or a combination of these. Work elements for the platform can include any work elements as set forth throughout the present disclosure, including at least: responses and resolution of customer inquiries; peer review of responses and resolution of customer inquiries; and/or quality review tasks.

An example freelance corpus management 104 component interprets a corpus of freelance workers in response to determining a work element is requested-for example a customer inquiry, a peer review work element, and/or a quality review element. In certain embodiments, operations to interpret the corpus of freelance workers includes accessing a registry of available freelance workers on the data store 116, building the corpus of freelance workers by querying the data store 116, or performing similar operations. In certain embodiments, the freelance corpus management 104 component will filter and/or sort available freelance workers to determine the corpus of freelance workers, for example utilizing criteria such as requirements for particular technical skills or certifications, requirements for the ability to access certain types of data, indicated preferences and/or qualifications to work with particular brands and/or with particular entities (e.g., a company utilizing the platform to respond to customer inquiries), or the like. In certain embodiments, applied sorting and/or filtering may be applied using the most selective aspects first (e.g., to reduce the number of records requiring further analysis), and/or using the simplest or least expensive criteria to apply (e.g., where determinations are simple and/or use limited data to determine whether a particular freelance worker is available for the work element).

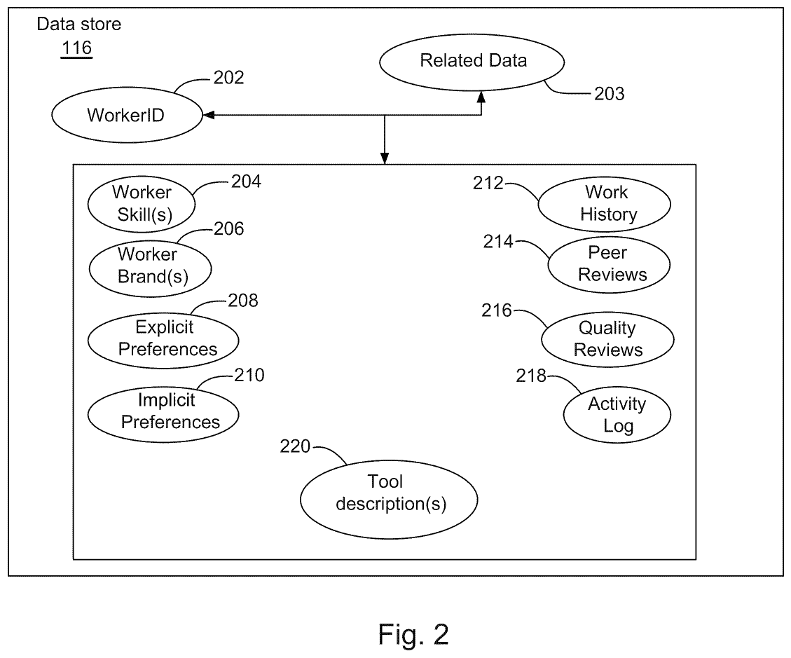

Referencing FIG. 2, an example data store 116 is depicted schematically. The example data store 116 may include freelance worker identifiers (e.g., WorkerID) with information for the given freelance worker associated with the WorkerID. The example of FIG. 2 depicts information for a worker, any aspects of which may be worker properties as set forth herein. In certain embodiments, the WorkerID 202 is itself a worker property, and/or may embody a primary key corresponding to a worker. In certain embodiments, the related data 203 includes information on the platform related to the worker, for example work elements that have been accepted, completed, which segments the worker is assigned to, which freelance work groups include the worker, or the like. In certain embodiments, the related data 203 or portions thereof embody a part of the worker properties for the corresponding worker. In certain embodiments, the freelance workers may be organized by a personal entity, and/or a given person may have more than one identifier as a freelance worker (e.g., where the worker may have multiple highly distinct skill sets, security access types for common work elements, etc.), for example where the creation of Crowds, Segments, or the like would overall be more efficient by creating more than one identifier for certain freelance workers. Example and non-limiting data for a given freelance worker on the data store 116 may include skill descriptions (e.g., keywords, certifications, and/or other systematized description of the worker's skills), brands (e.g., companies, products, brand names, etc. that the worker prefers, has worked on, is authorized to work on, etc.), explicit preferences (e.g., any preference criteria provided by the worker, for example communication preferences, dashboard content, work element preferences, etc.), implicit preferences (e.g., any preference criteria determined by the platform, for example based on the worker's work history, interaction data, login data, elements of the interface exercised by the worker, etc.), work history information (e.g., work elements addressed, in whole or part by the worker, outcomes for those work elements, communication history for those work elements, etc.), peer review information (e.g., peer reviews provided by other freelance workers about work elements addressed by the worker), quality review information (e.g., quality reviews provided by qualified freelance workers about work elements addressed by the worker), and/or an activity log (e.g., real-time information and/or transient information about the worker, such as currently associated work elements, status values, contribution values, or the like). In certain embodiments, information associated with the worker identifier may be stored separately from the profile of the worker, for example information about a Segment that the worker is assigned to (and/or commonly is assigned to), information about other freelance workers or customer inquiries that contain information about the identified worker, etc. The example organization of FIG. 2 is non-limiting.

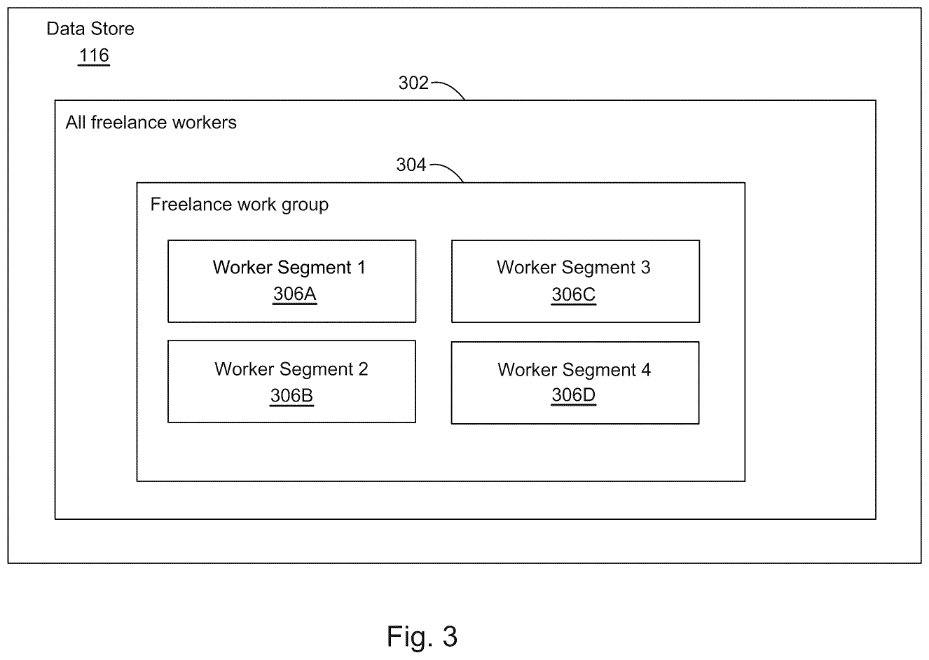

Referencing FIG. 3, an example data store 116 includes all worker information, with a corpus of freelance workers included as a subset of all workers, for example where the corpus of freelance workers includes all workers qualified to work on a particular work element, and/or all workers that have not been disqualified to work on a particular work element (e.g., where one or more qualifying criteria have not yet been compared against the potential available workers). In certain embodiments, for example where worker segments are determined in real-time in response to work elements, the corpus of freelance workers may include all freelance workers on the platform. The example data store 116 includes a number of worker segments, “Worker Segment 1” through “Worker Segment 4” (labelled 306A, 306B, 306C, and 306D), in the example of FIG. 3. The Worker Segments are utilized, for example by the work element resolution 118 component, to organize resolution of work elements on the platform, and to expose work elements to sufficient groups of workers in a scheduled manner to ensure that work elements are addressed sufficiently quickly and by a freelance worker having appropriate expertise. In certain embodiments, the corpus of freelance workers is screened to ensure that the remaining freelance workers are capable of performing the work element (e.g., they have the knowledge, available tools, likely work bandwidth, etc.), and those remaining freelance workers are divided into segments, with the freelance workers of each segment being offered the work element(s), in sequence (e.g., first offer to Worker Segment 1, and then to Worker Segment 2, etc.). Once a worker has accepted the work element, the work element may be removed from the assignment queue, and further offers to the work element may be disabled. In certain embodiments, for example where a worker has selected the work element, but subsequently de-selects the work element, the work element may be returned to the assignment queue. The return to the assignment queue may return to the original point in the sequence (e.g., if a freelance worker in Worker Segment 2 originally took the work element, the return may be to Worker Segment 2, or the next Worker Segment 3), may be returned as a new work element (e.g., starting at Worker Segment 1), and/or may be returned to a newly determined Segment group—for example with Segment determination criteria determined in response to activity that has already occurred on the work element—for example accounting for information about the work element determined in activity that has already occurred, accounting for the time that has lapsed since the work element was created, or the like.

Referring again to FIG. 1, the example work element resolution 118 component determines customer work elements and/or customer inquiries based on those elements being presented to the platform. For example, a client computing device 110 may aggregate a number of customer inquiries, for example provided by customer computing devices 114 interacted by customers 112. The customers 112 may be aware of the platform 102, for example interfacing with a web application, mobile application, support software on the customer device 114, or the like. In certain embodiments, the customers 112 may not be aware of the platform 102, for example interacting with an interface separate from the platform 102, such as a customer support interface for an entity, where the customer support interface for the entity passes the work elements to the platform 102, such that those inquiries and/or support communications are addressed by the platform 102 in a manner that appears to the customer to be addressed by the client entity. The direct interface to customers, and the appearance of the interface to the customers, is not limiting, and any arrangement is contemplated herein, including providing a first type of interface to one set of customers, and a second type of interface to another set of customers.

Operations of the work element resolution 118 component to determine worker segments include determining a number of workers in each segment, criteria for splitting workers between segments, hand-off times between segments (e.g., how long to offer to a first segment before proceeding to another segment), and the like. In certain embodiments, the work element resolution 118 component adjusts the criteria for segmentation based on aspects of the work elements (e.g., difficulty, complexity, available reward resources, urgency and/or time related value determinations), and/or iteratively improves (e.g., utilizing an expert system, Al component, and/or machine learning component) the criteria for segmentation, to improve the performance of the platform 102 over time, to ensure that performance criteria are met, to manage variability in the corpus of workers (e.g., an increase or decrease of workers having certain skills, etc.), and/or to balance workloads between freelance workers. In certain embodiments, operations to create segments, and then offer work elements by segment, are described herein as matching operations, matching a work element (e.g., a customer inquiry) to a freelance worker. In certain embodiments, logic to hand off work elements between segments may be varied, for example additive matching (e.g., continuing the offer to Worker Segment 1 and adding the offer to Worker Segment 2), limiting hand offs (e.g., removing the offer to Worker Segment 1, and making the offer to Worker Segment 2), or a combination thereof (e.g., keeping the offer to some workers from Worker Segment 1, and adding the offer to Worker Segment 2). In certain embodiments, adjusting the hand off logic may be a part of iterative improvements performed by the work element resolution 118 component.

In certain embodiments, matching operations may utilize a classification of the customer inquiry or other work element, for example classifying by tone, language, activity requirements, certifications, data content type (e.g., inclusion of PII, health information, etc.), urgency of the request, or the like. In certain embodiments, matching operations may utilize a classification of the corpus of freelance workers, with categories that match the classifications of work elements, that can be related to classifications of work elements, and/or with classifications that inform expected performance of freelance workers for the work elements. In certain embodiments, classifications or other performance estimates may be applied to a worker segment—for example providing an overall estimate of the performance of the segment to meet the needs of a work element or group of work elements. Accordingly, freelance workers may be bucketed into worker segments by criteria that improve the overall performance of the platform to address work elements, that lead to a different segmentation than a simple ranking of freelance workers individually.

In certain embodiments, classifications of the work elements may be updated in real time, for example based upon ongoing communications, customer response times, customer tone and/or tonal shifts, or the like. In certain embodiments, classifications of the freelance workers and/or worker segments may be updated in real time, for example based on ongoing communications, engagement status (e.g., worker logged in or out of the platform), resolution of work elements, or the like.

In certain embodiments, worker segments are saved, or static, for example where a group of freelance workers is utilized as Worker Segment 2 for a particular type of work element, improving the efficiency of the platform 102 to quickly assign work elements in a scheduled manner. In certain embodiments, worker segments are fully dynamic, for example where segments are determined for each work element (and/or for a set of work elements) in real time, based on ongoing classifications, etc. In certain embodiments, worker segments may be mixed, for example with static segments that are periodically updated (e.g., each hour, each day, each week, etc.) and/or episodically updated (e.g., when a number of work elements have been addressed, when a classification of a certain type or magnitude changes for a worker and/or a segment, when a performance metric for a worker and/or segment changes, etc.).

Example and non-limiting segmentation criteria include parameters such as: a sentiment and/or mood expressed in a work element; technical requirements suggested or required to address a work element; non-technical requirements suggested or required to address a work element (e.g., brand approval, certifications, regulatory requirements, ability to access PII, access to specific tools suggested or required to address a work element, and/or fitness to a classification associated with a work element); classification of freelance worker aspects to support platform operations (e.g., scheduling and/or activity history of a worker; bandwidth or throughput of a worker; work load balancing among workers, etc.); pricing, preference, and/or reward criteria for workers (e.g., ensuring that workers that are likely to be able to accept work elements are included in segments, as an additional sorting criteria to support workers getting preferred work element types and/or work element complexity levels, and to support customers getting service from freelance workers that are likely to provide desired support levels and services); topical preferences of freelance workers; response history of freelance workers; geographical matching and/or compatibility (e.g., accounting for regulatory requirements, compliance criteria, time management of workers, and/or work elements where similarity of geography between workers and customer needs may be relevant); and/or prior work of a freelance worker with a work element (e.g., a revived or continuing work element) or associated aspect (e.g., a customer returning to the platform, where it may be inferred that a new work element is associated with a previous work element, for example by offering the work element to a freelance worker that addressed the previous work element).

In certain embodiments, a work element resolution 118 component utilizes an urgency classification of a work element to perform and/or adjust matching operations. For example, an urgency classification may include a time to service the work element (e.g., resolve within 4 hours), a time-value function associated with the work element (e.g., accounting for time events that affect the value of the work element, such as degradation of resolution value over time, specific events that affect the value, or the like—for example where the number of workers in a segment, hand off logic between segments, and/or timing of hand offs between segments are configured in view of the time-value function). In certain embodiments, the weighting of other classifications may be adjusted, for example applying a stronger match criteria between customer tone and worker tone, a stronger match criteria for geographic locations, and/or a stronger match criteria for preferred complexity, which may improve the performance of the platform 102 to achieve acceptable service levels for work elements having an urgency associated therewith.

In certain embodiments, ranking and/or scoring operations are performed by the work element resolution 118 component to support segmentation operations and thereby expose work elements to freelance workers for acceptance, in a manner that promotes improved work element response, including over time (e.g., sustaining a sufficient corpus of freelance workers, ensuring that performance criteria are met and/or improved over time, etc.). In certain embodiments, operations include ranking a segment based on the properties of the underlying freelance workers in the segment, and which may be based on elements such as: performance (e.g., peer review, customer feedback, apparent resolution, and/or quality review information for previous work elements); preferences (e.g., matching of preferences for certain classifications of work elements, etc.); engagement status (e.g., online presence of workers, likely engagement times and/or historical engagement times, recent activity, observed work rhythms, etc.); and/or weighted or combined values for any one or more of the foregoing. The weighting, scoring, and/or ranking may be adjusted based on the work element(s) being considered, for example to promote segments that are more likely to successfully address work elements of a particular topic, classification, or the like. In certain embodiments, the ranking and/or scoring operations may be utilized to determine segment constituency (e.g., adding or removing workers to adjust the score or rank), to determine segment ordering (e.g., which segments will be offered work elements in which order), to adjust hand off logic (e.g., adjusting the timing and/or method of hand offs, for example based upon score differential—for example offering to a first segment for a longer period when the next segment has a much lower score, or for a shorter period when the next segment has a relatively close score), and/or to adjust workloads between segments—for example to support workload balancing, improved customer service, or the like.

In certain embodiments, the freelance corpus management 104 component provides one or more of a number of productivity tools for freelance workers. An example productivity tool includes a continuous customer sentiment analysis, for example providing feedback to the worker on an interface to show a sentiment of the customer, including an initial sentiment, a current sentiment, and/or a sentiment trajectory. In certain embodiments, the continuous customer sentiment analysis provides responsive suggested communications determined, for example, based on the customer sentiment and/or sentiment trajectory. In certain embodiments, the continuous customer sentiment analysis may suggest transfer of a work element to another freelance worker, and/or may move the work element to another freelance worker—for example a freelance worker having a better classification match based on the customer sentiment.

Another example productivity tool includes an “agent next dialogue prompt”, providing a next suggested dialogue element for the freelance worker, for example determined from the initial customer inquiry, a classified intent, and/or ongoing sentiment analysis. In certain embodiments, the agent next dialogue prompt provides language that is configured for the brand (e.g., the brand, product, company, or the like associated with the work element), configured for the specific freelance worker (e.g., providing a communication using a similar tone or word usage that the specific freelance worker generally uses, including potentially ranked communications based on prior success), communications built using a knowledge base (e.g., providing a convenient “correct answer” for the freelance worker, where the knowledge base may be stored on platform, in communication with the platform, and/or provided by a client or other entity).

Another example productivity tool includes a suggested response code—for example based on a categorization of the conversation, and/or an intent determined from client communications (including the initial communication and/or ongoing communications). The suggested response code may be utilized to reduce documentation time by the worker, to ensure that documentation is more likely to be correct, to ensure that documentation is completed, and to reduce the number of concepts that the worker has to focus while addressing customer inquiries (or other work elements). In certain embodiments, the suggested response codes may be utilized for analytics (e.g., grouping, tracking, and/or aggregating work elements), iterative improvement operations (e.g., improved segmentation, escalation logic, matching logic, classification operations, etc.), or the like. An example suggested response code may additionally or alternatively include an escalation code—for example a code utilized to implement and/or document the addition or replacement of the freelance worker, to engage a specialized freelance worker for a particular situation, or the like.

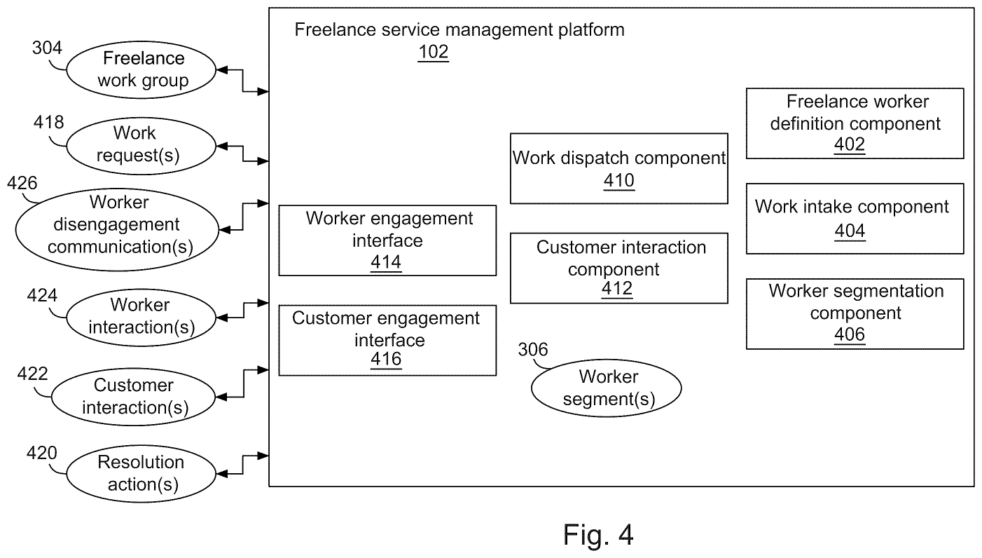

Referring now to FIG. 4, an example system includes a freelance service management platform 102 for matching customer related work elements to a freelance work group. A person of ordinary skill in the art having the benefit of this disclosure may enable one or more freelancer workers to answer Customer Service inquiries using their skills and knowledge, where the one or more freelancers may be rewarded, such as on a per-task basis, for what they know about a specific brand or product and for providing great customer service without having to commit to schedules, hours, certain regulations/arrangements, and/or throughput targets. The term customer service inquiries, and/or related terminology, as utilized herein, should be understood broadly. Without limitation to any other aspect of the present disclosure, customer service inquiries may be digital inquiries, such as chats, messaging, Forum posts, email, social media content, survey responses, or may be voice conversations, voice recordings, TTY/TDD/TT/AAC communications, and the like.

The freelance service management platform 102 may include a freelance worker definition component 402 that is configured to interpret a freelance work group 304, the freelance work group 304 including a plurality of freelance workers. Throughout this Specification, the freelance worker definition component 402 may also be referred to as a freelance corpus management 104 component. Throughout this Specification, freelance work group 304 may also be referred to as corpus of freelance workers. The freelance service management platform 102 may also include a work intake component 404 configured to interpret a work request 418.

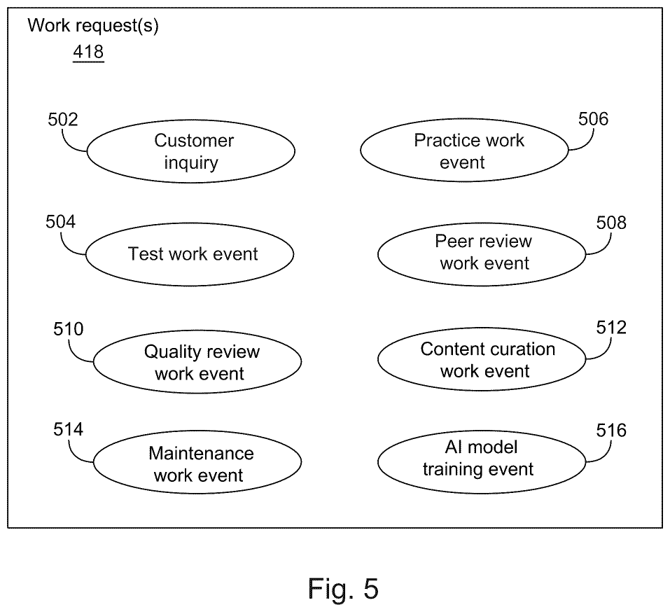

In embodiments, and with continued reference to FIG. 4, the freelance service management platform 102 may also include a worker segmentation component 406 configured to determine a plurality of worker segments 306 in response to the freelance work group 304. In example embodiments, the worker segmentation component 406 is further configured to determine the plurality of worker segments 306 in response to the work request 418, including the type of work request 418, or based on the body of outstanding requests pending, such as in a real-time scenario. Other ways to segment workers will be further disclosed herein. Referring now to FIG. 5, work requests 418 may include customer inquiries 502 (e.g., help using or setting up a product, help returning a product for credit, information on how to fix an issue), a test work event 504 (e.g., testing the system, an event geared for a worker to practice implementing the system), a practice work event 506 (e.g., a test of worker competency, an event geared to allow a worker to practice), a peer review work event 508 (e.g., providing a review of a completed work event, providing a review during the lifecycle of another work event, and/or providing any feedback by one freelance worker related to a work event by another freelance worker), a quality review event 510 (e.g., a quality review task by a freelance worker, for example using a configured quality form, answering specific quality related questions, scoring a work event or aspects thereof, etc.), a content curation event 512 (e.g., creating or updating any aspect of a knowledge base, such as a knowledge base article, dialog prompt, and/or any knowledge curation work event), a maintenance work event 514 (e.g., reviewing and/or responding to events such as QoS related events and/or health value events), and/or an AI model training event 516 (e.g., a task to train an expert system, AI component, ML learning component, automated review components, and/or iterative improvement component, as set forth throughout the present disclosure, including for example: labeling resolution actions, communications, and/or work requests; labeling moods, sentiments, positive outcomes, negative outcomes, ranking values, and/or scoring values; adjusting rules utilized; adjusting available inputs; adjusting available outputs; adding, removing and/or amending selected work requests and/or selected customer inquiries, and/or selecting representative actual work requests and/or customer inquiries to be utilized as selected work requests and/or customer inquiries, and/or to be utilized as a starting point for these; labeling and/or adjusting action time determinations; and/or labeling and/or adjusting action resource determinations). For example, a customer inquiry 502 may be handled by a segment with either an intermediate or advanced competence with respect to a topic, while a peer review work event 508 may be handled by only an advanced segment. In other examples, a baseline segmentation may occur and may be updated periodically or episodically. For example, the baseline segmentation may involve segmenting workers into those who know about mountain bikes and those who do not. Periodically, the segments may be updated for accuracy but may also be updated for refinement. For example, those who know about mountain bikes may be further segmented into those who know about operating them versus fixing them. In some embodiments, segmentation may occur via a combination of modes. For example, in one mode, a baseline segmentation may be used for most work requests 418, and a real-time segmentation may be determined for some work requests 418. For example, the baseline segmentation of those who know about mountain bikes versus those who do not may be sufficient for most work requests, but a real-time segmentation may need to be done if a request comes in with an inquiry specific to electronic mountain bikes.

Certain work requests 418 of the present disclosure are referenced as a peer review work event 508, which may be a review of a resolution action, portion thereof, or specific work element (e.g., a communication) performed by a first freelance worker, where the peer review work event 508 includes resolution action(s) performed by a second freelance worker. Certain work requests 418 of the present disclosure are referenced as a quality review work event 510, which may be an action to determine a quality of a resolution action, portion thereof, or specific work element (e.g., a communication) performed by a first freelance worker, where the quality review work event 510 includes resolution action(s) performed by a second freelance worker, a platform administrator, and/or by an automated quality review component (e.g., a quality management component 7702). In certain embodiments, the utilization of peer review and/or quality review work events allows for high resolution quality evaluation of a high percentage of resolution actions on the platform while reducing resource utilization on the platform, allowing for the platform to maintain high response quality, provide rich information for segmentation operations, reward operations, and/or reward division operations, and/or to ensure that quality determinations are made on fundamental merits of the response itself (e.g., a customer receiving a high quality response may provide negative feedback if the content of the response is not what the customer was looking for, even though the customer received a rapid, correct, and polite response). In certain embodiments, the utilization of human reviews combined with automated reviews (e.g., which may be trained by experts and/or utilizing human reviews) can provide for high quality reviews for an arbitrary fraction, or all, resolution actions on the platform.

The freelance service management platform 102 may also include a work dispatch component 410 configured to offer a resolution action 420 to the work request 418 to the worker segments 306, and repeat the offering until at least one freelance worker 302 accepts the resolution action 420. In an example, the offering is sequential, such that only one worker segment is offered the opportunity of the resolution action 420 at one time. In another example, multiple worker segments are offered the resolution action at one time. In some examples, new segments are offered the resolution action sequentially and in addition to one or more other worker segments. In examples, offering the resolution action 420 includes communicating it to the freelance worker 302, tracking it to completion, and any evaluation of the work activity associated with the resolution action 420. In embodiments, the work dispatch component 410 may be implemented on a freelance user device 108. For example, the work dispatch component 410 may be embodied as an application executing on the freelance user device 108 that directs the freelance worker to engage with the platform, which can be embodied on the same or a different application.

Certain further aspects of the example system are described following, any one or more of which may be present in certain embodiments. In some examples, the freelance service management platform 102 further includes a customer interaction component 412 configured to implement a customer engagement interface 416, and to determine the customer inquiry in response to customer interactions with the customer engagement interface 416. Throughout this specification and the drawings, the customer engagement interface 416 may also be referred to as a customer request interface. In examples, the customer engagement interface 416 is implemented on at least one of a client computing device 110 or a customer device 114. For example, when the customer engagement interface 416 is implemented on the client computing device 110, a customer interacting with the interface 416 may not be aware that the interface 416 is a component of the freelance service management platform 102, while if the interface 416 is on the customer's device 114, they may be aware that the interface 416 is an interface to the platform 102.

In examples, the work dispatch component 410 is further configured to update the work request 418 in response to a worker disengagement communication 426 from the at least one freelance worker 302 that accepted the resolution action 420. In an example, the worker disengagement communication 426 is launched when a freelance worker completes a resolution action, when the freelance worker is no longer active on the platform, if the system detects an issue with the engagement between the freelance worker and the customer, if a connectivity issue is detected for the freelance worker, if the freelance worker is no longer available to complete the resolution action, or the like. The worker segmentation component 406 may be further configured to determine the plurality of worker segments 306 in response to the worker disengagement communication 426. For example, a freelance worker for whom a worker disengagement communication 426 has been launched may not be included in worker segments. The work dispatch component 410 may be further configured to offer the resolution action 420 to the work request 418 in response to the worker disengagement communication 426. In this embodiment, the offer progress may be adjusted based on the declined work element, for example moving more quickly or more slowly through the progression, adjusting a queue order of available work segments 306, or changing an offer tactical implementation (e.g., changing notification location—e.g., text, e-mail, platform message, adding a priority indicator, changing an offered reward amount).

In embodiments, the freelance worker definition component 402 may be further configured to implement a worker engagement interface 414, and to adjust the freelance work group 304 in response to worker interactions 424 with the worker engagement interface 414. In this way, workers are able to engage or disengage with the platform 102 at any time, and the platform 102 can adjust the corpus (or segmentation) accordingly. In some embodiments, the worker engagement interface 414 may be implemented on a freelance user device 108.

Throughout this disclosure, example systems, components, circuits, or platforms are depicted as a single device or a distinct device for clarity of the present description, but any of the systems, components, circuits, or platforms may be a distributed device, and may be embodied, in whole or part, on a local computing device, on one or more computing devices, on a remote computing device, on a controller, and/or a cloud server (not shown). In some cases, an example controller includes a number of circuits configured to perform one or more operations of the controller. The example circuits are depicted as distinct devices for clarity of the description, but may be distributed on one or more computing devices, and/or may be embodied in whole or part as any hardware device within a system, and/or as computer readable instructions which, when executed by a processor, cause the circuit to perform one or more aspects of the operations set forth herein. Throughout this disclosure, it should be understood that any of the disclosed procedures, methods, processes, and operations may be implemented by any of the components, controllers, circuits, platforms, systems, or the like disclosed herein. It should be understood that the implementation of any one procedure, method, process, or operation may distributed among one or more components, controllers, circuits, platforms, or systems, or may be implemented on a single component, controller, circuit, platform, or system.

Referring now to FIG. 6, an example procedure 600 includes an operation 602 to interpret a freelance work group including a plurality of freelance workers, an operation 604 to interpret a work request, an operation 606 to determine a plurality of worker segments in response to the freelance work group, and an operation 608 to sequentially offer a resolution action to the work request to each of the worker segments, and repeat the sequentially offering until at least one freelance worker accepts the resolution action.

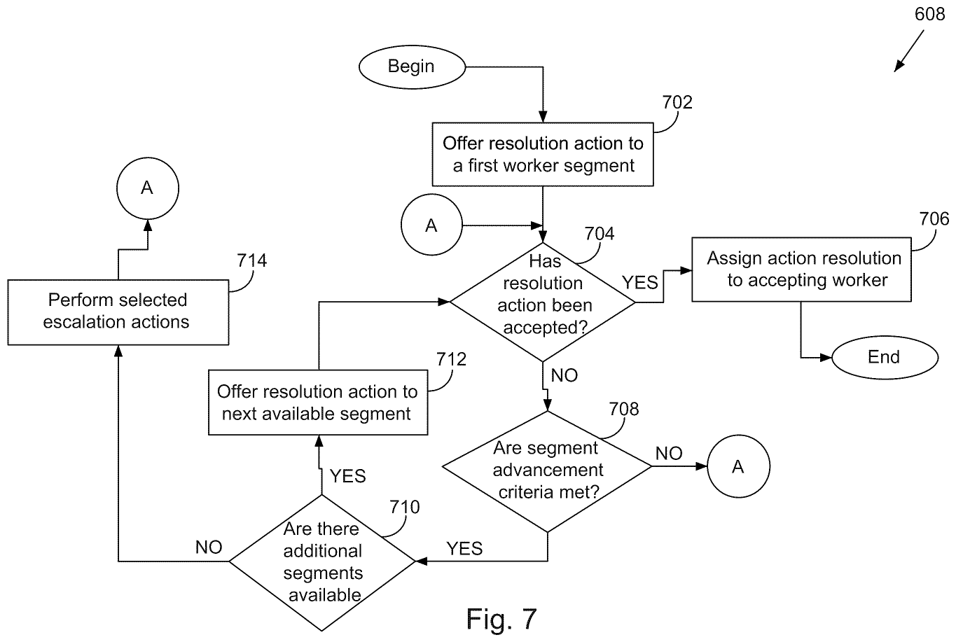

Referring to FIG. 7, the operation 608 to sequentially offer a resolution action may include various steps as depicted in the flowchart. The operation 608 may begin with an operation 702 to offer a resolution action to a first worker segment and may proceed to a decision point 704 to determine if a resolution action has been accepted. If one has, the procedure continues with an operation 706 to assign the action resolution to the accepting worker. If the resolution has not been accepted, processing flow continues to a decision point 708 to determine if a segment advancement criteria has been met. If the segment advancement criteria has not been met, process flow returns to the decision point 704. If the segment advancement criteria has been met, flow proceeds to a decision point 710 to determine if there are additional segments available. If there are additional segments available, flow proceeds to an operation 712 to offer the resolution action to the next available segment. Without limitation to any other aspect of the present disclosure, operation 712 may offer the resolution action to the next available segment in addition to continuing to offer the resolution action to one or more of the previous segments, and/or operation 712 may offer the resolution action exclusively to the next available segment. Process flow may continue back to the decision point 704 and continue on from there as described previously. If there are no additional segments available, process flow may continue to an operation 714 to perform selected escalation actions and flow may return to the decision point 704.

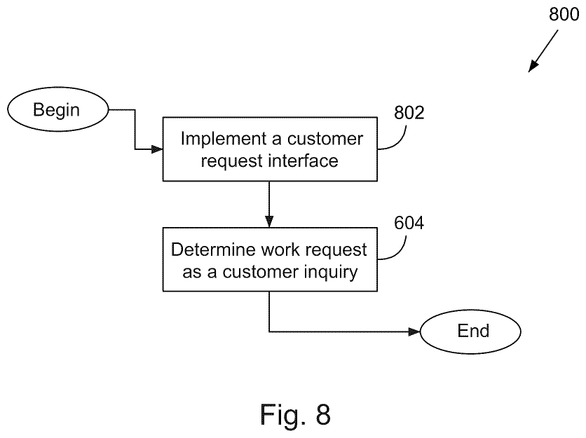

Certain further aspects of the example procedure are described following, any one or more of which may be present in certain embodiments. Referring to FIG. 8, the example procedure 800 may further include an operation 802 to implement a customer request interface and an operation 604 to determine the work request as a customer inquiry in response to customer interactions 422 with the customer request interface 416.

In embodiments, the example procedure 600 may further include an operation to determine the plurality of worker segments in response to the work request. In embodiments, the example procedure 600 may further include an operation to update the work request in response to a worker disengagement communication from the at least one freelance worker that accepted the resolution action. The operation may further include determining the plurality of worker segments in response to the worker disengagement communication. The operation may further include sequentially offering the resolution action to the work request in response to the worker disengagement communication.

In embodiments, interpreting the work request includes interpreting a customer inquiry. In embodiments, interpreting the work request includes interpreting a test work event. For example, interpreting a test work event may result in creating a test or practice work event, such as possibly in response to system changes or updates, normal monitoring, historical performance, or the like. In embodiments, interpreting the work request includes interpreting a peer review work event which may include creating a peer review work event from some past completed work element.

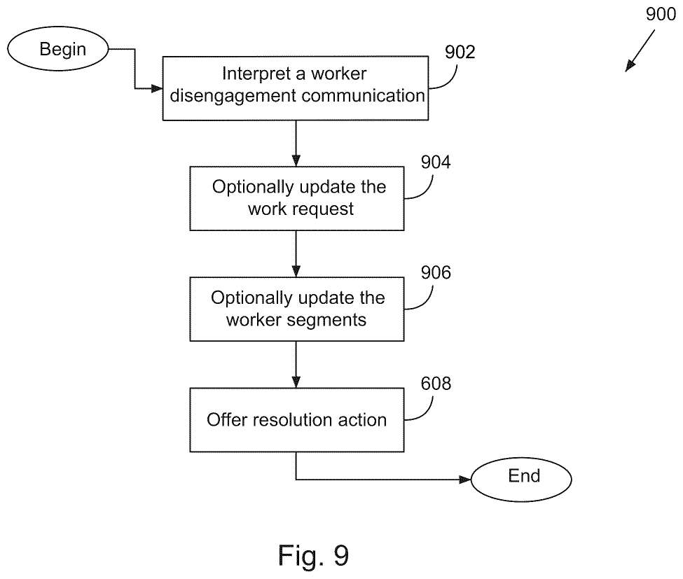

Referring to FIG. 9, an example procedure 900 may include an operation 902 to interpret a worker disengagement communication, an operation 904 to optionally update the work request, an operation 906 to optionally update the worker segments, and an operation 608 to sequentially offer a resolution action.

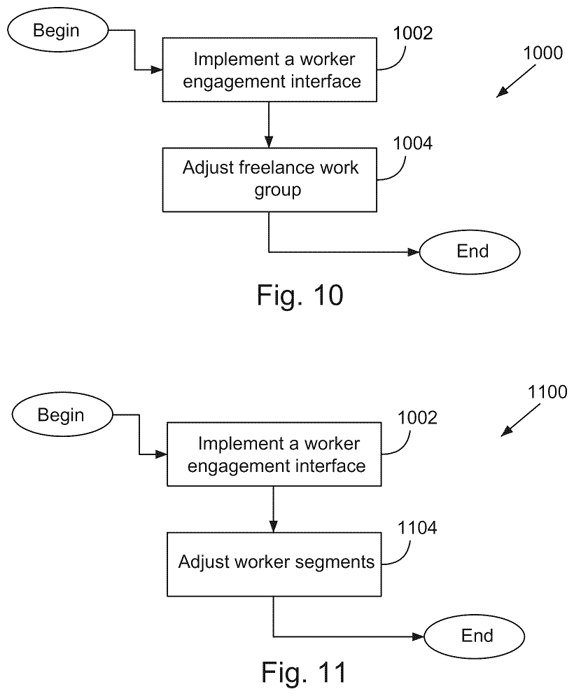

Referring to FIG. 10, an example procedure 1000 may include an operation 1002 to implement a worker engagement interface, and an operation 1004 to adjust the freelance work group in response to worker interactions with the worker engagement interface. For example, operations of the procedure 1000 may enable adding/removing people as available workers, or as available for certain brands or in certain technical areas (e.g., they have proven competency (or lack of it) in an area, they have a new skill added, etc.).

Referring to FIG. 11, an example procedure 1100 may include an operation 1002 to implement a worker engagement interface, and an operation 1104 to adjust the plurality of worker segments in response to worker interactions with the worker engagement interface. For example, operations of this procedure 1100 may enable changes in the way that workers may be segmented—e.g., they go on vacation so they won't be available for a while, or they want to reduce their workload. How workers get assigned to segments may change while they remain part of the pool of workers.

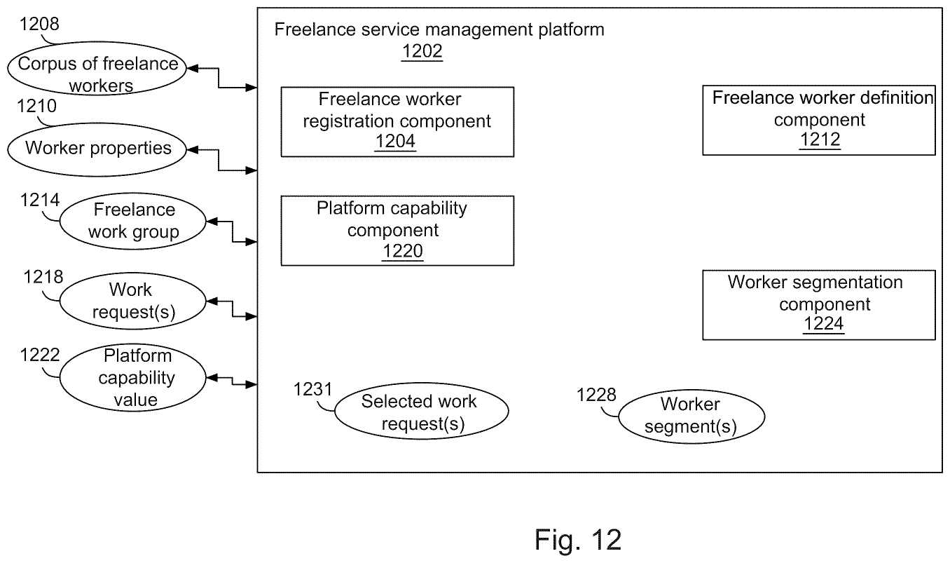

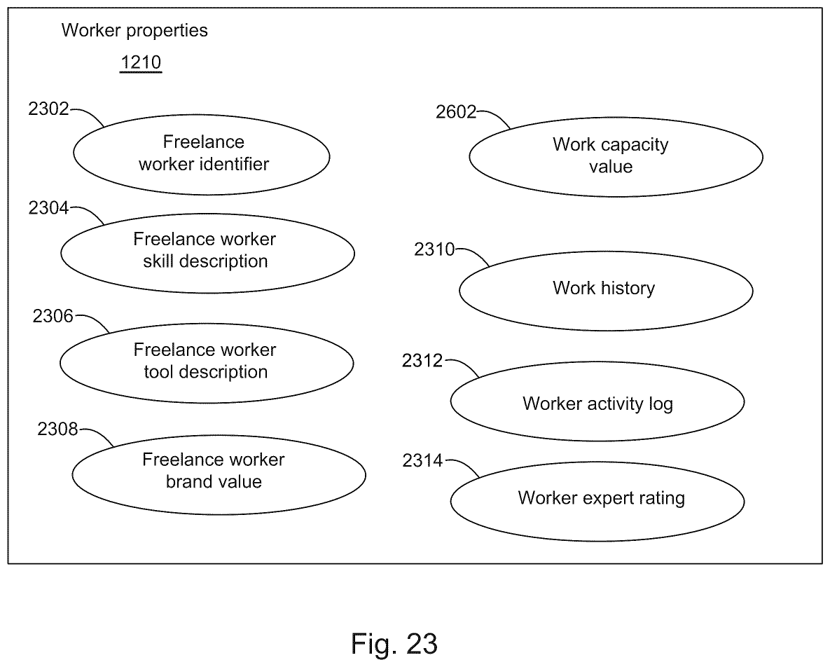

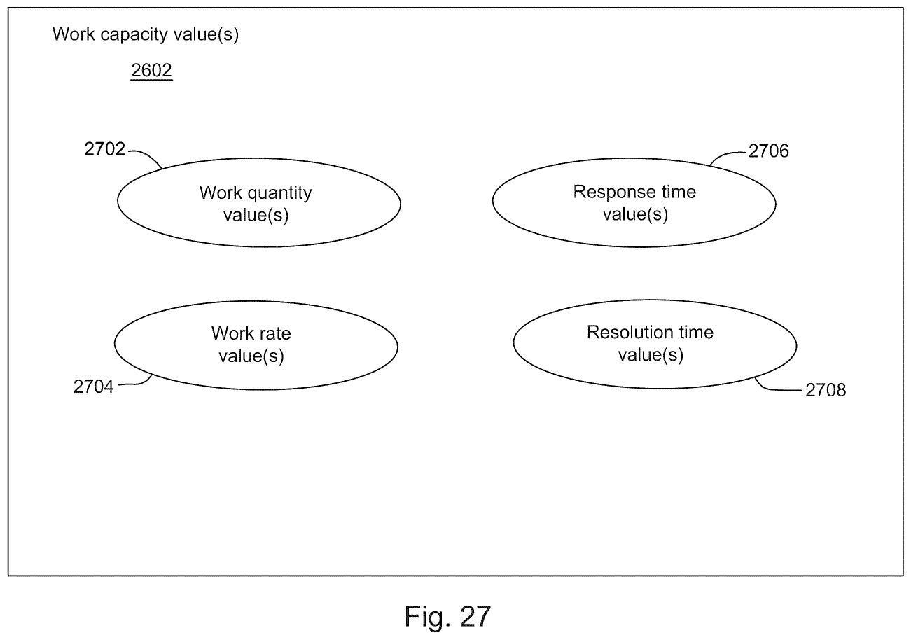

Referring now to FIG. 12, an example system includes a freelance service management platform 1202. In some cases, the system may operate on the freelance service management platform 102, and/or any other system, platform, component, or other embodiment as set forth throughout the present disclosure. An example freelance service management platform 1202 includes a freelance worker registration component 1204 configured to build a corpus of freelance workers 1208 including a plurality of freelance workers, and a plurality of worker properties 1210 corresponding to the plurality of freelance workers. A person of ordinary skill in the art having the benefit of this disclosure will be able to operate a platform to segment freelance workers along a number of dimensions related to the freelance worker(s), users of the platform (e.g., brands/entities and their customers/clients/users), operators of the platform, and the like to respond to work requests/customer inquiries in accordance with any parameters, rules, expectations, or the like. With reference to FIG. 23, some example worker properties 1210 include a freelance worker identifier 2302, a freelance worker skill description 2304, a freelance worker tool description 2306, a freelance worker brand value 2308, a work capacity value 2602, a work history 2310, a worker activity log 2312, and the like. An example worker property 1210 includes a worker expert rating 2314, for example a rating built from response quality values 7704 associated with the worker, from peer review work events 508 performed related to actions of the worker, from quality review work events 510 performed related to actions of the worker, or the like. Without limitation to any other aspect of the present disclosure, the worker expert rating 2314 may be utilized to determine which worker segment a worker will be assigned to, reward values for the worker, incentive values for the worker, contributions of the worker for distributed reward determinations, or the like. In certain embodiments, a worker property 1210 may include multiple worker expert ratings 2314 for a given worker, for example based on work request properties to allow the platform to differentiate different types of tasks, communications, brands, etc., that the worker excels at performing. Example freelance worker tool descriptions 2306, also known as tool description(s) 220 throughout this disclosure, may include software/applications, hardware devices, connection type/speed, operating system, or anything that might be required or supportive of servicing a request. Example worker activity log information may include time of day, methods of interfacing, communication methods used and that work, how many things are viewed before acceptance, characteristics of requests that are accepted, tools or techniques used to resolve, dialog length/terminology/duration/timing (e.g., with customer), or any other worker-related relevant information. Referring to FIG. 27, example work capacity values 2602 include a work quantity value 2702 (e.g., the amount of work or number of hours of work a worker can accommodate), a work rate value 2704 (e.g., resolutions per unit time possible or anticipated), a response time value 2706 ((e.g., expected response time given other factors, such as the relationship between work rate and work quantity), a resolution time value 2708 (e.g., how long it takes to resolve one or more work request/customer inquiries), and the like.

The example freelance service management platform 1202 may include a freelance worker definition component 1212 (which may also be referred to as the freelance corpus management 104 component described previously herein) configured to interpret a freelance work group 1214 in response to the plurality of worker properties 1210, the freelance work group 1214 including a plurality of freelance workers available to service a selected work request 1231. For example, the freelance worker definition component 1212 may include information regarding availability of the worker by various methods, including phone, text messaging, online chat, etc. The worker property 1210 deemed relevant to a selected work request 1231 may be capability to speak by phone. The freelance worker definition component 1212 may interpret the freelance work group 1214 to identify those available workers who can speak by phone at that time.

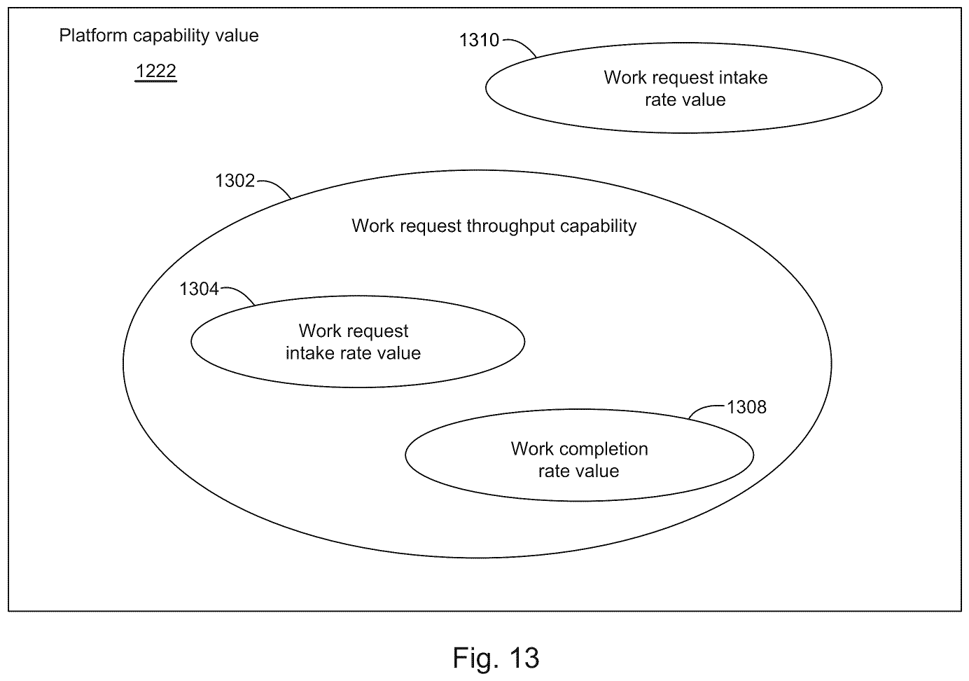

The example freelance service management platform 1202 may include a platform capability component 1220 configured to interpret a platform capability value 1222, and a worker segmentation component 1224 configured to determine a plurality of worker segments 1228 in response to the freelance work group 1214, the plurality of worker properties 1210, and the platform capability value 1222. In an example, and referring to FIG. 13, the platform capability value 1222 includes a work request throughput capability 1302. In another example, the platform capability value 1222 includes a work request quality of service value 1310. For example, the platform capability value 1222 could be set by a brand, requiring work requests to be picked up within 1 minute and disposed of in a predetermined amount of time. The worker property 1210 may also be set by the brand, requiring freelance workers to be available by phone or chat and to be able to switch between the two during the course of handling a work request. The worker segmentation component 1224 may determine worker segments from amongst those available in the freelance work group 1214 who can handle phone or chat communications and have been shown to respond quickly to work requests.

Work request throughput capability 1302 could be for a portion of the work requests. For example, throughput could be the number of active work requests pending, the number of work requests completed per unit time, the number of work requests accepted per unit of time, or the like. The work request quality of service value 1310 refers to a guaranteed quality of service for some segment of the work requests, which could be specific to certain customers, inquiry types, related to certain products, brands, or services, etc. The work request quality of service value 1310 could be based on a customer requirement, subscription, or the like. The work request quality of service value 1310 could reference response quality, response resolution time, responsiveness of communications or status updates, time to a first communication of acceptance, and the like. Both the work request throughput capability 1302 and the work request quality of service value 1310 could vary across the work requests 1218.

In examples, the work request throughput capability 1302 includes a work request intake rate value 1304 or a work completion rate value 1308. In an example, the work request intake rate value 1304 is a number of work units accepted per unit time (e.g., per day, week, hour, month, etc.). In another example, the work request intake rate value 1304 is a statistically built estimate based on individual worker information, a sum of the worker numbers, etc., and would be based on the summed performance of the segments, which may not be a simple sum of the segments (e.g., the capability of three segments serially may not be the same as adding them together).

In an example, the worker segmentation component 1224 is further configured to determine a segment capacity value 1402 (described elsewhere herein) for at least one segment of the plurality of worker segments 1228, and wherein the platform capability component 1220 is further configured to determine the work request throughput capability 1302 in response to the segment capacity value 1402. In this example, determining the segment capacity value 1402 or the work request throughput capability 1302 is iterative, and may be performed on an ongoing basis, periodically, or episodically.

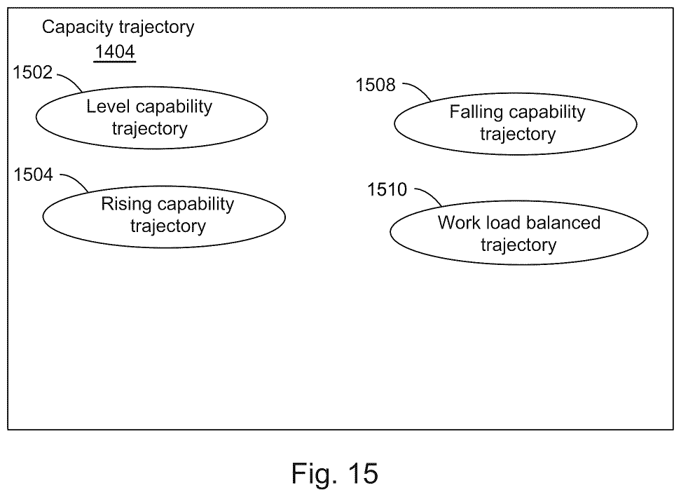

In an example, the worker segmentation component 1224 is further configured to determine a segment capacity value 1402 for at least one segment of the plurality of worker segments 1228, and to determine the plurality of worker segments in response to the segment capacity value 1402. In this example, the worker segmentation component 1224 is further configured to provide the plurality of worker segments having a selected capacity trajectory 1404. Referring to FIG. 15, the selected capacity trajectory 1404 includes at least one trajectory selected from: a level capability trajectory 1502, a rising capability trajectory 1504, a falling capability trajectory 1508, or a work load balanced trajectory 1510.

Work load balancing means putting the work load into the selected segments, whether heavier on the early segments (e.g., those offered the opportunity to respond to a work request first), later segments, or a middle segment. A person of ordinary skill in the art having the benefit of this disclosure would understand how to work load balance in the system. For example, placing the work load emphasis on the early segments provides the most work to early workers (e.g. workers associated with those early segments), enhancing responsiveness and predictability. Balancing the work load in favor of later segments provides the most work to late workers, allowing for selective workers to be put in earlier segments (e.g., maybe they are high quality but low throughput), reducing the likelihood of having to recycle the work request, etc. Placing the workload emphasis on the middle segments allows for multiple things, such as rewarding early segments allowing them to be selective, where most things will be picked up/handled relatively early, with certain worker types being a better fit for difficult or otherwise less likely to be picked up work elements. In some examples, work load balancing across worker segments may be level, but it may not mean that segments have equal workers in terms of any measure.

Work loads may be described as rising, falling, or level. Rising loads may refer to the case where work elements tend to rise with each segment. Falling loads may refer to the case where work elements tend to decrease with each segment. Level, rising, or falling loads could be beneficial for several purposes. For example, level work loads can be a type of diagnostic, if it becomes un-level it can be an indicator of changing worker properties and/or an indicator of the health of the worker corpus. In some examples, a rising load provides for greater stability (e.g., passing work elements are likely to be picked up before recycle) and the specific slope/trajectory of the rise can act as a diagnostic. In another example, a falling load provides for greater responsiveness, but is vulnerable to a recycle cascade (once the work element passes through, it becomes more likely that it will keep moving), and the specific slope/trajectory of the decline can act as a diagnostic, especially with a significant number of segments. In some examples, a mixture of load types can be used for diagnosis. For example, a falling load can be used for responsiveness combined with a rising load for stability.

In some examples, at least two segments may be needed to leverage the benefits. A complex scheme with a lot of different worker types (e.g., quality, responsiveness, attendance clumping) could realistically still create value using a large number of segments (say, 5, 7, or 9), allowing for specific treatment and goals for different segments. Fewer segments (e.g., about 3) may be the nominal, allowing for high priority workers in a first segment, a high throughput total capacity in a middle segment, and either lower priority workers, responsive workers, individual high capacity workers, etc. in a last segment. Aspects to consider include individual distributions (for capacity, responsiveness, quality, variability in these), how many workers need to go into a segment for statistically predictable performance of the segment, cost, and impact of work request recycle, availability of sufficient worker capability distributions to meet an overall segmentation scheme, etc. In certain embodiments, the worker segments may be determined in response to worker expert ratings 2314 relevant to the specific work requests, thereby allowing the platform to promote higher quality and higher customer satisfaction for completion of resolution actions on the platform.

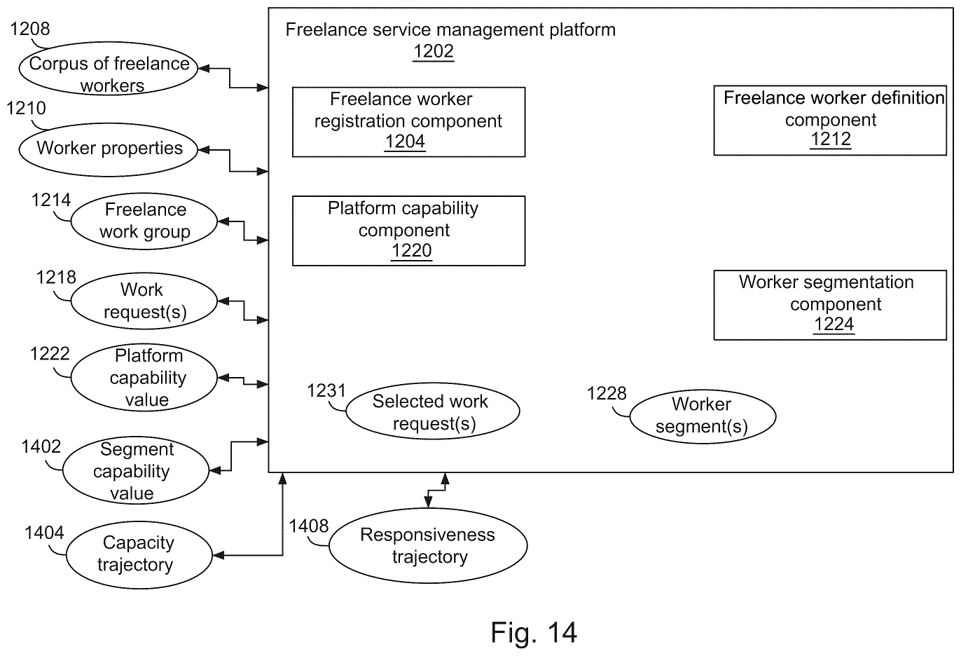

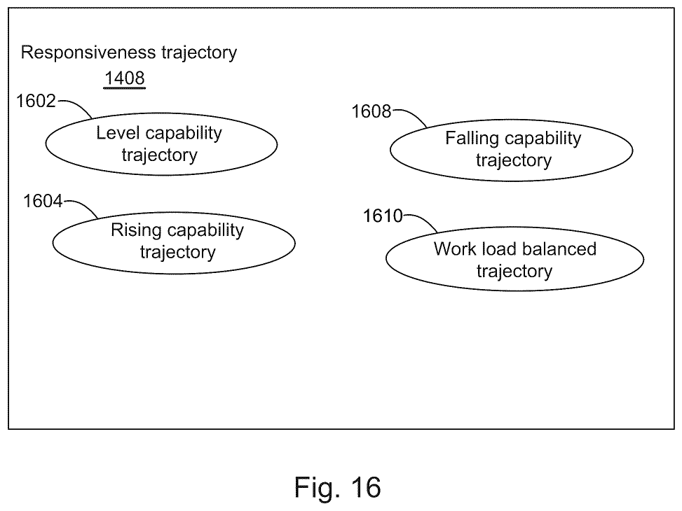

In some examples, and referring to FIG. 14, the worker segmentation component 1224 is further configured to provide the plurality of worker segments 1228 having a selected responsiveness trajectory 1408. Referring to FIG. 16, the selected responsiveness trajectory 1408 may include at least one trajectory selected from: a level capability trajectory 1602, a rising capability trajectory 1604, a falling capability trajectory 1608, or a work load balanced trajectory 1610.

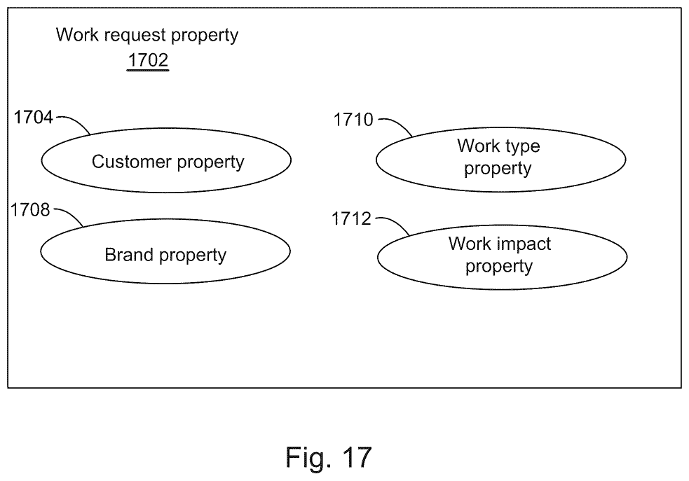

In some examples, the platform capability value 1222 includes a work request quality of service value 1310. In examples, certain quality of service (QoS) values are applicable to certain work elements. In examples, the work request quality of service value 1310 corresponds to a property of the selected work request 1231. Referring to FIG. 17, the work request property 1702 may include at least one of: a customer property 1704, a brand property 1708 (e.g., which allows QoS differentiation for specific brands), a work type property 1710 (e.g., which allows QoS differentiation based on the work type—for example customer inquiry, informational, login help, peer review, etc.), or a work impact property 1712. In an example, the customer property 1704 may relate to ensuring QoS for certain customers, the customer being either the party needing help (e.g., a customer of an entity), or the party that the platform is supporting (e.g., the entity). In an example, the customer property 1704 could be based on something about the customer. For example, the customer property 1704 could be related to a contractual obligation, subscription level, customer requirement, internal metrics, etc. In an example, the work impact property 1712 may allow QoS based on estimated, specified, or otherwise determined impact of the work element. For example, a customer unable to work is likely more important, and may have a higher impact, than just an information request. The work impact property 1712 could be based on information entered by the customer, knowledge about the state of a customer system when having this type of request, specified by the supported customer (e.g., a brand entity, a company), parsed from language utilized in the request, etc. In some examples, work type and work impact may have overlap, or even be the same thing. In certain embodiments, the utilization of a work request quality of service value 1310 allows the platform to track and ensure that work requests are achieving the goals of a customer or the platform for service response time, service acceptance time, and/or quality performance for resolution activity for any type of work request on the platform.

Throughout the present disclosure, work requests and customer inquiries may be used interchangeably and should be understood to refer to the same concept. The example customer inquiries and example work requests disclosed herein are non-limiting examples, and any type of customer inquiry or work request that may relate to a product, service, company, entity, brand, industry, technology, or the like are contemplated herein. Without limitation to any other aspect of the present disclosure, example and non-limiting work requests include: customer inquiries; peer review work events; quality review work events; test work events (e.g., work events provided by an administrator, trainer, or the like to test aspects of the platform); practice work events (e.g., work events that may be provided to test aspects of the platform, performance by freelance workers, to develop skills for freelance workers, etc.); knowledge curation or maintenance work events (e.g., work events to create, update, develop, and/or improve help files, knowledge base documents such as training documents, reference documents, etc.); QoS review events (e.g., checking or confirming that QoS standards are being complied with, identifying QoS gaps, and/or making and/or approving QoS related adjustments); and/or platform health review events (e.g., checking or confirming that platform health values are acceptable, identifying health value gaps, and/or making and/or confirming health value related adjustments). In certain embodiments, work requests of any type may be associated with a reward value, and/or in certain embodiments a work request may not be associated with a reward value (e.g., a practice work event initiated by, and completed by, a freelance worker may not include an associated reward value; a health value review performed by a platform administrator may not include an associated reward value; in certain embodiments such activity may include a reward value, for example to promote skill development and maintenance, to engage high trust freelance workers in maintaining and/or curating the platform, etc.).

Certain operations and/or activities are referenced herein as resolution actions. Resolution actions include, without limitation to any other aspect of the present disclosure, any actions performed on the platform, and/or exercising an interface herein that is provided by and/or is in communication with the platform, that are performed to complete and/or contribute to a work request of any type. Example and non-limiting resolution actions may include any one or more of the following: accepting a work request; providing a communication pursuant to a work request (e.g., including communications with a customer, another freelance worker, an administrator, etc.); utilization of a tool (e.g., using an application, accessing a reference document, accessing a knowledge base, etc.); and/or completing administrative tasks such as checklists, forms, and/or submissions. In certain embodiments, resolution actions may contribute to customer inquiries, peer review work events, quality review work events, practice work events, test work events, knowledge curation or maintenance work events, QoS review events, and/or platform health review events.

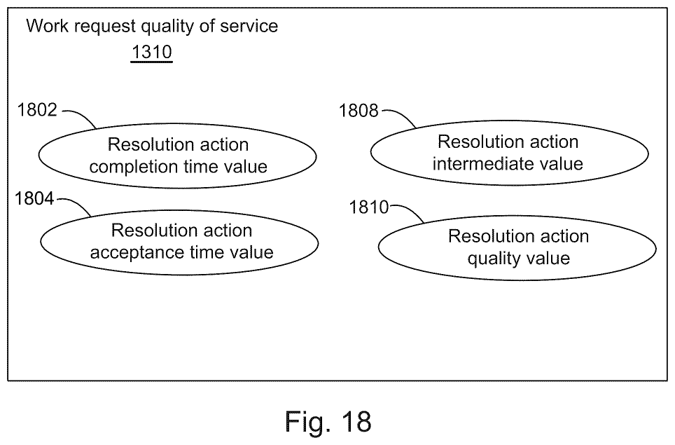

In examples, the work request quality of service value may be used to determine an aspect of how a work element gets resolved. For example, and referring to FIG. 18, the work request QoS value is at least one value selected from: a resolution action completion time value 1802, a resolution action acceptance time value 1804 (e.g., measured from acceptance), a resolution action intermediate value 1808, or a resolution action quality value 1810.

QoS may be measured differently for worker exited requests (e.g., disengagement communication). Typically, these may have a higher QoS (e.g., a request that was not accepted should now be serviced earlier), or the recycle may be ignored (e.g., serviced within 4 hours from initial request regardless of the disengagement). In an example, a resolution action completion time value 1802 may relate to time to progress to completion. This could be measured from inquiry time or acceptance time and may include a time value (e.g., 4 hours), a statistical value (e.g., 95% completed within the time), and/or a mix (e.g., 95% completed within 4 hours, 99% in 6 hours, and not-to-exceed 8 hours). In examples, a resolution action intermediate value 1808 may be anything measured during the servicing, such as for example, response time to communications, progression between stages (if applicable), completion of forms, surveys, metadata, etc. In examples, a resolution action quality value 1810 may have a longer cycle time, and may include target values for customer feedback and/or peer reviews.

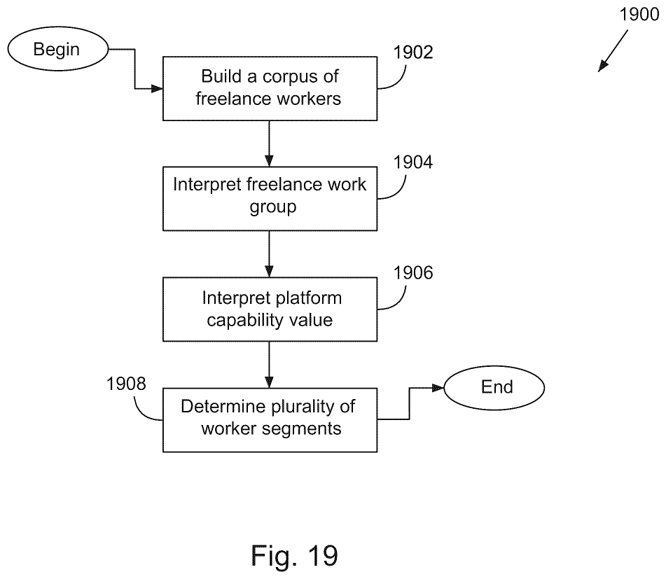

Referring to FIG. 19, a procedure 1900 includes an operation of building a corpus of freelance workers 1902 comprising a plurality of freelance workers, and a plurality of worker properties corresponding to the plurality of freelance workers, an operation of interpreting a freelance work group 1904 in response to the plurality of worker properties, the freelance work group comprising a plurality of freelance workers available to service a selected work request, an operation of interpreting a platform capability value 1906, and an operation of determining a plurality of worker segments 1908 in response to the freelance work group, the plurality of worker properties, and the platform capability value.

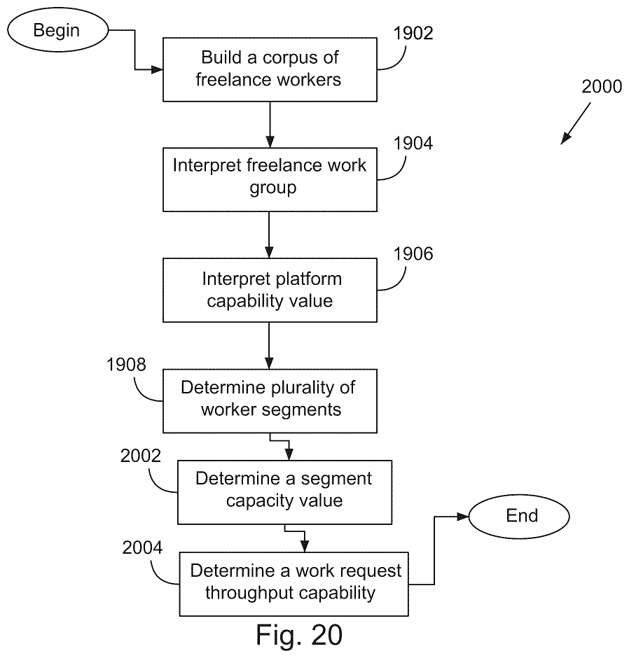

The procedure 2000 may further include, and referring to FIG. 20, wherein the platform capability value comprises a work request throughput capability describing a desired capability, an operation determining a segment capacity value 2002 for at least one segment of the plurality of worker segments, and determining the work request throughput capability 2004 (e.g., the actual and current capability) in response to the segment capacity value. This operation determines if the segments have the desired capability.

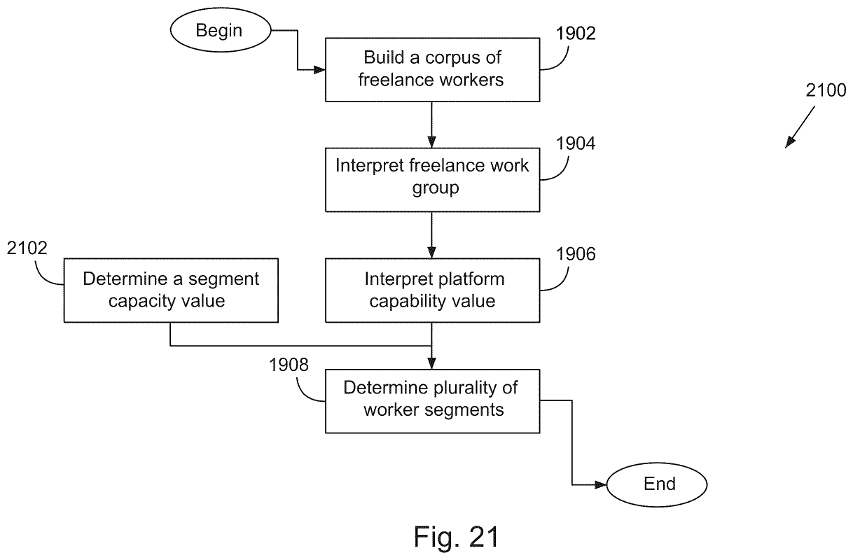

Referring to FIG. 21, a procedure 2100 may further include an iterative operation to determine segments, check capability, and update segments until capability is achieved or some optimal is reached. The procedure may continue based on changes in the available workers, worker properties, or needed capability. The procedure includes an operation of, wherein the platform capability value comprises a work request throughput capability, determining a segment capacity value 2102 for at least one segment of the plurality of worker segments, and determining the plurality of worker segments 1908 in response to the segment capacity value. The procedure 2100 may further include providing the plurality of worker segments having a selected capacity trajectory, or providing the plurality of worker segments having a selected responsiveness trajectory.

The procedure 2100 may further include an operation of, wherein the platform capability value comprises a work request quality of service value, determining a segment capacity value 2102 for at least one segment of the plurality of worker segments, and determining the plurality of worker segments 1908 in response to the segment capacity value. These operations may be an iterative operation to determine segments, check capability, and update segments until capability is achieved or some optimal is reached.

The procedure 2100 may further include providing the plurality of worker segments having a selected capacity trajectory or having a selected responsiveness trajectory.

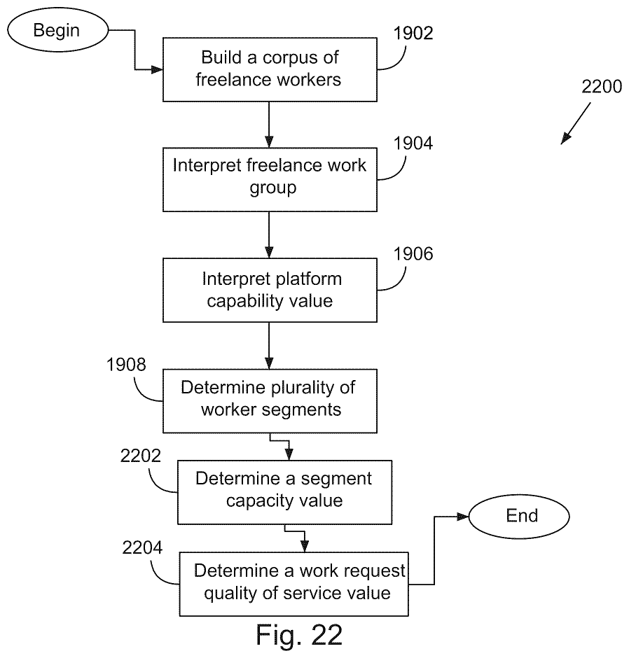

Referring to FIG. 22, a procedure 2200 may further include, wherein the platform capability value comprises a work request quality of service value (e.g., has a QoS requirement), an operation of determining a segment capacity value 2202 for at least one segment of the plurality of worker segments, and determining the work request quality of service value 2204 (e.g., expected QoS achieved with this segmentation) in response to the segment capacity value.

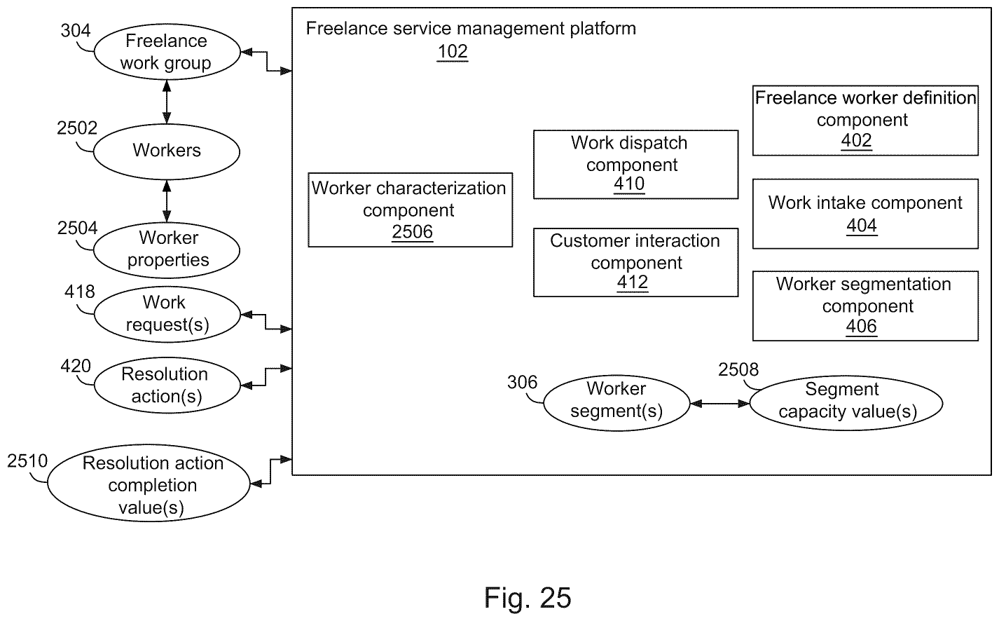

Referring now to FIG. 25, a matching engine may perform scheduled matching of customer inquiries (CIs) to freelance workers (FWs). FIG. 25 depicts a system including an example freelance service management platform 102 including a freelance worker definition component 402 configured to interpret a freelance work group 304 comprising a plurality of freelance workers 2502, and a plurality of worker properties 2504 each corresponding to one of the plurality of freelance workers 2502. The example freelance service management platform 102 further includes a work intake component 404 configured to interpret a work request 418 (e.g., customer inquiry), a worker segmentation component 406 configured to determine a plurality of worker segments 306 in response to the freelance work group 304 and the plurality of worker properties 2504, and a work dispatch component 410 configured to offer a resolution action 420 to the work request 418 to the worker segments 306, and repeating the offering until at least one freelance worker 2502 accepts the resolution action 420. In some examples, the offering is sequential to the worker segments 306. In some examples, one worker segment 306 is offered and if there are no takers, a next worker segment is offered and offering may be discontinued or may continue to the first worker segment 306. In some examples, determining the plurality of worker segments 306 is further in response to the work request 418. Throughout this disclosure, the work dispatch component 410 may also be referred to as work element resolution 118. Offering the resolution action 420 may include communicating it to the worker, tracking it to completion, and any evaluation of the work activity.

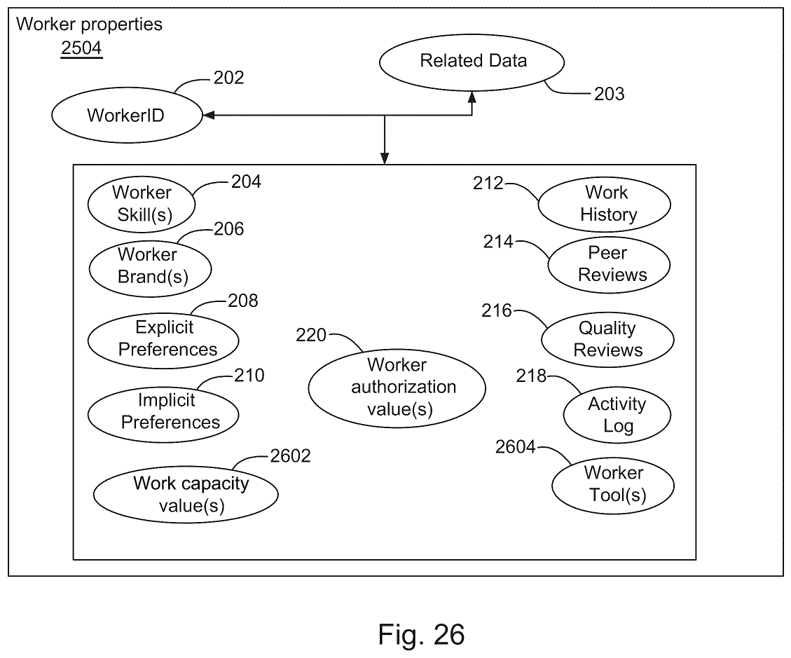

In examples, and referring to FIG. 26, the plurality of worker properties 2504 includes at least one property selected from: a freelance worker identifier 202, a freelance worker skill description 204, a freelance worker tool description 2604 (also known as tool description(s) 220), a freelance worker brand value 206, explicit preferences 208, implicit preferences 210, peer reviews 214, quality revies 216, activity log 218, or a work capacity value 2602. Worker properties 2504 are useful for qualifying workers for segments. Workers have to have the right skill so freelance worker skill description 204 may be used as a qualifier, and the freelance worker identifier 202 can link everything else (work capacity, responsiveness, quality, etc.). In an example, the freelance worker brand value 206, which may describe the sorts of brands/topics of special interest or expertise possessed by the worker, may be used as a simple qualifier.

In examples, the worker segmentation component 406 is further configured to determine a segment capacity value 2508 for segments of the plurality of worker segments 306, and to determine the plurality of worker segments 306 in response to the segment capacity values 2508. These determinations could be iterative, which could be before the first segmentation or done over time (e.g., associate segments together that are about right, and then modulate over time; or create segments, determine their capacity, adjust segments, etc., until the selected balance is achieved—these concepts can be combined with an element of being responsive to changes in the worker properties that evolve).

In examples, capacity of the segment could be a raw capacity number (e.g., each segment is capable of 500 units per day), or a responsiveness number (e.g., 500 units per day is an “average” response time of 173 seconds), and these may be related in the inverse (similar to electrical conductivity or resistance). Depending on the scheme utilized, work history, implicit preferences, and activity log information can apply statistical nuance in improving the match. For example, the variability of the actual capacity or responsiveness can be estimated, Poisson distribution equivalent can achieve a more realistic number (e.g., modeling the clumping of activity by individual workers and the segment as a whole). This allows creation of segments having the estimated capacity and/or responsiveness (C/R) with a defined confidence value.

In examples, segments may not be equal by design. For example, segments may have an increasing or decreasing trajectory for C/R, segments with high capacity and lower responsiveness (e.g., due to highly clumped high capacity capability) may be placed earlier or later in the sequence, etc.

In examples, time of day may be a factor in capacity and/or responsiveness, which could lead to a highly distinct segmentation (and/or worker properties) based on time of day, calendar events, holidays, weekends, or the like.

In examples, the worker segmentation component 406 is further configured to provide the plurality of worker segments 306 having a selected capacity trajectory 1404. In examples, the worker segmentation component 406 is further configured to provide the plurality of worker segments 306 having a selected responsiveness trajectory 1408. Capacity and/or responsiveness trajectory not only refers to the sequence of capacity/responsiveness values (e.g.: 500, 500, 500 for 3 segments, or 500, 200, 100, or 100, 200, 500, etc.) but also the residence time for each offering to a segment (e.g., 3 minutes each, 3/2/1 minutes, etc.). In examples, the treatment of the offering at the final segment is variable. For example, the offering may be dumped into a final segment until serviced, recycled to the beginning segment, etc. Offering the request may be combined with a reward trajectory, typically increasing the reward with time until the request is serviced.

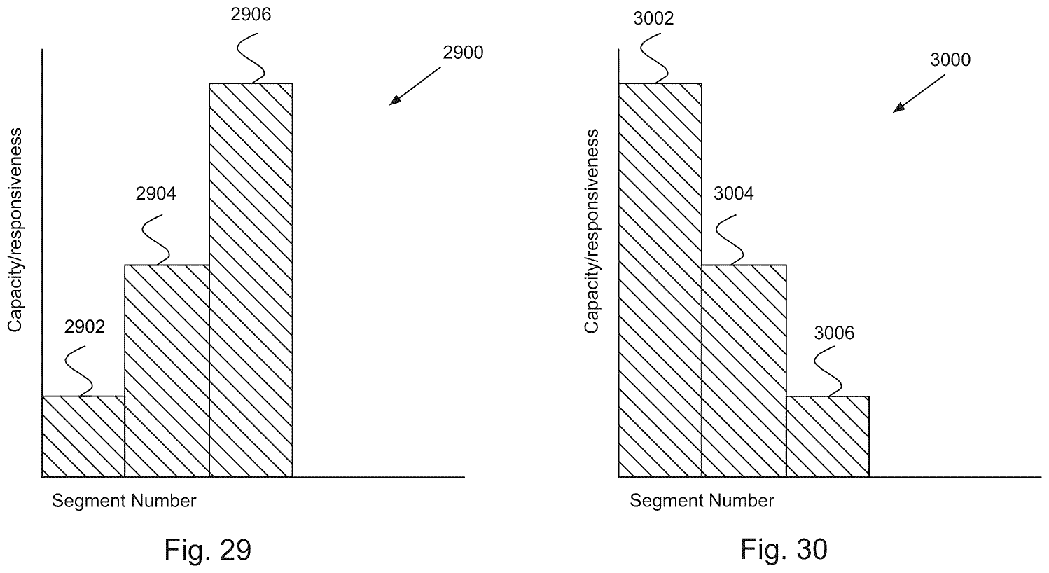

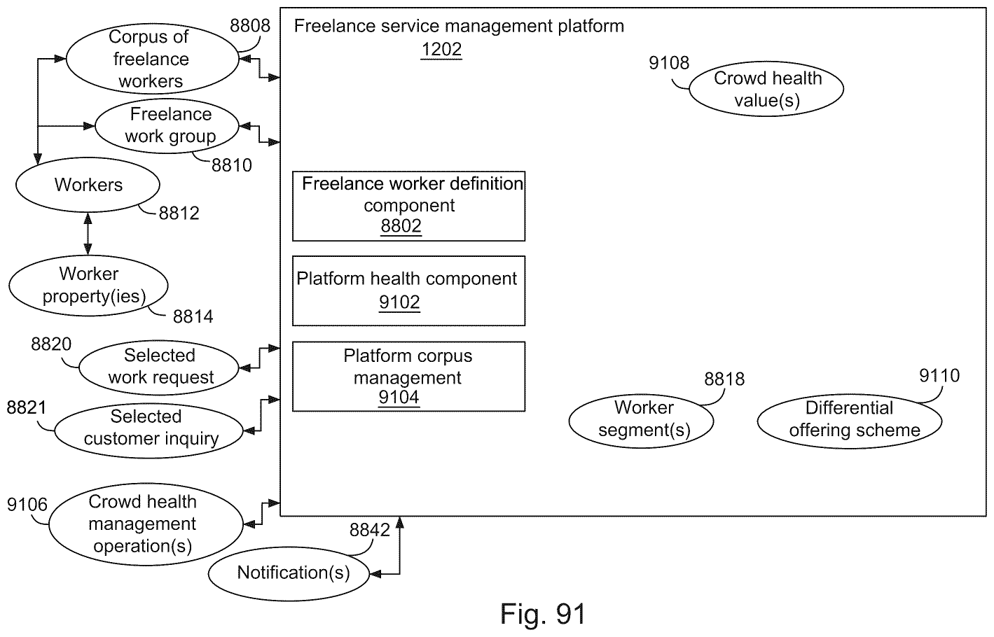

Numerous operations throughout the present disclosure reference differentially offering resolution actions, peer review actions, or other work elements, to worker segments on the platform 1202. Differentially offering, as utilized herein, should be understood broadly. Operations to differentially offer a work element to worker segments includes offering the work element to worker segments with a difference in the offer, including a time difference (e.g., offering to one segment earlier and/or longer than to another segment), a reward difference (e.g., offering a different reward amount, and/or reward trajectory, to one segment than to another segment), a communication difference (e.g., providing different communication text, communication location such as text, messaging, and/or interface notification, to two different segments). In certain embodiments, the overall logic for performing the differentially offering is referenced as a differential offering scheme 9110 (e.g., reference FIG. 91), where the differential offering scheme 9110 may include parameters for offering to each segment, changes over elapsed time (e.g., since the work element was received, accepted, and/or according to a progression of tasks for the resolution action. In certain embodiments, the platform 1202 may store multiple differential offering schemes 9110, for example based on properties of the work element (e.g., properties of a customer inquiry and/or work request), a related customer (e.g., a customer utilizing the platform 1202 to provide resolution actions to work elements for one or more of their products or services), calendar time (e.g., adjusting differential offering schemes 9110 for weekends, holidays, events, etc.), and/or adjustments to platform targets (e.g., target response times, quality values, contractual obligations, KPIs, etc.). Referring now to FIG. 29, the capacity/responsiveness of various segments are depicted on a bar graph 2900 with the segment 2902 having the least capacity/responsiveness, segment 2904 having more capacity/responsiveness, and segment 2906 having the most capacity/responsiveness. The trajectory across these segments is increasing capacity/responsiveness. In this example, the width of the segment bars, which may indicate that the depicted segments 2902, 2904, 2906 have the same size (e.g., number of freelance workers within each segment) and/or that an offer is provided to each segment for a same amount of time. In certain embodiments, a graph 2900 such as that depicted in FIGS. 29-33 can assist in planning the capability of each segment, for example where an area of a given segment bar 2902 provides an indication of the likelihood that an offered resolution action will be accepted by that segment. The selected axes for such a graph, and/or the utilization of graphical features such as areas, slopes, or the like, are non-limiting examples. It will be understood that determining the likelihood of a segment acceptance, and/or the timing of such acceptance, involves more than two dimensions of interest (e.g., resolution completion rate, resolution acceptance timing, number of workers in the segment, variability of worker capabilities within the segment, etc.), such that a single two-dimensional graph does not encompass all possible variables for planning a differential offering to segments. However, graphs such as those depicted herein can assist in ensuring that design parameters (e.g., number of workers in a segment, timing of offerings, responsiveness or capability, etc.) are visibly evident in the graph (e.g., as an area, slope, vertical extent, horizontal extent, etc.), allowing for a user to understand and/or modify those design parameters. In certain embodiments, determination of appropriate segments for the differential offering, and/or parameters of the differential offering scheme 9110, may be determined analytically based on a model of worker and segment performance, and/or an analytical analysis of graphical elements (which readily allows for n-dimensional analysis).

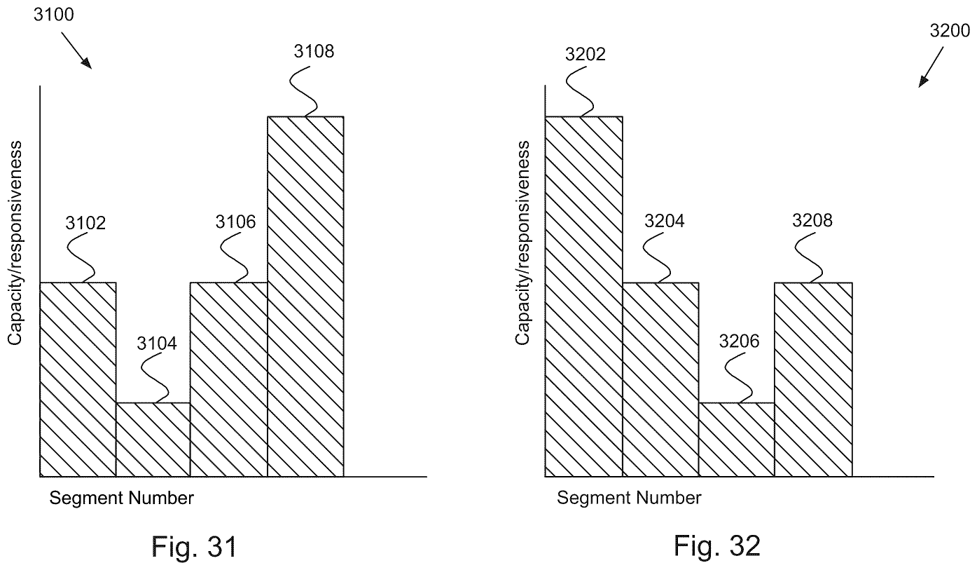

Referring to FIG. 30, the capacity/responsiveness of various segments are depicted on a bar graph 3000 with the segment 3002 having the most capacity/responsiveness, segment 3004 having less capacity/responsiveness than segment 3002, and segment 3006 having the most capacity/responsiveness. The trajectory across these segments is decreasing capacity/responsiveness. Referring to FIG. 31, the capacity/responsiveness of various segments are depicted on a bar graph 3100 wherein the capacity/responsiveness has a variable trajectory across segments. In this case, the first and third segments 3102, 3106 have similar capacity/responsiveness with segment 3104 have less capacity/responsiveness and segment 3108 having more capacity/responsiveness. Referring to FIG. 32, the capacity/responsiveness of various segments are depicted on a bar graph 3200 wherein the capacity/responsiveness has a variable trajectory across segments. In this example, the width of the segment bars is all the same indicating that the sizes are similar. In this case, the second and fourth segments 3204, 3208 have similar capacity/responsiveness with segment 3206 have less capacity/responsiveness and segment 3202 having more capacity/responsiveness.

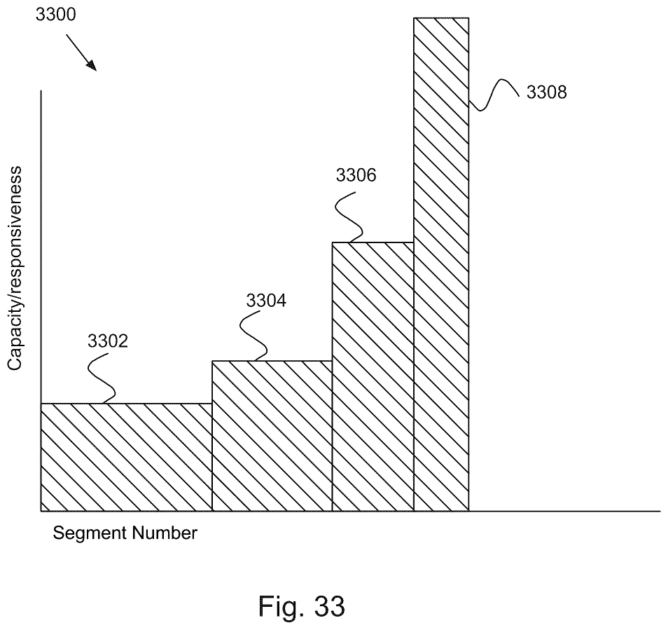

Referring to FIG. 33, the capacity/responsiveness of various segments are depicted on a bar graph 3300 wherein the capacity/responsiveness has an increasing trajectory across segments. In the example of FIG. 33, the width of the segments is varied, for example indicating that segments have varying numbers of freelance workers therein, and/or that the segments are offered a given resolution action for different amounts of time. In this case, segment 3302 has the greatest width but the least capacity/responsiveness, segment 3304 has a narrower width than segment 3302 but more capacity/responsiveness, segment 3306 has a yet narrower width but more the capacity/responsiveness of various segments are depicted on a bar graph wherein the capacity/responsiveness has a variable trajectory across segments. The final example segment 3308 has the narrowest width but the most capacity/responsiveness.

Without limitation to any other aspect of the present disclosure, an example such as FIG. 29 may be utilized to ensure that resolution actions are likely to be accepted on a first cycle through the segments (e.g., where segment 2906 serves to clean up resolution actions), and/or to ensure stable operation of the platform, for example providing for increased capability to be engaged as the number of work elements increases. An example such as FIG. 30 may be utilized to provide for rapid responses to resolution actions, for example providing a highly responsive segment up front. In the example of FIG. 30, stability may not be a primary goal, for example where the rate of customer inquiries and/or work requests is well understood and well behaved, and/or where the segment 3002 also serves as a stability segment (e.g., on a second round of offering through the segments, for example allowing the cost of resolution action acceptance on the second round to provide the stability). An example such as in FIGS. 31 and 32 provides for a mixed balance between responsiveness and stability, at the slight cost of managing more segments than in the examples of FIGS. 29 and 30. An example such as in FIG. 33 promotes both stability and responsiveness, accepting that a first segment 3302 may buy responsiveness either with additional workers in the segment, and/or with additional time offered to the segment for acceptance. The examples of FIGS. 29-33 are non-limiting examples to illustrate certain aspects of the present disclosure, differential offering operations, and differential offering schemes 9110.

In examples, the system further includes wherein the plurality of worker properties 2504 include a work capacity value 2602 and a work history 212, and wherein the worker segmentation component 406 is further configured to determine a segment capacity value 2508 for segments of the plurality of worker segments 306, and to determine the plurality of worker segments 306 in response to the segment capacity values 2508.

Examples of the platform 102 further include a worker characterization component 2506 configured to determine a resolution action completion value 2510, and to update the work history 212 of the at least one freelance worker 2502 (e.g., an accepting worker) that accepted the resolution action 420 in response to the resolution action completion value 2510. Examples of the resolution action completion value 2510 may include declining the work element after acceptance (e.g., a worker disengagement communication is received)

Examples of the system further include wherein the plurality of worker properties 2504 include a work capacity value 2602, a work history 212 (e.g., accepted actions, timing thereof, resolution success, reviews, etc.), and a worker activity log 218, and wherein the worker segmentation component 406 is further configured to determine a segment capacity value 2508 for segments of the plurality of worker segments 306, and to determine the plurality of worker segments 306 in response to the segment capacity values 2508. Examples of the worker activity log 218 may include time of day, methods of interfacing, communication methods used and that work, how many things are viewed before acceptance, characteristics of requests that are accepted, tools or techniques used to resolve, dialog length/terminology/duration/timing (e.g., with customer), and the like.

Examples of the platform 102 further include a worker characterization component 2506 configured to determine a resolution action completion value 2510, and to update at least one of the work history 212 or the worker activity log 218 of the at least one freelance worker 2502 that accepted the resolution action 420 in response to the resolution action completion value 2510.

Examples of the worker segmentation component 406 are further configured to determine the plurality of worker segments 306 in response to the work request 418. In examples, determining may include an element of responsiveness/urgency required for this work request, amount of work required for this request, customer considerations (e.g., higher service level (e.g., important, repeat, subscription based, associated entity), history including relevance to this request, customer capability or other complications that might adjust the difficulty of managing the request for this customer), customer capability could be language proficiency, technology proficiency, access available to customer device, or the like.

In certain examples, the plurality of worker properties 2504 include a work capacity value 2602, wherein the work capacity value 2602 includes at least one of: a work quantity value 2702, a work rate value 2704, a response time value 2706, or a resolution time value 2708.

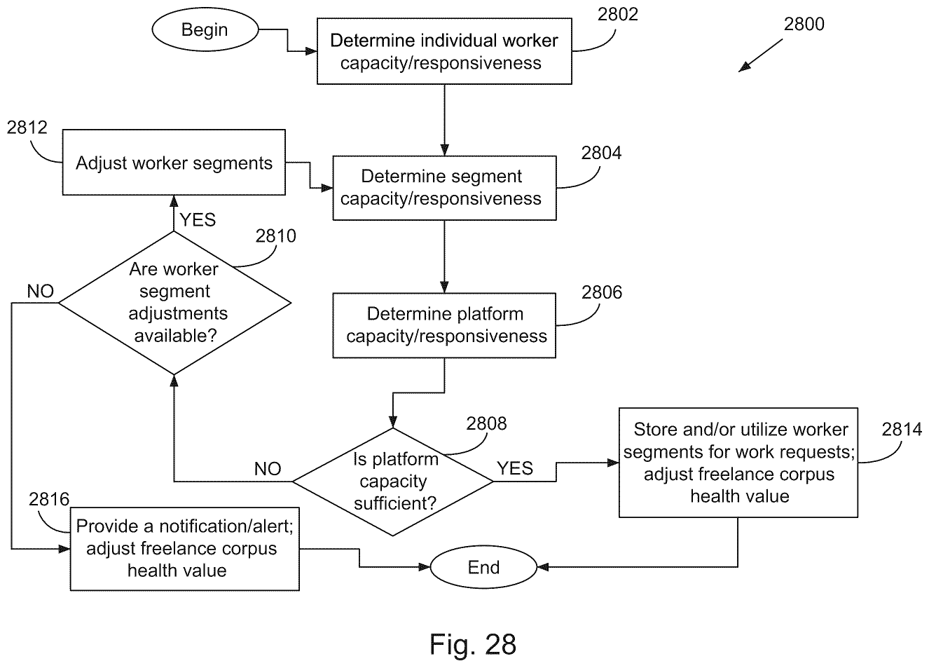

Referring now to FIG. 28, an example procedure 2800 includes an operation 2802 of determining individual worker capacity/responsiveness, an operation 2804 of determining segment capacity/responsiveness, and an operation 2806 of determining platform capacity/responsiveness. The example procedure 2800 includes a decision point 2808 of determining if the platform capability is sufficient. If it is, processing flow of the procedure 2800 continues to an operation 2814 of storing and/or utilizing worker segments for worker requests and adjusting he freelance corpus health value. If the answer at the decision point 2808 is no, processing flow continues to another decision point 2810 where it is determined if worker segment adjustments are available. If worker segment adjustments are available, processing flow continues to an operation 2812 of adjusting worker segments after which processing flow returns to the operation 2804. If worker segment adjustments are not available, processing flow continues to an operation 2816 of providing a notification/alert and adjusting the freelance corpus health value.

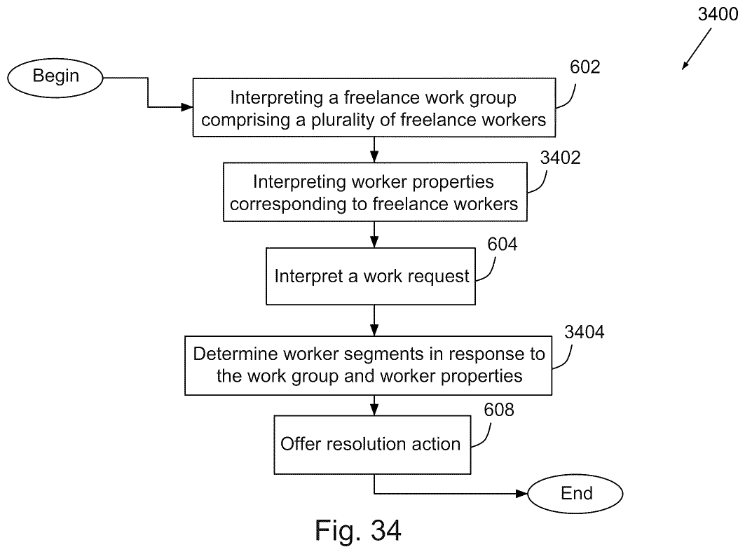

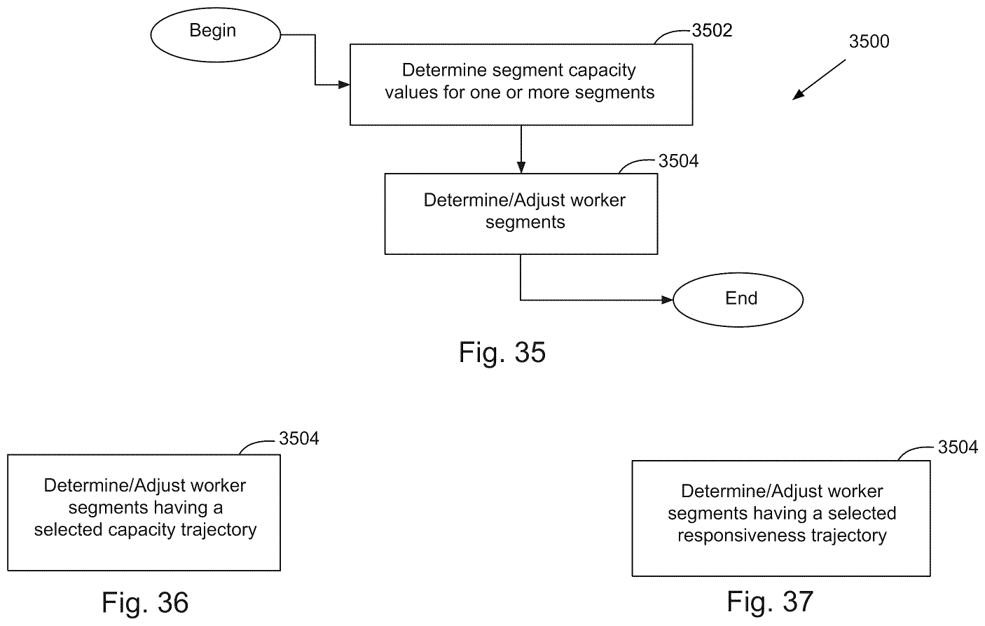

Referring to FIG. 34, an example procedure 3400 includes an operation 602 of interpreting a freelance work group comprising a plurality of freelance workers, an operation 3402 of interpreting a plurality of worker properties each corresponding to one of the plurality of freelance workers, an operation 604 of interpreting a work request, an operation 3404 of determining a plurality of worker segments in response to the freelance work group and the plurality of worker properties, and an operation 608 of offering a resolution action to the work request to each of the worker segments, and repeating the offering until at least one freelance worker accepts the resolution action, wherein the offering is sequential in some examples. An example procedure 3500, and referring to FIG. 35, includes an operation 3502 of determining a segment capacity value for each segment of the plurality of worker segments in response to a work capacity value for each of the plurality of freelance workers, and an operation 3504 of determining the plurality of worker segments further in response to the segment capacity values. Referring to FIG. 36, the example procedure 3500 may include an operation 3504 of determining/adjusting worker segments having a selected capacity trajectory. Referring to FIG. 37, the example procedure 3500 may include an operation 3504 of determining/adjusting worker segments having a selected responsiveness trajectory. The example procedure 3500 may include providing the plurality of worker segments having a selected capacity trajectory or providing the plurality of worker segments having a selected responsiveness trajectory.

The example procedure 3400 further includes determining a segment capacity value for each segment of the plurality of worker segments in response to a work capacity value and a work history for each of the plurality of freelance workers, and determining the plurality of worker segments further in response to the segment capacity values. Some examples include providing the plurality of worker segments having a selected capacity trajectory or providing the plurality of worker segments having a selected responsiveness trajectory.

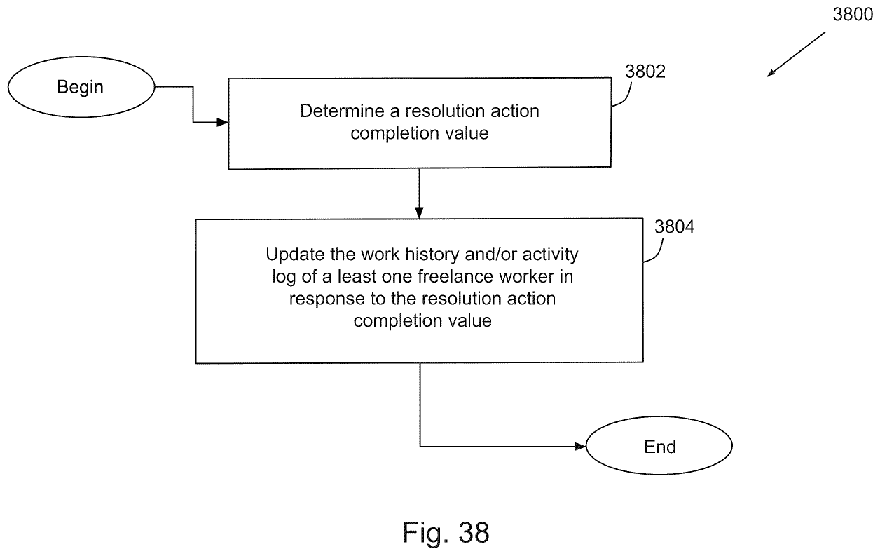

Referring to FIG. 38, an example procedure 3800 includes an operation 3802 of determining a resolution action completion value, and an operation 3804 updating the work history of the at least one freelance worker that accepted the resolution action in response to the resolution action completion value.

The example procedure 3400 further includes determining a segment capacity value for each segment of the plurality of worker segments in response to a work capacity value, a work history, and a worker activity log for each of the plurality of freelance workers, and determining the plurality of worker segments further in response to the segment capacity values. Some examples include providing the plurality of worker segments having a selected capacity trajectory or providing the plurality of worker segments having a selected responsiveness trajectory. Some examples include determining a resolution action completion value, and updating at least one of the work history or the worker activity log of the at least one freelance worker that accepted the resolution action in response to the resolution action completion value.

The example procedure 3400 further includes determining the plurality of worker segments in response to the work request.

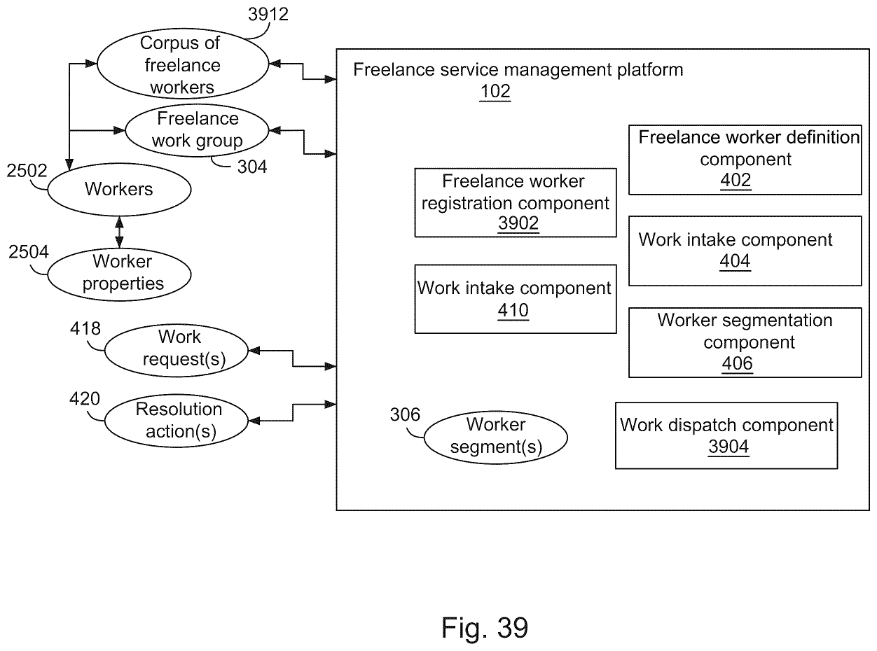

Referring to FIG. 39, an example system includes a freelance service management platform 102 a freelance worker registration component 3902 configured to build a corpus of freelance workers 3912 comprising a plurality of freelance workers 2502, and a plurality of worker properties 2504 corresponding to the plurality of freelance workers 2502, a freelance worker definition component 402 configured to interpret a freelance work group 304 in response to the plurality of worker properties 2504, the freelance work group 304 comprising a plurality of freelance workers 2502 available to service a selected work request 418, and a worker segmentation component 406 configured to determine a plurality of worker segments 306 in response to the freelance work group 304 and the plurality of worker properties 2504. In this example, available may mean capable of performing the selected work request, generally based on skills and tools, possibly time of day or other constraints. Selected work request may refer to an actual request, but generally is a model request having the selected properties that are useful for gating real requests. An example selected work request could be a set of work request properties of interest: requiring a certain skill, requiring a certain tool, requiring a specific response time, requiring service at a given time of day, calendar date, etc. This builds the efficiency of the platform, by allowing the creation of work groups that will have known capability sets, avoiding having to perform segment operations on workers that cannot do the selected work request. Building the corpus of freelance workers 3912 may include registering and tracking all potential freelance workers on the platform, which may include retiring inactive workers, but generally includes everyone. In one example, a worker ID may be used to track a freelance worker on the platform, and a given worker could be put into multiple segments. Generally, the worker may not be in two segments of the same sequence, but rather in a first segment for a first type of work request, and a second segment for a second type of work request. In other embodiments, workers may be in one or more segments of the same sequence.

The example platform 102 further includes a work intake component 404 configured to interpret a work request 418, and a work dispatch component 3904 configured to differentially offer a resolution action to the work request to the plurality of worker segments, and repeating the differentially offering until at least one freelance worker accepts the resolution action. In some examples, the worker segmentation component 406 is further configured to update the plurality of worker segments in response to the work request. This may be real-time updating or determination of the segmentation based on the actual work request. In examples, there are basic fixed segments to start, with adjustments based on work elements, changes to worker performance or properties, etc., which allows for a good rough cut of segments for efficient adjustment rather than full raw segment determination each time. It should be understood that full raw segment determination each time is also contemplated by this disclosure.

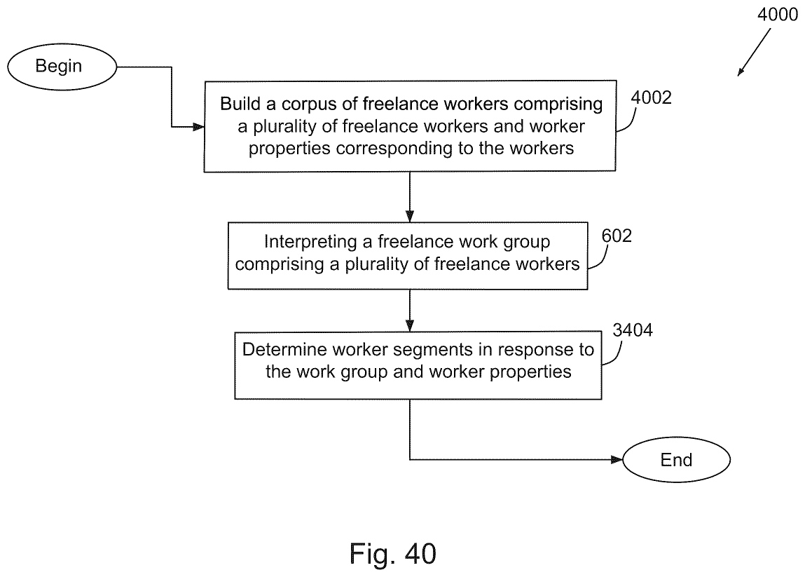

Referring to FIG. 40, an example procedure 4000 includes an operation 4002 of building a corpus of freelance workers comprising a plurality of freelance workers, and a plurality of worker properties corresponding to the plurality of freelance workers, an operation 602 of interpreting a freelance work group in response to the plurality of worker properties, by determining which freelance workers are available to service a selected work request, and an operation 3404 of determining a plurality of worker segments in response to the freelance work group and the plurality of worker properties. The example procedure 4000 may further include interpreting a work request, and differentially offering a resolution action to the work request to the plurality of worker segments, and repeating the differentially offering until at least one freelance worker accepts the resolution action. The example procedure 4000 may further include updating the plurality of worker segments in response to the work request.

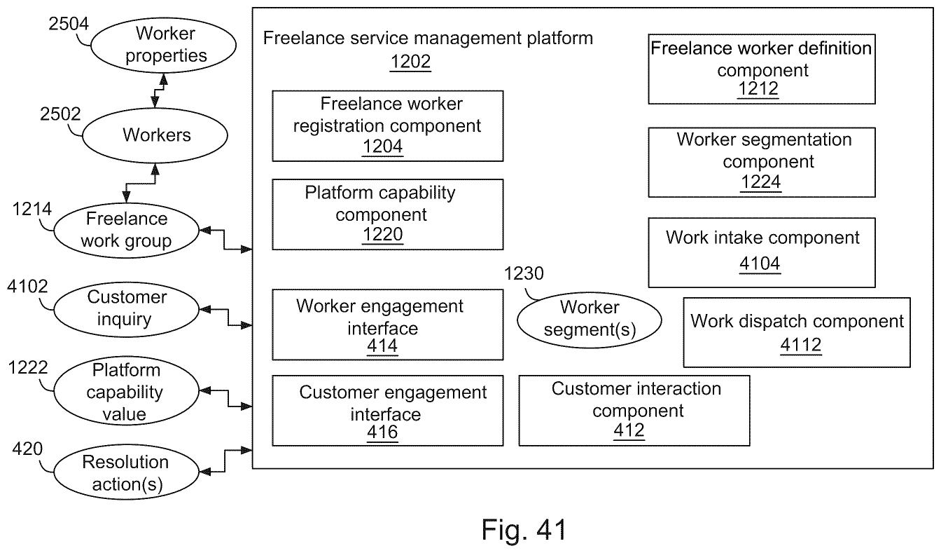

Referring to FIG. 41, an example system includes a freelance service management platform 1202 including a freelance worker definition component 1212 configured to interpret a freelance work group 1214 comprising a plurality of freelance workers 2502, and a plurality of worker properties 2504 corresponding to the plurality of freelance workers 2502, a customer interaction component 412 configured to implement a customer request interface (e.g., as a customer engagement interface 416), and to determine a customer inquiry 4102 in response to customer interactions with the customer request interface 416, a work intake component 4104 configured to interpret the customer inquiry 4102, a worker segmentation component 1224 configured to determine a plurality of worker segments 1230 in response to the freelance work group 1214, the plurality of worker properties 2504, and the customer inquiry, a work dispatch component 4112 configured to differentially offer a resolution action to the customer inquiry 4102 to the plurality of worker segments 1230, and repeating the differentially offering until at least one freelance worker accepts the resolution action 420, and wherein the customer interaction component 412 is further configured to communicatively couple the customer with the at least one freelance worker that accepted the resolution action 420. The example system further includes wherein the worker segmentation component 1224 is further configured to determine the plurality of worker segments 1230 by selecting a predetermined worker segmentation 4202, 4204, 4206, 4208 in response to a comparison of properties 4302 between a selected customer inquiry and the customer inquiry 4102. In this example, a list of segmentation schemes are built based on model (e.g., selected) customer inquiries. Segmentation schemes can be built on skills, brands, any other criteria, and then selecting the “best” one of those based on a real customer inquiry compared to the model inquiries. For example, a model inquiry is “XYZ Cola” and nutritional inquiry, and a segmentation may be built from this model inquiry. Depending on how good the match is between the model and the real inquiry, the pre-built segmentation could be used in responding to the inquiry.

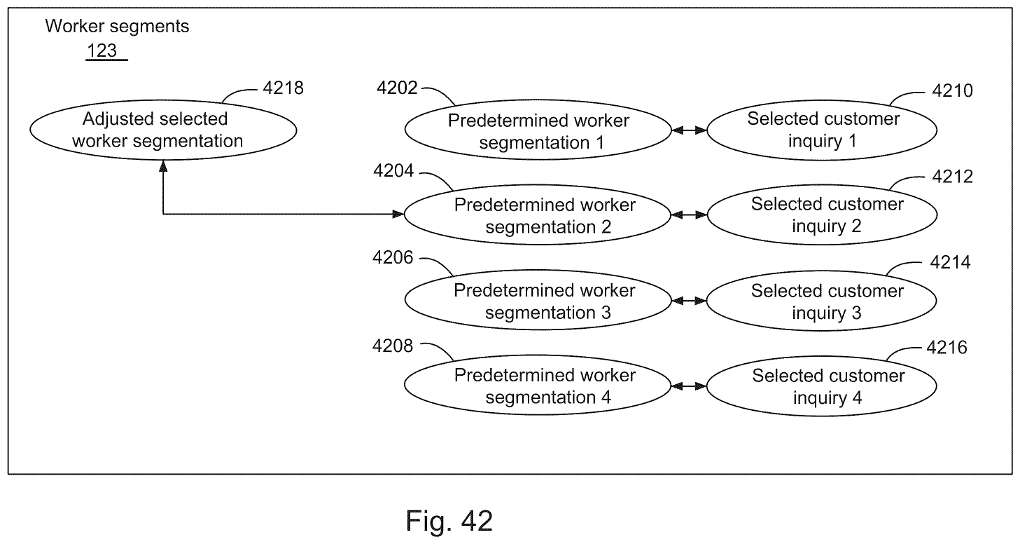

The example system further includes, and referring to FIG. 42, wherein the worker segmentation component is 1224 further configured to determine the plurality of worker segments 1230 by adjusting the predetermined worker segmentation in response to the comparison of properties between the selected customer inquiry and the customer inquiry 4102 to provide an adjusted selected worker segmentation 4218. In this example, the segments are adjusted intelligently based on the real differences. As long as the model inquiry provides a group having the needed capability (e.g., skills/tools/brands), then it can be a more efficient starting point than going from the whole corpus or even from a work group (which may have been sorted for capability).

The example system further includes wherein the worker segmentation component 1224 is further configured to determine a plurality of predetermined worker segmentations 4202, 4204, 4206, 4208 in response to properties of a plurality of selected customer inquiries 4210, 4212, 4214, 4216, and determine the plurality of worker segments 1230 by selecting one of the plurality of predetermined worker segmentations in response to a comparison of properties between the customer inquiry and at least one of the plurality of selected customer inquiries.

The example system includes, and referring to FIG. 43, wherein the properties of the plurality of selected customer inquiry properties 4302 include at least one of: a brand value 4304, a worker skill value 4306, a tool description 4308, or a customer property 4310.

The example system includes wherein the worker segmentation component is further configured to update the selected one of the plurality of predetermined worker segmentations 4202, 4204, 4206, 4208 in response to properties of the customer inquiry 4302.

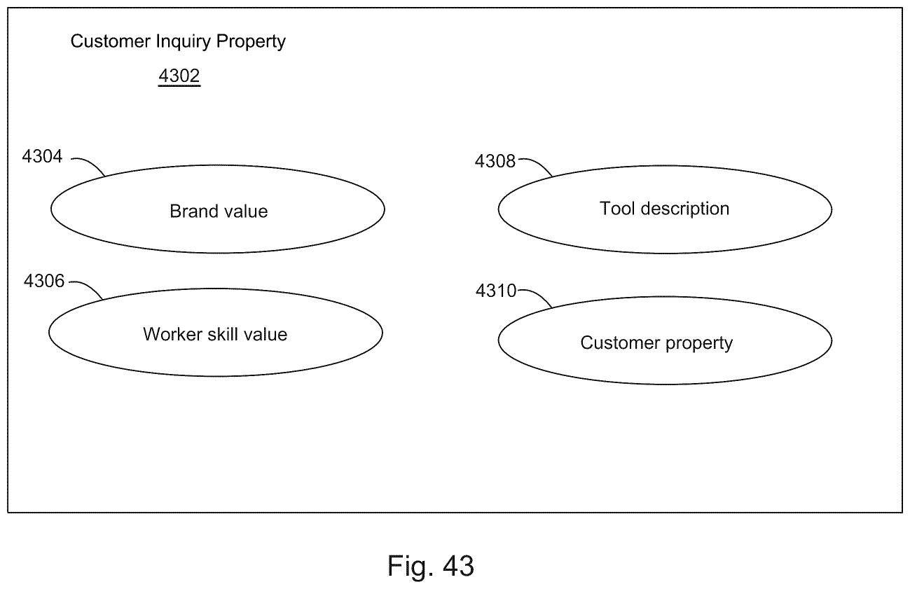

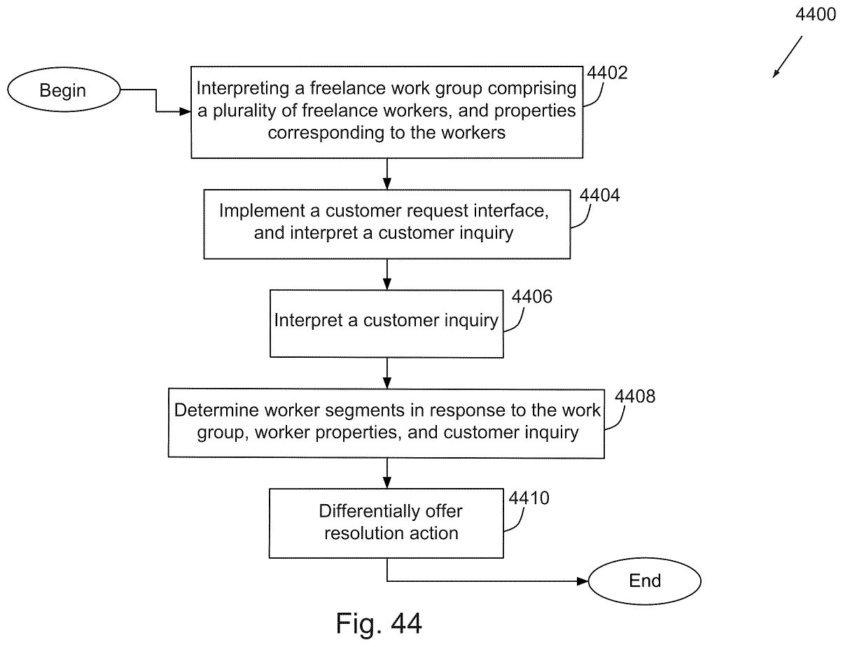

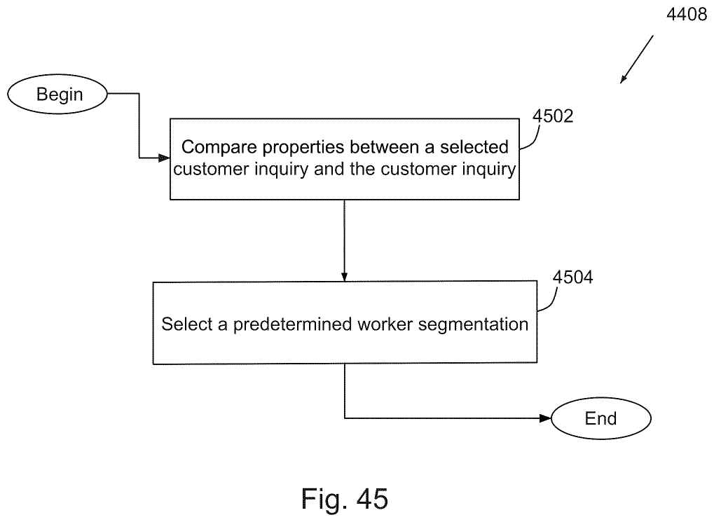

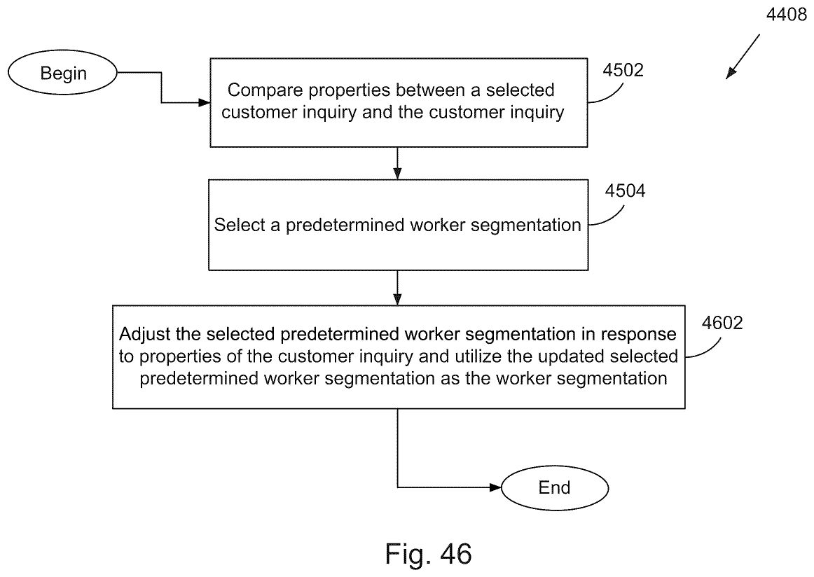

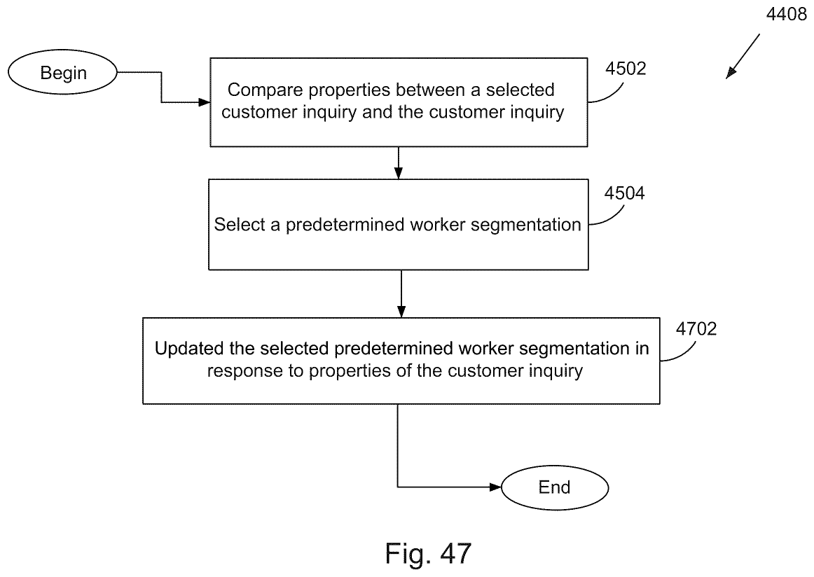

Referring to FIG. 44, an example procedure 4400 includes an operation 4402 of interpreting a freelance work group comprising a plurality of freelance workers, and a plurality of worker properties corresponding to the plurality of freelance workers, an operation 4404 of implementing a customer request interface, and determining a customer inquiry in response to customer interactions with the customer request interface, an operation 4406 of interpreting the customer inquiry, an operation 4408 of determining a plurality of worker segments in response to the freelance work group, the plurality of worker properties, and the customer inquiry, and an operation 4410 of differentially offering a resolution action to the customer inquiry to the plurality of worker segments, and repeating the differentially offering until at least one freelance worker accepts the resolution action, and an operation of communicatively coupling the customer with the at least one freelance worker that accepted the resolution action. Interpreting the customer inquiry could be just determining the inquiry, but may also include any processing to make it ready for use in the platform, such as determining keywords, intents, required skills to address, required tools to address, associated brands, etc. Information could come from parsing the request, such as where the request comes from (e.g., a specific portal they logged in to, number they called, etc.), or the history of the customer. Communicatively coupling could be just assigning the worker, and connecting inquiry-related messages to each respective user interface, exercising a messaging or email function on the platform, etc. The example operation 4408 may include, and referring to FIG. 45, determining the plurality of worker segments by an operation 4504 of selecting a predetermined worker segmentation in response to an operation 4502 of a comparison of properties between a selected customer inquiry and the customer inquiry. The example operation 4408 may include, and referring to FIG. 46, determining the plurality of worker segments by an operation 4602 of adjusting the predetermined worker segmentation in response to the comparison of properties between the selected customer inquiry and the customer inquiry. The example procedure 4400 may include determining a plurality of predetermined worker segmentations in response to properties of a plurality of selected customer inquiries, and determining the plurality of worker segments by selecting one of the plurality of predetermined worker segmentations in response to a comparison of properties between the customer inquiry and at least one of the plurality of selected customer inquiries. The example operation 4408 may include, and referring to FIG. 47, an operation 4702 of updating the selected one of the plurality of predetermined worker segmentations in response to properties of the customer inquiry.

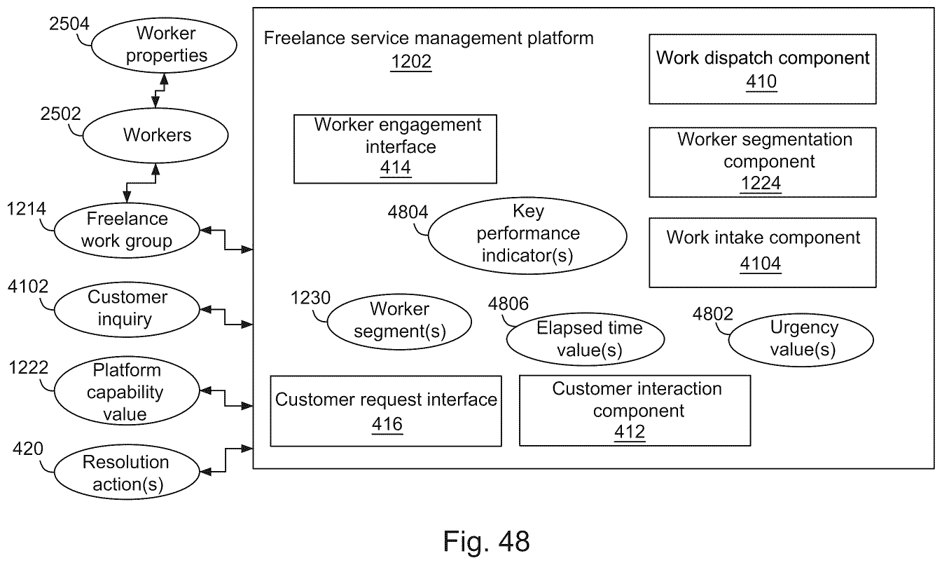

Referencing FIG. 48, an example system includes a freelance service management platform having a customer interaction component 412 that implements a customer request interface 416. In examples throughout the present disclosure, customers of the platform may include individuals seeking customer assistance, for example relating to a particular produce, service, brand, or the like. In certain embodiments, customers of the platform may include individuals or entities supported by the platform 1202, for example a company, brand, or other entity that utilizes the platform 1202 to provide support or assistance for customers (e.g., consumers) of their products, services, or brands. The example customer interaction component 412 determines a customer inquiry 4102 (e.g., a request for customer support, assistance, fixing an issue, etc.) in response to interactions of a customer with the customer request interface 416. The example platform 1202 includes a work intake component 4104 that interprets the customer inquiry 4102, and determines an urgency value 4802 for the customer inquiry 4102. Embodiments throughout the present disclosure include operations on customer inquiries or work requests, which may include any work element to be processed by the platform and resolved by a freelance worker 2502 of the freelance work group 1214 (and/or of a corpus of freelance workers). The utilization of the terms customer inquiry or work requests is to provide clarity to particular illustrative embodiments, but any given work element (e.g., a customer service activity, quality review activity, peer review activity, or the like) may be addressed by any embodiments herein, and the terminology using a customer inquiry or work request is not limiting to any embodiments. Any examples referencing a customer inquiry may additionally or alternatively be understood to reference a work request, and any examples referencing a work request may additionally or alternatively be understood to reference a customer inquiry. In certain embodiments, the work element (e.g., a customer inquiry and/or a work request) is determined by a first component (e.g., the customer interaction component 412) and interpreted by a second component (e.g., the work intake component 4104). In certain embodiments, the determining operation brings the work element onto the platform 1202, for example by accepting a form, message, call, or the like, from the customer requesting the work element, and the interpreting operation prepares the work element for direct use by the platform 1202, for example including operations such as parsing information from the work element, reading fields of data from a form, performing text recognition and/or voice to text recognition, determining classifications of message, determining intents, moods, or sentiments of a message, or the like. In certain embodiments, the initial intake of the work element may be directly utilized by the platform 1202 (e.g., a customer utilizing a form that is correctly filled out), where the interpreting operation includes utilizing the work element directly as determined by the initial component. In certain embodiments, one or more of the operations to determine the work element and the interpret the work element may be omitted (e.g., by interpreting a customer inquiry and/or work request directly from stored data, and/or determining the customer inquiry and/or work request as a directly utilizable work element), and/or the interpreting operation may include just passing the determined work element to other components of the platform 1202 that are utilized in operations described throughout the present disclosure for the particular work element.

The example platform 1202 includes a work dispatch component 410 that differentially offers a resolution action 420 to the customer inquiry 4102 to a number of worker segments 1230 in response to the urgency value 4802, and repeating the differentially offering until at least one freelance worker accepts the resolution action 420. Without limitation to any other aspect of the present disclosure, operations to differentially offer the resolution action 420 to the worker segments 1230 includes any operation that offers the resolution action 420 to at least one worker segment, and provides a difference in the offering between at least two of the worker segments 1230. For example, for a particular customer inquiry 4102 having two applicable worker segments 1230, an operation to differentially offer the resolution action 420 for the customer inquiry 4102 may include offering the resolution action 420 to a first one of the worker segments 1230 but not to the other one of the worker segments 1230. Without limitation to any other aspect of the present disclosure, example differences between offers to worker segments 1230 that are differentially offering include at least: a time difference (e.g., offering to one segment before the other one, offering to one segment for a longer period of time than another one); a reward difference (e.g., offering a different reward value to a first segment relative to another segment); a notification difference (e.g., providing a different message or message location—for example e-mail, platform messaging service, notification on a dashboard for a freelance worker enrolled with the platform 1202, etc., to different worker segments); and/or a trajectory difference (e.g., adjusting a reward trajectory between segments, even if portions of those reward trajectories provide a same reward value between segments over a portion of the trajectory).

The example customer interaction component 412 communicatively couples the customer (e.g., that provided the customer inquiry 4102, and/or that passed the customer inquiry 4102 to the platform 1202—for example where a customer service system for a particular company utilizes an API to pass customer inquiries 4102 to the platform 1202 for servicing and/or resolution) to an accepting freelance worker for the resolution action 420. Operations to communicatively couple the customer to the freelance worker include providing interfaces for each one of these with the platform 1202, exercising a chat window, exercising a messaging application for communications therebetween, or the like. In certain embodiments, communicatively coupling may be performed utilizing any method or combination of methods, where the platform 1202 is configured to monitor at least one side of the communications (e.g., monitoring the freelance worker side of a phone call). In certain embodiments, the customer interaction component 412 maintains the communicative coupling, at least intermittently, until the resolution action 420 is completed, the customer withdraws the customer inquiry 4102, the customer inquiry 4102 is transferred to another freelance worker or off the platform, or the customer inquiry 4102 is otherwise resolved.

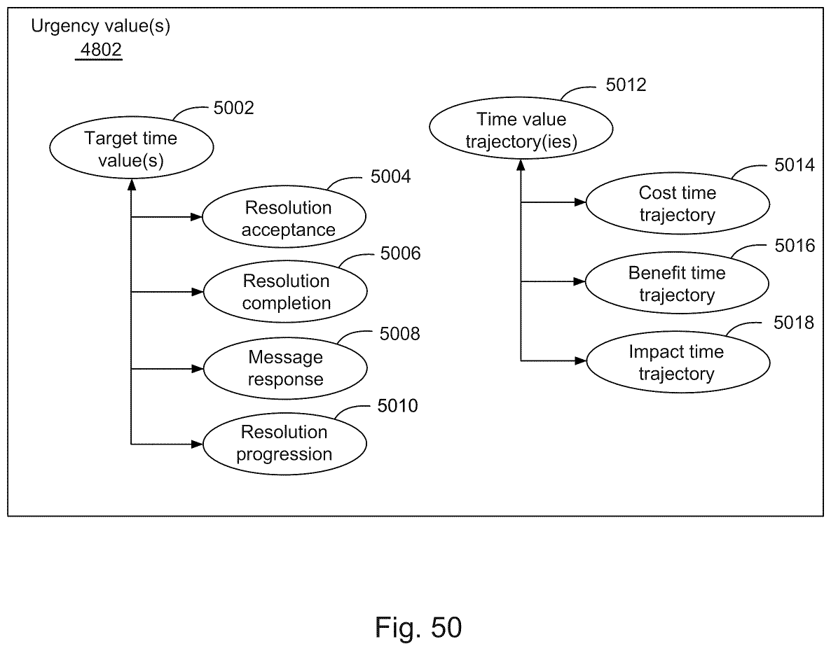

Referencing FIG. 50, example and non-limiting urgency values 4802 are schematically depicted. An urgency value 4802 may include any one or more of the examples, and/or may include any other aspects of the present disclosure that may be utilized to determine an urgency for resolving the customer inquiry and/or work request. In certain embodiments, the urgency of the work element may be related to a customer urgency (e.g., desired to resolve the work element quickly, an impact of the unresolved work element on the customer, a value to the customer of resolving the work element, etc.), a property of the work element (e.g., an associated entity, product or service provider, a brand related to the work element, etc.), and/or a property of the platform (e.g., contractual value or obligation to resolve the work element within a period of time, preserving the capacity of the platform to resolve work elements, maintaining the ability to accept new work elements, etc.). An example urgency value 4802 includes a target time value 5002 to resolve the customer inquiry (e.g., a total resolution time after acceptance, after the customer submits the work element, a deadline time to resolve the work element, etc.). The target time value 5002 may relate to a resolution acceptance 5004 (e.g., ensure the work element is accepted for a resolution action 420 within the time period), a resolution completion 5006 (e.g., ensure the resolution action 420 for the work element is completed within the time period), a message response 5008 time (e.g., ensuring messages between the freelance worker and the customer are provided within the time period), and/or a resolution progression 5010 (e.g., for a resolution action 420 having a number of steps or stages, to ensure progression between steps or stages occurs within the time period). In certain embodiments, a given work element may have multiple relevant urgency values 4802 and/or target time values 5002.

An urgency value 4802 includes a time value trajectory 5012, for example a cost time trajectory 5014 (e.g., an estimated cost of the unresolved work element over time), a benefit trajectory 5016 (e.g., an estimated benefit for resolving the work element over time), and/or an impact time trajectory 5018 (e.g., an estimated impact, for example to the customer and/or to an entity related to the customer, of the unresolved work element over time). The time value trajectory 5012 may be utilized to reflect the increasing impact, cost, or benefit to the customer over time as the resolution action 420 for the work element is not accepted, not resolved, not progressing through stages, as messaging communications during the resolution action 420 performance are not provided, or the like. In certain embodiments, the cost, benefit, or impact, may instead be related to the platform 1202 (e.g., cost of pending work elements that are not resolved, which may reduce throughput, impact the ability to maintain capacity for taking new work elements; cost of missing contractual obligations and/or degrading contractual performance, etc.), and/or to another affected entity (e.g., a company or customer contracting utilization of the platform 1202 on behalf of the customer providing the customer inquiry and/or work request). The time value trajectory 5012 may be constructed in any manner to promote the desired urgency response, for example providing an increasing cost, increasing impact, and/or reducing benefit over time. The time value trajectory 5012 may include flat spots or hold periods (e.g., impact of failure to resolve may not increase at all for a period of time), and/or may include ramping changes, curved changes (e.g., polynomial, exponential, or other changes), and/or counter moves (e.g., rising for a period, and falling over a later period, for example due to changes in available information, complex relationships between costs/benefits and time, maintaining desired delay periods for certain actions such as responses to customers for complex communications, etc.).

In certain embodiments, operations to differentially offer the resolution action 420 to worker segments 1230 in response to the urgency value(s) 4802 include selecting a segment sequencing scheme, adjusting the timing of offers to segments, adjusting a sequencing of segments, adjusting reward values provided to accepting workers from the segments, adjusting incentive values provided to accepting workers from the segments, or the like. Any operations that adjust the differential offering to segments in response to the urgency value(s) 4802 are contemplated herein.

In certain embodiments, the work intake component 4104 determines the urgency value 4802 in response to a key performance indicator (KPI) 4804 for the platform 1202. A KPI for the platform 1202 may include any type of parameter utilized to determine whether the overall performance of the platform 1202 is properly executing the mission of the platform 1202. Without limitation to any other aspect of the present disclosure, example and non-limiting KPIs include parameters such as: a number of work elements resolved; a fraction of total work elements resolved; an expressed customer satisfaction score for resolved work elements (e.g., based on direct customer feedback); a quality score for resolved work elements on the platform (e.g., based on automated reviews, quality reviews, peer reviews, or the like); performance against contractual obligations and/or incentives; average response times (e.g., times for acceptance, resolution, stage progression times, and/or messaging times); and/or platform response reserve capacity.

An example platform 1202 includes a worker segmentation component 1224 that adjusts the plurality of worker segments 1230 in response to the time value trajectory 5012 and an elapsed time value 4806 (e.g., as measured from a customer inquiry 4102 intake time, an acceptance time, a stage progression time, a time since a customer message, etc.). Operations to adjust the worker segments 1230 include any operations such as moving freelance workers between segments (e.g., to create segments having certain properties such as number of workers in the segment, capacity of the segment, responsiveness of the segment, etc.), adjusting the ordering or sequencing of segments for the differential offering, adjusting reward values offered to segments, etc.

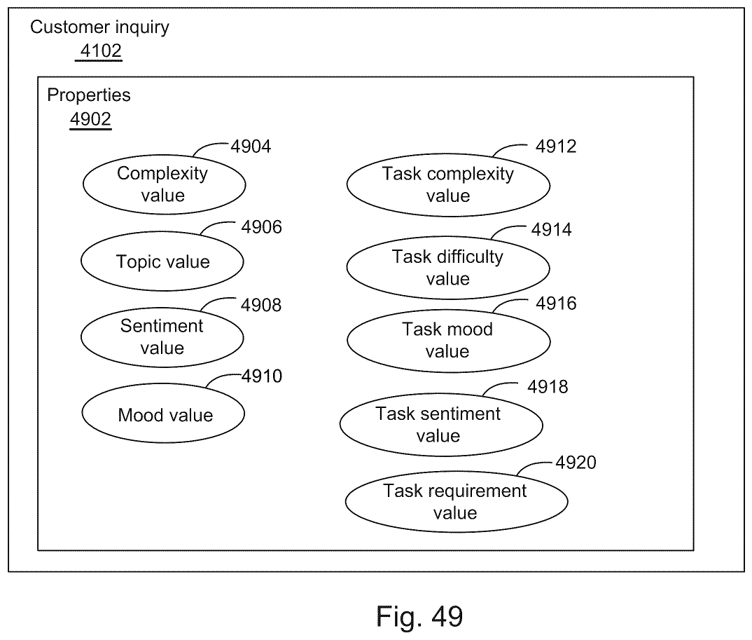

In certain embodiments, the work intake component 4104 determines the urgency value 4802 in response to a property of the customer inquiry 4102. Referencing FIG. 49, example and non-limiting properties 4902 of the customer inquiry 4102 that may be utilized to adjust the urgency value 4802 include aspects such as: a complexity value 4904 (e.g., to move complex actions to be resolved earlier, later, according to operating conditions of the platform 1202, etc.); a topic value 4906 (e.g., to resolve inquiries related to particular topics more quickly, more slowly, etc.); a sentiment value 4908 (e.g., allowing for adjustment of the urgency based on a sentiment expressed within the inquiry and/or by the existence of the inquiry); and/or a mood value 4910 (e.g., allowing for adjustment of the urgency based on a mood expressed in the inquiry). In certain embodiments, the properties 4902 may be determined by the text content of the inquiry, by the source of the inquiry (e.g., according to the device utilized to access the platform, according to a related brand, the frequency of similar inquiries, etc.), any feedback from the customer during the inquiry period, and/or according to any messages from the customer that are related to the inquiry (e.g., messages with a particular topic, mood, sentiment, utilization of particular words, etc.). In certain embodiments, properties 4902 of an inquiry may include one or more of: a task complexity value 4912 (e.g., a complexity of a task to be performed as a part of the resolution action 420); a task difficulty value 4914 (e.g., a difficulty of a task to be performed as a part of the resolution action 420, which may be distinct from a complexity of the task); a task mood value 4916 (e.g., a mood expressed by the customer and/or freelance worker in relation to a task performed during the resolution action 420); a task sentiment value 4918 (e.g., a sentiment expressed by the customer and/or freelance worker in relation to a task performed during the resolution action 420); and/or a task requirement value 4920 (e.g., a requirement, such as a skill, tool, utilization of a particular type of communication, etc., related to a task performed during the resolution action 420). The adjustments and/or determination of the urgency value 4802 allows the platform 1202 to ensure that tasks are performed within designed times, to adjust execution of the resolution action 420 before a problem develops, to ensure performance of the platform 1202, customer satisfaction, and/or freelance worker satisfaction, to move tasks within a resolution action 420 to appropriate freelance workers, and/or to ensure capability margin of the platform 1202.

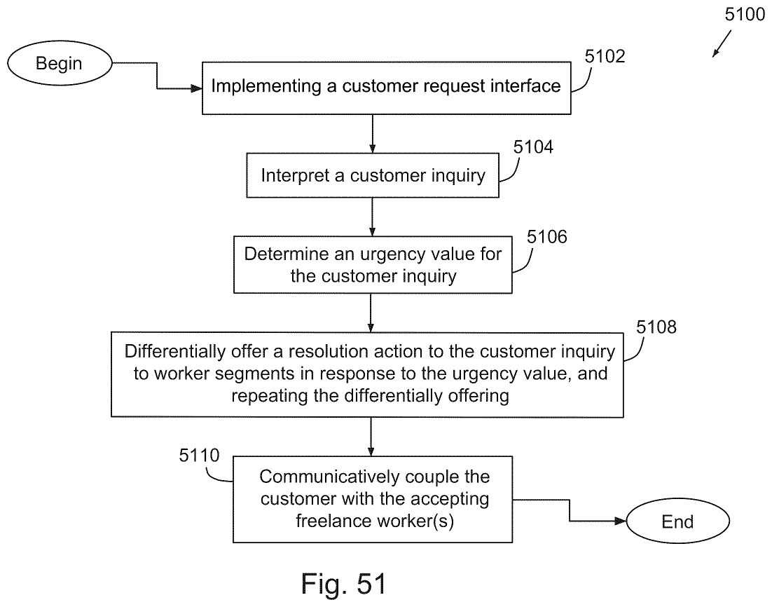

Referencing FIG. 51, an example procedure 5100 is schematically depicted to communicatively couple a customer providing a work element with a freelance worker performing a resolution action for the work element. The example procedure 5100 includes an operation 5102 to implement a customer request interface, an operation 5104 to interpret a customer inquiry, an operation 5106 to determine an urgency value for the customer inquiry, and an operation 5108 to differentially offer a resolution action to the customer inquiry to worker segments in response to the urgency value, and repeating the differentially offering until a freelance worker accepts the resolution action. The example procedure 5100 includes an operation 5110 to communicatively couple the customer with the accepting freelance worker. In certain embodiments, the example procedure 5100 includes determining the urgency value in response to a KPI, a complexity value of the customer inquiry, a topic value of the customer inquiry, and/or a mood value of the customer inquiry. An example procedure 5100 includes an operation to adjust the worker segments in response to the urgency value, where the urgency value includes a time value trajectory for the customer inquiry, and/or an elapsed time value related to the customer inquiry, the resolution action, and/or a task of the resolution action. In certain embodiments, the reward value 5202 may be varied for different worker segments, over time, based on operating conditions of the platform 1202, and/or according to varying properties of the customer inquiry 4102, for example properties of the customer inquiry 4102 where changes become apparent over the course of the intake and resolution of the inquiry, and/or changes that occur during the course of the intake and resolution of the inquiry. An example reward value 5202 is a static reward value, for example that does not change over time, which may include some variation for example with variation to distinct worker segments 1230. An example reward value 5202 is a dynamic reward value, for example a value that changes over time, operating conditions on the platform 1202, changes to the constituency of the freelance corpus, a freelance work group, and/or a freelance worker segment, and/or changes in the rate and/or content of customer inquiries, work requests, or other work elements on the platform 1202.

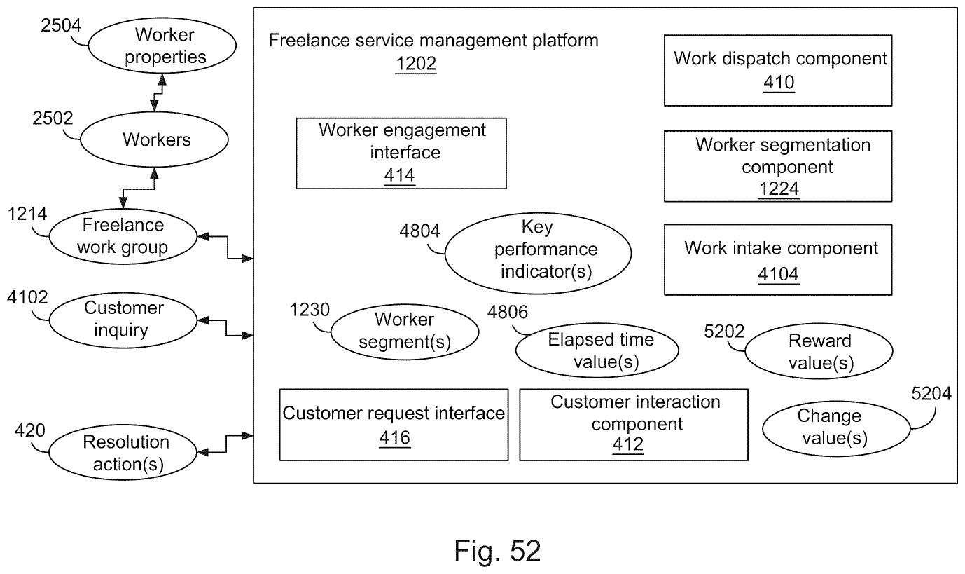

Referencing FIG. 52, an example system includes a freelance service management platform 1202 including a customer interaction component 412 that implements a customer request interface 416, and determines a customer inquiry 4102 in response to interactions of a customer with the customer request interface 416. A work intake component 404 interprets the customer inquiry 4102, and determines a reward value 5202 for the customer inquiry 4102. In certain embodiments, the reward value 5202 includes a reward (e.g., monetary value, credit value, etc.) for the resolution action 420, which may include a reward for completion of the resolution action 420 and/or portions thereof. The example platform 1202 includes a work dispatch component 410 that differentially offers a resolution action 420 to the customer inquiry 4102 to a plurality of worker segments 1230 in response to the reward value 5202, and repeats the differentially offering until at least one freelance worker accepts the resolution action 420. The customer interaction component 412 further communicatively couples the customer with the at least one freelance worker that accepted the resolution action 420.

An example work intake component 4104 determines the reward value 5202 in response to a property of the customer inquiry 4102 (e.g., reference FIG. 49 and the related description), for example providing an increased reward for complex, urgent, difficult work elements, resolution actions, and/or tasks thereof. In certain embodiments, the reward value 5202 may be adjusted for tasks that support KPIs of the platform 1202, to enhance responsiveness to the resolution action and/or tasks thereof, or the like. In certain embodiments, reward values 5202 may be adjusted for various worker properties, such as the location of the worker (e.g., to reflect cost-of-living values, jurisdictional requirements, or other considerations), the worker expert rating 2314 (e.g., to reward high quality responses from freelance workers), tools utilized by the worker and/or required to be utilized for the relevant tasks (e.g., to encourage best practices and/or to reward tasks that require tools that may be expensive or difficult to obtain), and/or skills possessed by the worker relevant to the customer inquiry and/or other work request. In certain embodiments, determining the reward value 5202 may be made in response to combinations of any of the considerations set forth throughout the present disclosure. In certain embodiments, adjustments to the reward value 5202 may be made directly (e.g., adjusting a reward value for a particular customer inquiry and/or work request) and/or indirectly (e.g., adjusting reward values for worker segments relevant to particular customer inquiries or work requests, for example where the worker segments are themselves determined based on reward considerations as set forth herein).

An example work dispatch component 410 interprets a change value 5204 for the customer inquiry 4102, and adjusts the reward value 5202 in response to the change value 5204 for the customer inquiry 4102. Any change to the customer inquiry 4102 is contemplated for a potential feature to adjust the reward value 5202, including for example: a change to a property of the customer inquiry; a delay in acceptance of a related resolution action 420, completing the resolution action 420 and/or a task thereof; progression of the resolution action 420 for a task, step, or stage of the resolution action 420; and/or a change in the platform 1202 that results in a different view of the customer inquiry 4102 (e.g., a number of available freelance workers qualified or available to perform the related resolution action 420). Operations to adjust the reward value 5202 include any operations such as: increasing the reward value; decreasing the reward value; applying an offset to the reward value; applying a function to the reward value; applying a multiplier to the reward value; switching from one reward schedule (e.g., reward descriptions according to segments, inquiries or work elements, properties thereof, etc.) to another reward schedule; and/or applying offsets, multipliers, functions, or the like to one or more reward schedules.

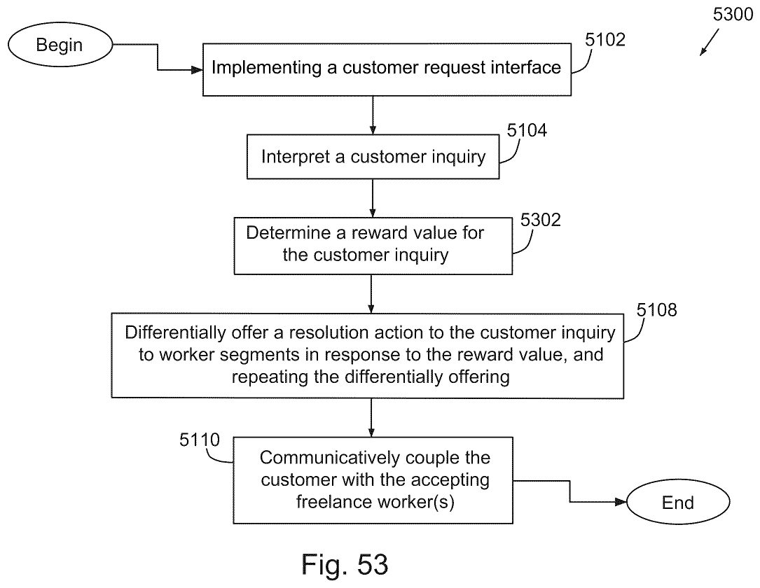

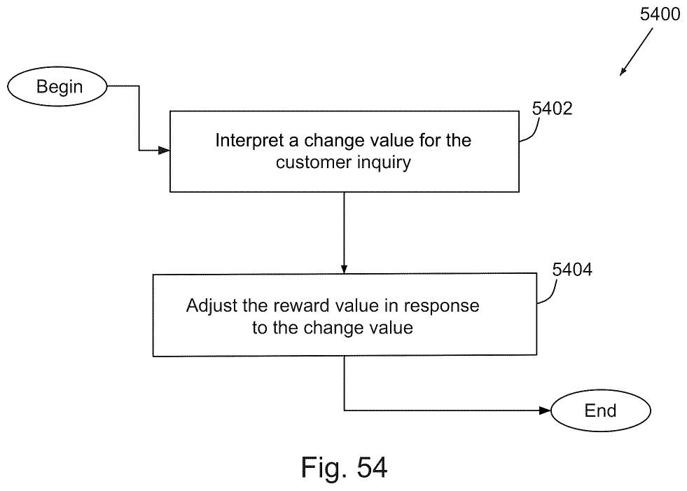

Referencing FIG. 53, an example procedure 5300 for communicatively coupling a customer with an accepting freelance worker is schematically depicted. The example procedure 5300 includes an operation 5102 to implement a customer request interface, an operation 5104 to interpret a customer inquiry, and an operation 5302 to determine a reward value for the customer inquiry. The example procedure 5300 further includes an operation 5108 to differentially offer a resolution action to the customer inquiry to worker segments in response to the reward value, and repeating the differentially offering until a freelance worker accepts the resolution action to resolve the customer inquiry. The example procedure 5300 further includes an operation 5110 to communicatively couple the customer with the accepting freelance workers. Referencing FIG. 54, an example procedure 5400 includes an operation 5402 to interpret a change value for the customer inquiry, and an operation 5404 to adjust the reward value in response to the change value for the customer inquiry. In certain embodiments, operation 5302 further includes determining the reward value in response to a task complexity value, a task difficulty value, a task mood value, and/or a task sentiment value of the customer inquiry (e.g., any one or more of these determined for the customer inquiry, a task of the resolution action, a communication from the customer, and/or a communication from the freelance worker that accepted the resolution action). Additionally or alternatively, the operation 5302 further includes determining the reward value in response to a task requirement value of the customer inquiry (e.g., a required skill, tool, time commitment, response time, etc., related to the customer inquiry, a task of the resolution action, a communication from the customer, and/or a communication from the freelance worker that accepted the resolution action).

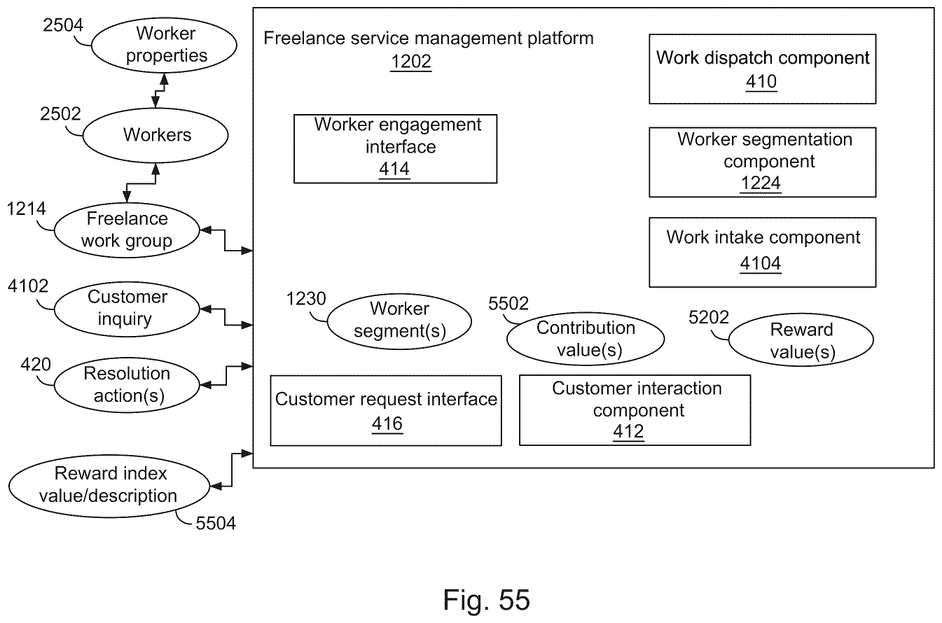

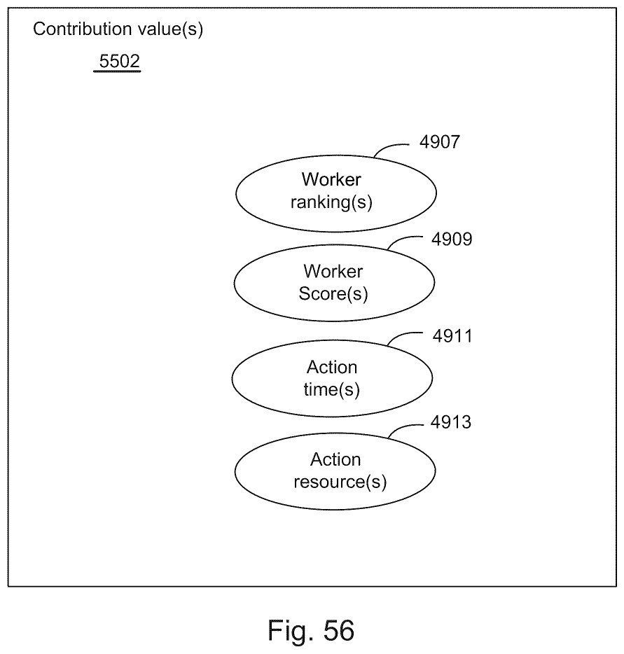

Referencing FIG. 55, an example system includes a freelance service management platform 1202 having a customer interaction component 412 that implements a customer request interface 416, and determines a customer inquiry 4102 in response to interactions of a customer with the customer request interface 416. The platform 1202 includes a work intake component 404 that interprets the customer inquiry 4102, and determines a reward value 5202 for the customer inquiry, and a work dispatch component 410 that differentially offers a resolution action 420 to the customer inquiry 4102 to a plurality of worker segments, and repeating the differentially offering until at least one freelance worker accepts the resolution action 420. The example work dispatch component 410 tracks a contribution value 5502 to the resolution action 420 for the at least one freelance worker that accepted the resolution action 420, and distributes the reward value 5202 to the freelance worker(s) in response to the contribution value(s) 5502 to the resolution action 420. For example, a first worker may accept the resolution action 420, and complete one or more tasks of the resolution action 420. In a further example, another freelance worker may become involved with the resolution action 420, without limitation for any reason as set forth throughout the present disclosure (e.g., where the first worker discontinues work on the task, where the platform 1202 transfers the resolution action 420 to another worker, where a change in the inquiry and/or resolution action 420 leads to a change in worker, for example due to a change in urgency, required skills, required tools, etc.). The example work dispatch component 410 distributes the reward value 5202 between the first worker and the second worker. Example operations to distribute the reward value 5202 include dividing the reward value 5202 evenly, ranking the contributing workers and distributing the reward value 5202 among the workers according to the ranking 4907 (e.g., reference FIG. 56), scoring the contributing workers and distributing the reward value 5202 among the workers according to the scoring 4909, or the like. In certain embodiments, the total distributed rewards according to the contribution values 5502 equal the total amount of the reward value 5202. In certain embodiments, the total distributed rewards according to the contribution values 5502 may be greater than or less than the total amount of the reward value 5202 (e.g., due to an incomplete resolution action 420, tasks that cannot be attributed, incentives applied to the customer inquiry 4102, affected aspects of the customer inquiry 4102 and/or resolution action 420 that are not attributable to the performance of the freelance workers, or the like). In certain embodiments, the contributions of the workers, including potentially ranking or scoring the workers, may be determined in response to peer review work events and/or quality review work events related to the work request, for example with a peer reviewer, expert reviewer, and/or an element of automated review, contribute to determining the contributions among the workers contributing to resolution actions or elements thereof. In certain embodiments, customer feedback related to the work request may be utilized or considered in determining the contributions among the workers.

In certain embodiments, the work dispatch component 410 distributes the reward value 5202 to the accepting freelance workers according to a ranking of the workers by contribution value 5502. For example, a ranking schedule according to the number of workers may be applied, for example with 60% going to a highest ranking worker and 40% going to a lower ranking worker that nevertheless completed aspects of the resolution action 420 sufficient to develop a contribution value 5502 attributed to the lower ranking worker. In certain embodiments, ranking schedules may be developed for different numbers of workers (e.g., 2, 3, or 5 contributing workers), and/or according to a balancing of contribution value 5502 differences between workers.

In certain embodiments, the work dispatch component 410 distributes the reward value 5202 to the accepting freelance workers according to a scoring of the workers by contribution value 5502. In certain embodiments, the scoring may be applied according to the importance of particular tasks (e.g., customer visible tasks, critical path limiting tasks, tasks involving working with personally identifiable information (PII) of the customer, etc.), according to the required skills for the tasks (e.g., tasks requiring a difficult or expensive certification may generate a higher contribution value 5502), and/or according to the required tools for the tasks (e.g., tasks requiring an expensive software application may generate a higher contribution value 5502). In certain embodiments, the distribution of the reward value 5202 may be prorated according to the scoring, applied as a function of the scoring from contributing freelance workers, or the like. In certain embodiments, distribution between workers may be based on both ranking and scoring of contributors, and/or combined with other distribution mechanisms. For example, certain tasks of the resolution action 420 may have a fixed reward value, a fixed ranking contribution, and/or a fixed scoring contribution.

In certain embodiments, the work dispatch component 410 tracks the contribution value(s) 5502 of contributing freelance workers (e.g., freelance workers that accepted the resolution action 420, whether initially or at any time during the resolution cycle of the customer inquiry and/or work element) according to an action time 4911 of the corresponding freelance worker. Without limitation to any other aspect of the present disclosure, an action time is a time spent working on one or more aspects of the resolution action 420, for example an amount of time to find responsive information, communicate with the customer, interact with tools on behalf of the customer, etc. In certain embodiments, action time may be directly measured or observed, estimated according to outputs from the freelance worker, utilized from standardized values for particular activities, or the like. In certain embodiments, the action time contribution to the contribution value 5502 may be varied according to the type of action—for example, actions that are difficult, important, requiring a high skill set, or the like, may accumulate contribution values 5502 and/or action time more quickly than other actions.

In certain embodiments, the work dispatch component 410 tracks the contribution value(s) 5502 of contributing freelance workers according to an action resource 4913 of the corresponding freelance worker. Without limitation to any other aspect of the present disclosure, an action resource involves the consumption and/or utilization of a resource to contribute to one or more aspects of the resolution action 420, for example utilization of a particular skill, tool, certification, demonstration of communication techniques (e.g., according to best practices, language analysis of communications, preferred techniques for particular customers, brands, properties of the customer inquiry, etc.).

In certain embodiments, the work dispatch component 410 tracks the contribution value(s) 5502 of contributing freelance workers by providing a reward index value to one or more contributing freelance workers in response to the contribution value(s) 5502 for those freelance workers. The utilization of a reward index value allows for combining multiple sources of contributions, for example action time, action resources, special circumstances for a customer inquiry, actions that support the platform 1202, or the like, to allow the platform 1202 to incentivize, motivate, and appropriately reward freelance workers for contributions to resolution actions 420 on the platform 1202. In certain embodiments, the work dispatch component 410 implements a worker engagement interface 414, and provides the reward index value 5504 to the contributing freelance workers (e.g., providing one or more contributing freelance workers with the reward index value corresponding to that worker), for example to allow the freelance worker to track their contributions, and/or to motivate the freelance worker.

In certain embodiments, the work dispatch component 410 tracks the contribution value(s) 5502 of contributing freelance workers by providing a reward description 5504 to one or more contributing freelance worker in response to the contribution value(s) 5502 for those freelance workers. The utilization of a reward description allows for communication of aspects of the worker contributions to resolution actions 420 that contributed to the contribution value 5502 for that worker, to allow the platform 1202 to incentivize, motivate, and appropriately reward freelance workers for contributions to resolution actions 420 on the platform 1202. The reward description 5504 allows for the freelance worker to understand which aspects of their contributions are the most effective, allowing for the worker to more efficiently develop their own work patterns, determine which skills or tools they should emphasize or improve, develop their strategy for which types of work elements to accept, or the like. Accordingly, providing the reward index value and/or reward descriptions to contributing freelance workers improves the platform capacity, improves customer satisfaction, improves customer outcomes to inquiries, and allows freelance workers to develop their most efficient and rewarding work strategies.

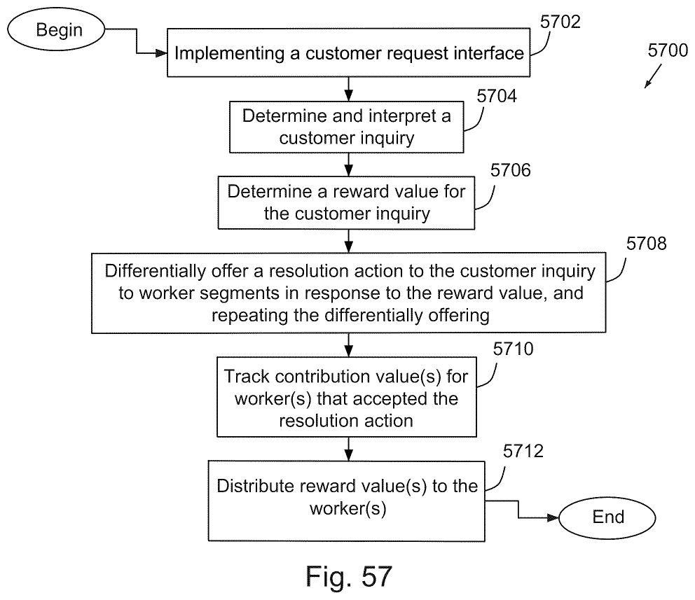

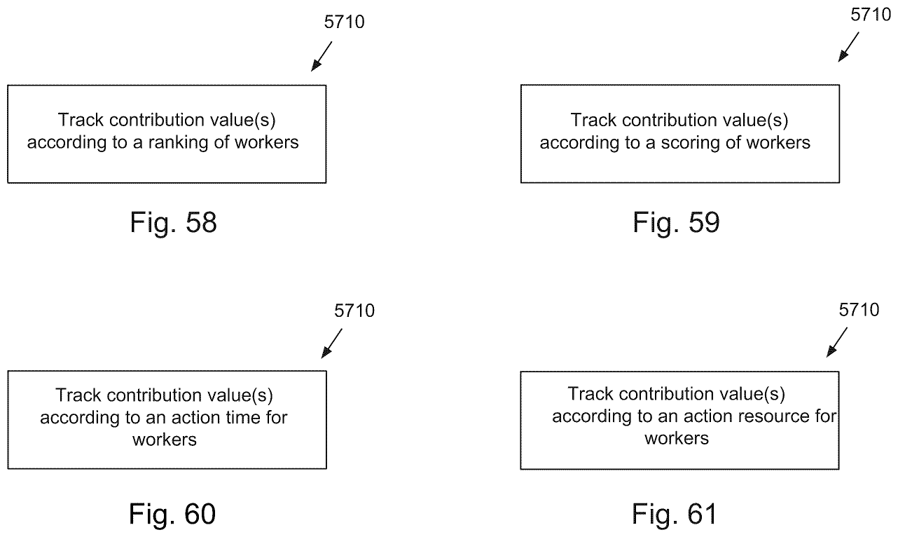

Referencing FIG. 57, an example procedure 5700 includes an operation 5702 implementing a customer request interface, an operation 5704 determining a customer inquiry in response to interactions of a customer with the customer request interface and interpreting the customer inquiry, and an operation 5706 determining a reward value for the customer inquiry. The example procedure 5700 includes an operation 5708 differentially offering a resolution action to the customer inquiry to a plurality of worker segments, and repeating the differentially offering until at least one freelance worker accepts the resolution action, and an operation 5710 tracking a contribution value to the resolution action for the at least one freelance worker that accepted the resolution action. The example procedure 5700 includes an operation 5712 distributing the reward value to the at least one freelance worker in response to the contribution value to the resolution action. Example operations 5710 to track the contribution values include one or more operations such as (reference FIGS. 58-61): tracking the contribution value(s) according to a ranking of the accepting freelance workers; tracking the contribution value(s) according to a scoring of the accepting freelance workers; tracking the contribution value(s) according to an action time of the accepting freelance workers; and/or tracking the contribution value(s) according to an action resource of the accepting freelance workers.

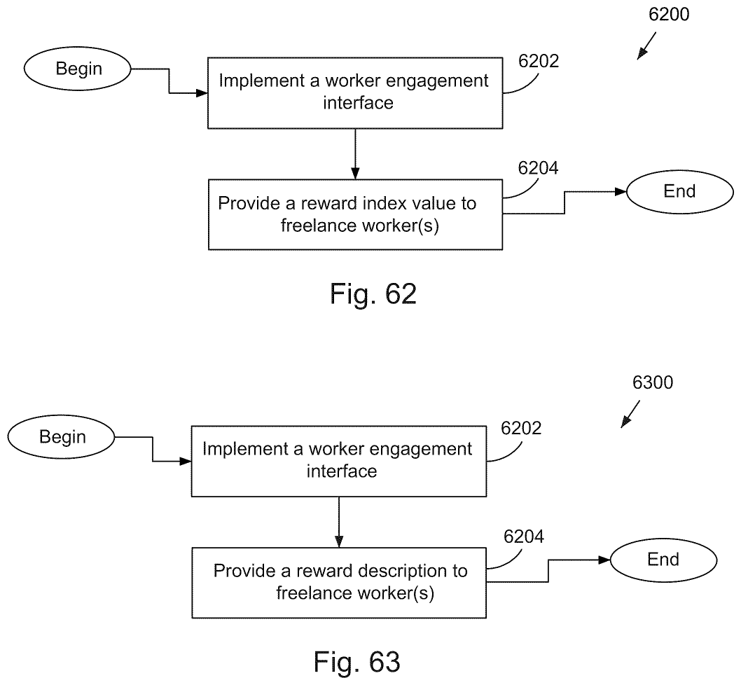

Referencing FIG. 62, an example procedure 6200 includes an operation 6202 implementing a worker engagement interface, and an operation 6204 to provide a reward index value to the at least one freelance worker that accepted the resolution action on the worker engagement interface in response to the contribution value for the at least one freelance worker that accepted the resolution action. Referencing FIG. 63, an example procedure 6300 includes an operation 6202 implementing a worker engagement interface, and an operation 6204 providing a reward description to the at least one freelance worker that accepted the resolution action on the worker engagement interface in response to the contribution value for the at least one freelance worker that accepted the resolution action.

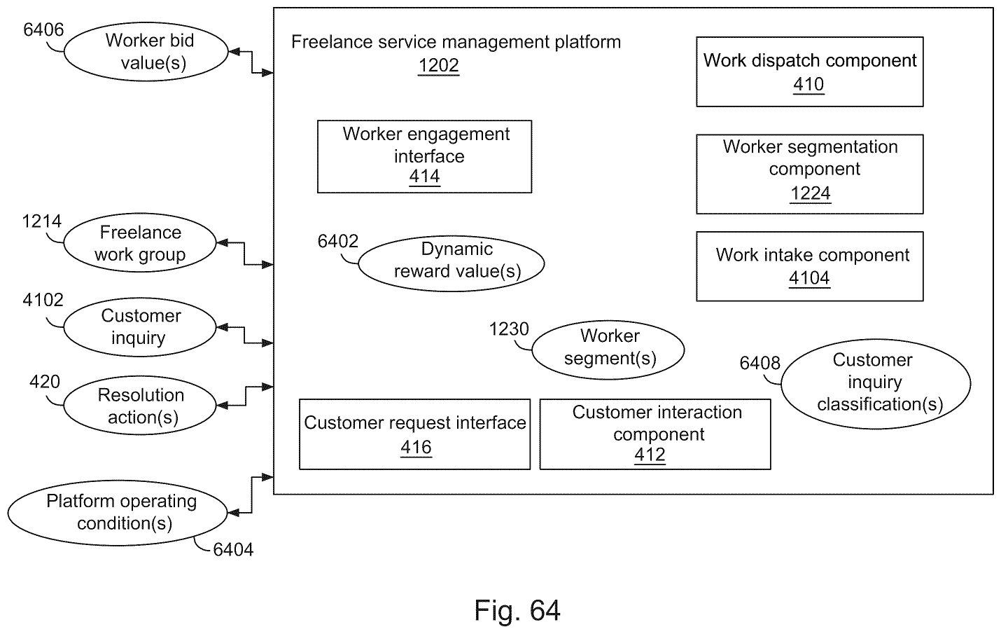

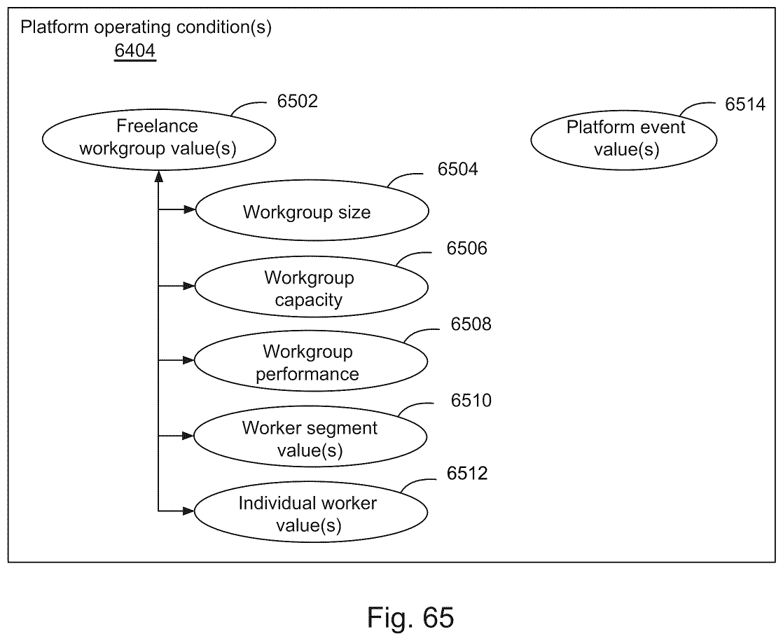

Referencing FIG. 64, an example system includes a freelance service management platform 1202 having a customer interaction component 412 that implements a customer request interface 416, and determines a customer inquiry 4102 in response to interactions of a customer with the customer request interface 416. The example platform 1202 includes a work intake component 4104 that interprets the customer inquiry 4102, and determines a dynamic reward value 6402 for the customer inquiry 4102, and a work dispatch component 410 that differentially offers a resolution action 420 to the customer inquiry 4102 to a plurality of worker segments in response to the dynamic reward value 6402, and repeating the differentially offering until at least one freelance worker accepts the resolution action. In certain embodiments, the work intake component 4104 determines the dynamic reward value 6402 as a monotonically increasing reward value (e.g., a reward value that rises or stays level over the incrementing parameter, where the incrementing parameter may be time, segments (e.g., rising or staying level from segment to segment), activity (e.g., the number of active inquiries, inquiries of a particular type, number of engaged workers from the corpus, work group, and/or a segment, etc.), and/or an index combining one or more of these or other parameters). In certain embodiments, the work intake component 4104 determines the dynamic reward value 6402 as a monotonically decreasing reward value, as a capped reward value (e.g., limited to a maximum value), and/or as a floored reward value (e.g., limited to a minimum value). In certain embodiments, the work intake component 4104 determines the dynamic reward value 6402 in response to a platform operating condition 6404, for example based on activity levels on the platform, platform capacity, platform performance, a number of available workers on the platform, a platform health value (e.g., platform health, corpus health, work group health, segment health, etc.), platform initiatives (e.g., emphasized actions such as responsiveness, quality, etc.), and/or any other considerations for the platform (e.g., recent performance, contractual obligations, events, etc.). In embodiments, worker bid value(s) 6406 may be an input to the platform 1202. In embodiments, customer inquiry classifications(s) 6408 may be generated by the platform 1202. Referencing FIG. 65, example and non-limiting platform operating conditions 6404 include a freelance workgroup value 6502 and/or a platform event value 6514. In the example of FIG. 65, non-limiting example of freelance workgroup values 6502 include one or more aspects such as: a workgroup size 6504, a workgroup capacity 6506, a workgroup performance 6508 (e.g., timeliness, throughput, customer satisfaction, etc.), worker segment values 6510 (e.g., size, capacity, and/or performance of a segment), and/or individual worker values 6512 (e.g., capacity, throughput, and/or performance of the worker). The example of FIG. 65 depicts workgroup values (e.g., based on all available workers having the capability to work on the work element, such as certifications, skills, tools, intersecting time availability, within geographic boundaries, etc.), but may additionally or alternatively utilize corpus values (e.g., all workers on the platform 1202, and/or all active workers on the platform 1202), and/or segment values (e.g., all workers within a segment or a group of segments, which may be estimated or updated, for example as the constituency of segments changes over time and/or as determined for different work elements). Example platform operating conditions 6404 include a platform event value 6514—for example the determination that a platform parameter has exceeded or fallen below a threshold, a number or rate of active work elements, changes in contractual obligations or performance, etc.).

An example work intake component 4104 determines the dynamic reward value 6402 in response to one or more bid values corresponding to freelance worker(s). A bid value may be explicit, for example a freelance worker provides a bid value to work on particular work elements, or any work element, for example according to properties of the work elements. In certain embodiments, a bid value may be inferred, for example based on an acceptance history of the freelance worker and corresponding reward values at the time or operating conditions of the platform 1202 at the time of acceptance. In certain embodiments, the utilization of a bid value allows the platform 1202 to set or determine appropriate reward levels, and/or to adjust rewards to particular events such as a surge of work elements.

An example platform 1202 includes a worker segmentation component 1224 that determines the worker segments 1230 in response to bid value(s). For example, the reward values provided to different segments, the constituency of the segments, and/or the timing of offers between segments, may be adjusted according to the bid values to configure the segments having selected capabilities, to ensure work elements are resolved, or the like.

An example work intake component 4104 determines a customer inquiry classification (e.g., based on properties of the customer inquiry, according to an intent, mood, or sentiment of the customer inquiry and/or messages related thereto, etc.), and determines the dynamic reward value 6402 in response to the customer inquiry classification. In certain embodiments, the adjustment of the dynamic reward value 6402 in response to the customer inquiry classification allows the platform 1202 to adjust rewards based on the complexity, mood, importance, criticality, or the like of the customer inquiry and/or a class of customer inquiries.

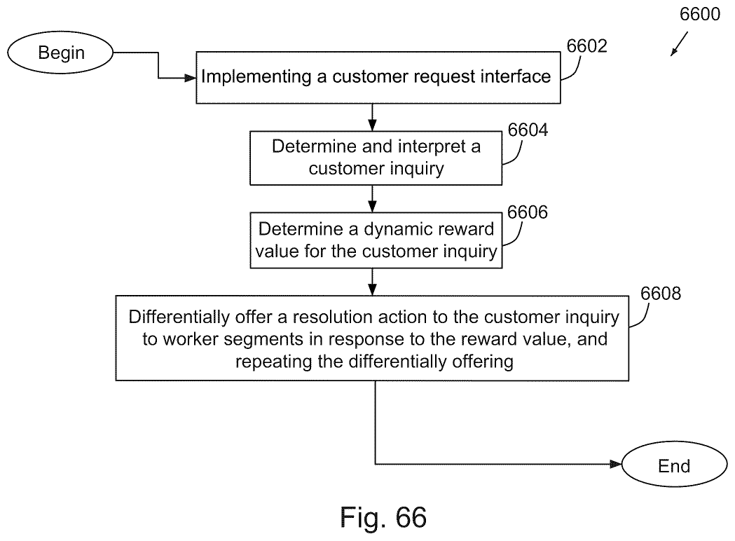

Referencing FIG. 66, an example procedure 6600 for differentially offering resolution actions to worker segments is schematically depicted. The example procedure 6600 includes an operation 6602 to implement a customer request interface, an operation 6604 to determine and interpret a customer inquiry, an operation 6606 to determine a dynamic reward value for the customer inquiry, and an operation 6608 to differentially offer a resolution action to the customer inquiry to worker segments in response to the dynamic reward value, and repeating the differentially offering until at least one freelance worker accepts the resolution action.

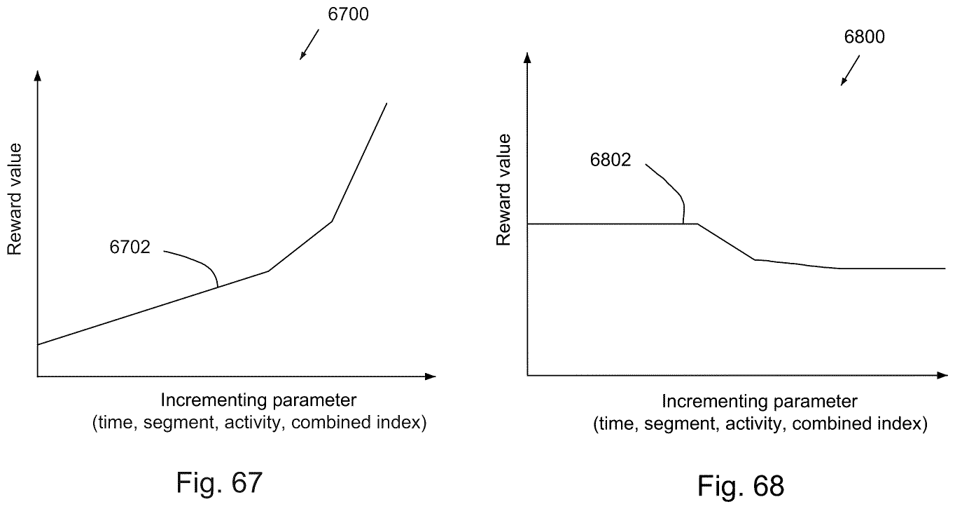

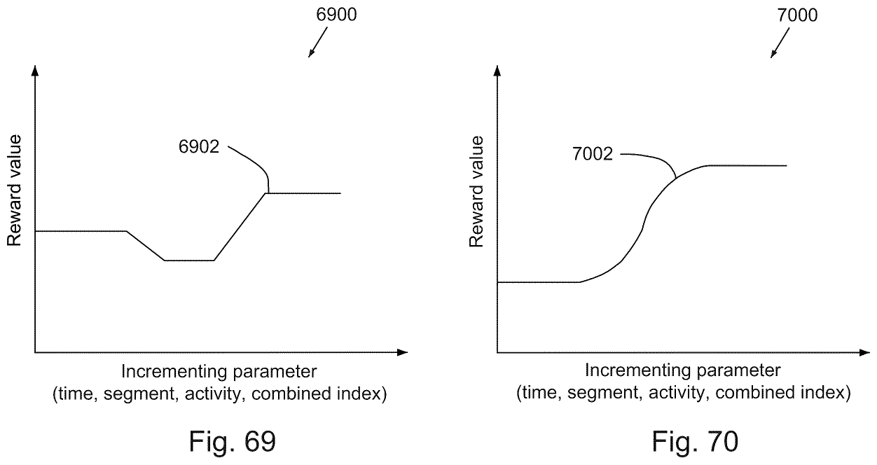

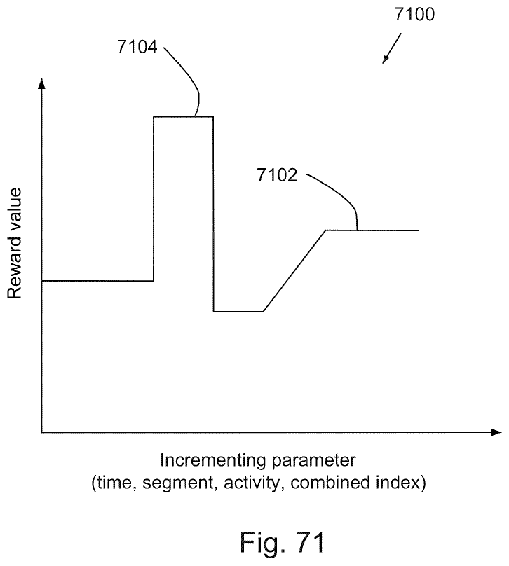

Referencing FIG. 67, an example illustration 6700 of a dynamic reward value depicts a monotonically increasing reward value 6702 with the incrementing parameter. In certain embodiments, the incrementing parameter is a time parameter (e.g., moving to the right on the illustration 6700 based on elapsed time), a segment (e.g., moving to the right on the illustration 6700 based on which segment of the available segments is being considered), an activity (e.g., a platform operating condition or any other activity related to the platform), and/or an index combining increment parameters, which can facilitate weighting between parameters. It will be seen that the incrementing parameter does not need to be, but could be, a time based parameter. Additionally, it will be seen that, depending upon the specific incrementing parameter, movement on the illustration 6700 can include movement to the left (e.g., when an index value decreases) and/or resetting to the left (e.g., in a sequenced segment embodiment where no segments accepted, and the platform 1202 recycles the offer through all segments from the beginning). Referencing FIG. 68, an example illustration 6800 of a dynamic reward value 6802 depicts a monotonically decreasing reward value with the incrementing parameter. Referencing FIG. 69, an example illustration 6900 of a dynamic reward value 6902 depicts a reward trajectory that includes a middle dip, with a portion of the illustration 6900 decreasing, and a portion of the illustration 6900 increasing. Referencing FIG. 70, an example illustration 7000 of a dynamic reward value 7002 depicts a monotonically increasing reward value with the incrementing parameter. Referencing FIG. 71, an example illustration 7100 of a dynamic reward value depicts a combination of incrementing parameters, for with time as a main incrementing parameter shown on the axis, and a platform event (e.g., event true=1 and event false=0) as a second incrementing parameter (not shown), the main incrementing parameter providing a baseline dynamic reward value 7102, and a second incrementing parameter interrupting the baseline dynamic reward value 7102 with an overriding dynamic reward value 7104.

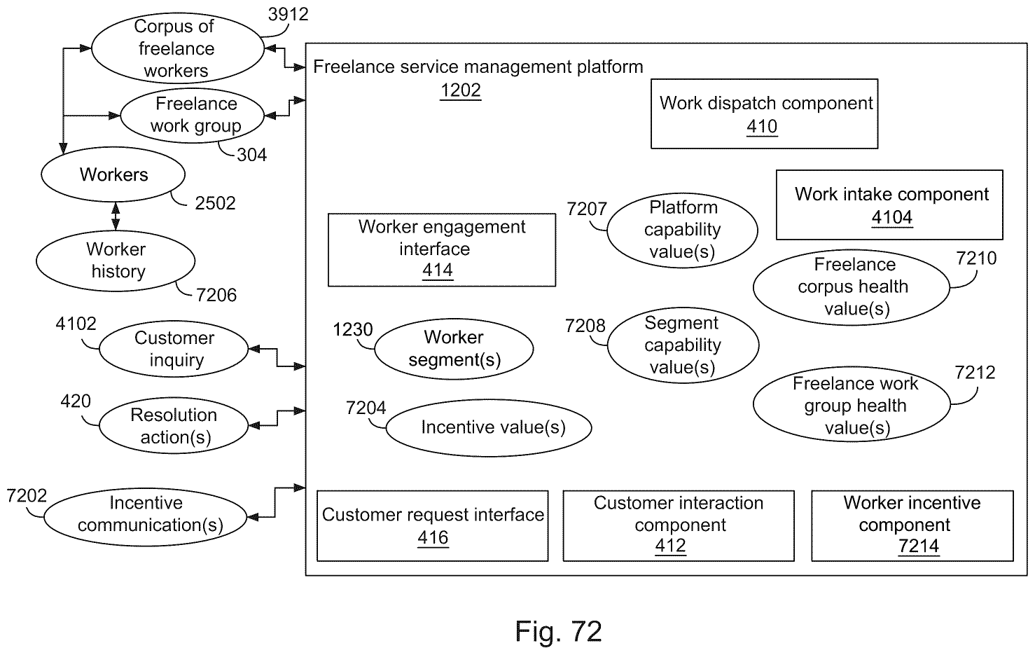

Referencing FIG. 72, an example freelance service management platform 1202 includes a customer interaction component 412 that implements a customer request interface 416, and determines a customer inquiry 4102 in response to interactions of a customer with the customer request interface 416; a work intake component 4104 that interprets the customer inquiry 4102; a work dispatch component 410 that differentially offers a resolution action to the customer inquiry to a plurality of worker segments, and repeating the differentially offering until at least one freelance worker accepts the resolution action 420, and that implements a worker engagement interface 414, and provides an incentive communication 7202 to at least one worker 2502 of a corpus of freelance workers 3912, the corpus of freelance workers 3912 defining the plurality of worker segments 1230. Workers 2502 have a worker history 7206. The platform 1202 may generate a platform capability value 7207, a segment capability value 7208, a freelance corpus health value 7210, and a freelance work group health value 7212.

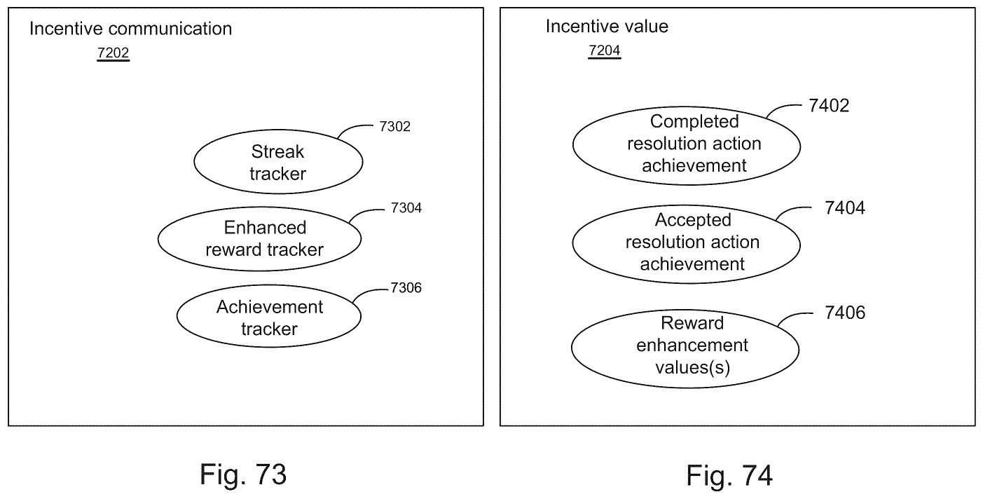

Referencing FIG. 73, example and non-limiting incentive communications 7202 include one or more of: a streak tracker 7302 (e.g., where the streak may be consecutive days where a target is met such as a number of resolved actions, high customer satisfaction ratings, etc., or any other type of streak related to consecutive events, time above or below a desired goal, etc.; and where the streak tracker may include a visual aid, graphical depiction on the worker engagement interface 414, a message provided to the worker, etc.); an enhanced reward tracker 7304 (e.g., depicting an amount of enhanced rewards provided to the worker, for example related to a current task, current resolution action, recent time period, selected time period, etc.); and/or an achievement tracker 7306 (e.g., where achievements may be set by the platform 1202, by an administrator, by the worker, and/or by an entity related to the worker such as a brand value or the like, where achievements can relate to any activity on the platform, such as resolved actions, quality values, contribution values, action time, action resources, etc.). Without limitation to any other aspect of the present disclosure, example achievements include: achieving a selected number of maximum customer ratings in a time period (e.g., 5 in one month), achieving a target quality review value and/or expert rating value (e.g., getting 85% on a next quality review), and/or adding a new skill (e.g., a skill relevant to adding the worker to a new work group and/or selected work group). The trackers may be provided as a graphical depiction (e.g., a speedometer icon, graph, chart, etc.), on the worker engagement interface, on a dashboard and/or home page, and/or as a message sent to the user via text, e-mail, platform messaging, or the like.

An example platform 1202 includes a worker incentive component 7214 that determines an incentive value 7204 for the at least one worker of the corpus of freelance workers, and wherein the work dispatch component 410 further provides the incentive communication 7202 in response to the incentive value. In certain embodiments, the incentive value 7204 may be determined based on completed resolution actions, customer satisfaction values, quality values, action time, action resources, or the like. Referencing FIG. 74, example and non-limiting incentive values 7204 include one or more of: a completed resolution action achievement 7402, an accepted resolution action achievement 7404, and/or a reward enhancement value 7406 (e.g., a description of rewards earned, high value rewards earned, bonus reward amounts earned, bonus reward amounts related to current activity or resolution actions being worked, etc.). An example worker incentive component 7214 determines the incentive value 7204 in response to a work history of the worker. An example worker incentive component 7214 determines the incentive value 7204 in response to a platform capability value—for example showing the incentive value 7204 to enhance platform capability, and/or to depict (and/or provide) an enhanced reward based on current or target platform capability and/or a gap between these. An example worker incentive component 7214 determines the incentive value 7204 in response to a freelance corpus health value—for example showing the incentive value 7204 to enhance the freelance corpus health and/or to enhance platform capability when the freelance corpus health is low, and/or to depict (and/or provide) an enhanced reward based on the freelance corpus health. In certain embodiments, the worker incentive component 7214 determines the incentive value 7204 in response to a freelance work group health value, a worker segment health value, a freelance work group capability value, and/or a worker segment capability value.

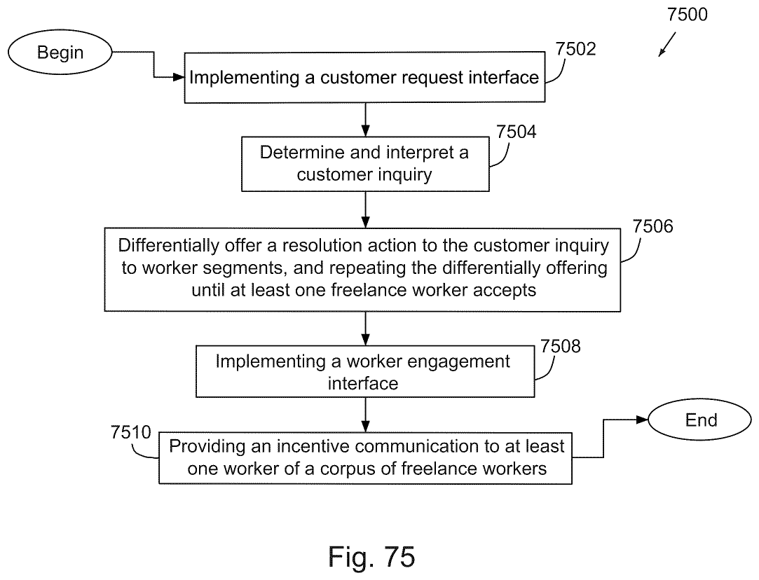

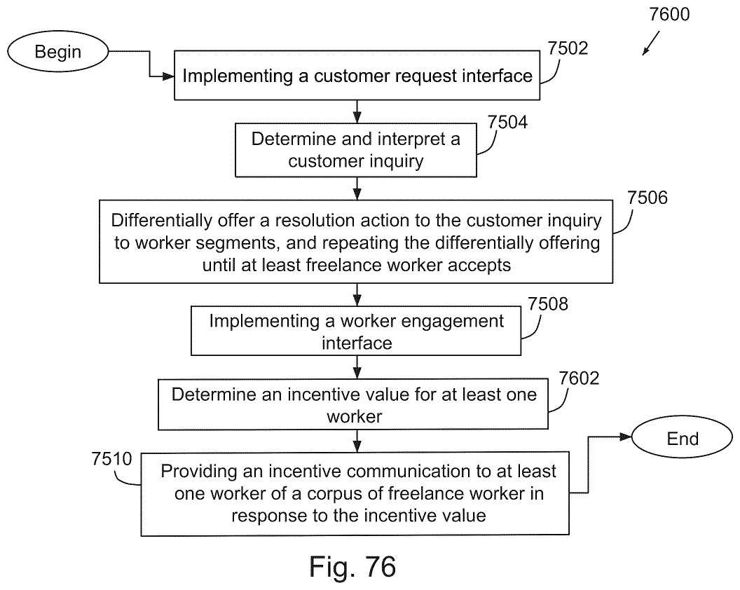

Referencing FIG. 75, an example procedure 7500 for providing an incentive communication to a freelance worker is schematically depicted. The example procedure 7500 includes an operation 7502 to implement a customer request interface, an operation 7504 to determine and interpret a customer inquiry, and an operation 7506 to differentially offer a resolution action to the customer inquiry to a plurality of worker segments, and repeating the differentially offering until at least one freelance worker accepts the resolution action. The example procedure 7500 includes an operation 7508 implement a worker engagement interface, and an operation 7510 to provide an incentive communication to an accepting worker(s). Referencing FIG. 76, an example procedure 7600 further includes an operation 7602 to determine an incentive value for one or more workers, and where the operation 7510 includes providing the incentive communication in response to the incentive value.

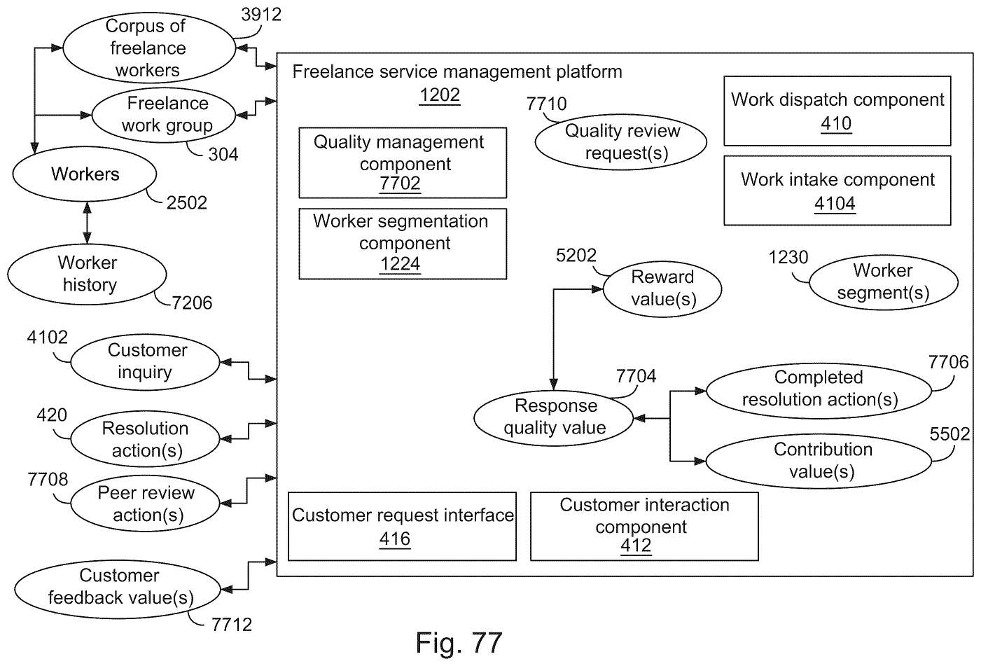

Referencing FIG. 77, an example system includes a freelance service management platform 1202 including a customer interaction component 412 that implements a customer request interface 416, and determines a customer inquiry 4102 in response to interactions of a customer with the customer request interface 416. The platform 1202 further includes a work intake component 4104 that interprets the customer inquiry 4102, a work dispatch component 410 that differentially offers a resolution action 420 to the customer inquiry 4102 to a plurality of worker segments 1230, and repeating the differentially offering until at least one freelance worker accepts the resolution action 420. The platform 1202 further includes a quality management component 7702 that determines a response quality value 7704 for the at least one freelance worker that accepted the resolution action 420. Without limitation to any other aspect of the present disclosure, the response quality value 7704 may be determined automatically, for example reviewing and/or evaluating tasks related to the resolution action 420 by the accepting freelance worker, including acceptance communications, communications with the customer during the resolution action 420 performance, utilization of tools during tasks (e.g., including utilization of the proper tools, and/or proper utilization of specific tools), and conclusory tasks for the resolution action 420. In certain embodiments, automated evaluation may include determining that tasks are completed in full, evaluation of how the tasks are completed (e.g., forms fully completed, communications are responsive and have correct tone, mood, selected word usage, etc.), that tasks are performed in the correct sequence, and the like. In certain embodiments, automated evaluations utilize expert systems or heuristics (e.g., checking rules built by an expert) to perform all or a part of automated checks. In certain embodiments, automated evaluations utilize natural language processing to determine communication tone, mood, sentiment, sophistication level, etc., to confirm that these are appropriate and/or to assist in other portions of the automated evaluation. In certain embodiments, aspects of an automated evaluation may be utilized to assist other evaluations, for example with elements of an automated evaluation provided to a reviewing user (e.g., another user performing a peer review action for a quality review request), which may be utilized to provide suggested elements for the review, to provide review contributions that can be confirmed by the reviewing user, and/or to be available upon request by the reviewing user (e.g., the reviewing user entering a request to check an aspect of the resolution action 420 under review, for example to request a tone for a message, to flag any messages with a selected tone classification, etc.). The utilization of combined peer review, expert review, and/or automated review contributes to getting a quality review of a high percentage of resolution actions, and/or potentially all resolution actions, in contrast with previously known systems. Additionally or alternatively, the utilization of combined peer review, expert review, and/or automated review allows for automated review tasks to more rapidly converge on high quality automated reviews that are more likely to be correct, and improves the value of the total quality review, including for example determination of worker expert ratings, with consequent benefits to overall platform performance. For example, having high quality and rapidly determined worker expert ratings improves the performance of worker segmentation operations, improves the capacity of the platform to respond to work requests, enhances customer satisfaction in the rapid and high quality completion of resolution actions, and reduces the need for higher cost operations such as extensive use of incentive rewards to respond to off-nominal platform conditions. The rapidly determined worker expert ratings are also more responsive to system changes, reducing the cost of disruptions and/or transient events that may affect the performance of individual freelance workers, cause an unusual influx of work requests, and/or cause a transient change in the types of work requests received by the platform.

An example response quality value 7704 corresponds to a completed resolution action 7706, for example when a quality review is performed after the action is completed. In certain embodiments, the response quality value 7704 may correspond to an in-process resolution action 420, and could be determined for any resolution action 420 that has been accepted by a freelance worker on the platform.

An example response quality value 7704 corresponds to a contribution value 5502 of the accepting freelance worker. For example, a given resolution action 420 may have different response quality values 7704 for different tasks of the resolution action 420, or for different freelance workers that have worked on the resolution action 420. Accordingly, a freelance worker can determine which portions of the resolution action 420 they have performed that were performed well, and which portions would benefit from improvements. Additionally or alternatively, the response quality value 7704 may be utilized to determine distribution of the reward values 5202 between multiple freelance workers contributing to a given resolution action 420, and/or may otherwise be utilized to determine the contribution values 5502 for each freelance worker contributing to a resolution action 420 (e.g., by determining and utilizing response quality values 7704 to determine the scoring, ranking, action time, action resources, and/or any other aspects utilized to determine the contribution values 5502 for each accepting freelance worker for the resolution action 420).

An example platform 1202 includes a worker segmentation component 1224 that adjusts the worker segments 1230 in response to the response quality value 7704. For example, the response quality values 7704 can assist the worker segmentation component 1224 in determining: the total capability of workers in a segment; the total capacity of workers in a segment; the predicted performance of segments for different selected customer inquiries and/or selected work requests; and/or the predicted performance of segments against platform requirements, contractual obligations, and/or QoS parameters. In certain embodiments, the response quality values 7704 assist the worker segmentation component 1224 in determining the constituency of segments 1230 that support the desired goals, and/or in determining health values for the platform, the freelance worker corpus, freelance worker groups, and/or freelance worker segments, allowing the worker segmentation component 1224 to create and/or adjust segments 1230 accordingly, and/or providing information for a platform corpus management component 9104 (e.g., reference FIG. 91) to determine appropriate crowd health management operations 9106.

In certain embodiments, the quality management component 7702 adjusts a work history 7206 of accepting freelance workers in response to the response quality value 7704. For example, the work history 7206 may include response quality values 7704 associated with particular completed resolution actions 7706, and/or may be utilized to determine descriptions of the freelance worker performance and/or capability, including for particular types of work elements, quality average values, quality variability values, or the like for the freelance worker. For example, a quality management component 7702 adjusts the work history 7206 of an accepting freelance worker in response to a property of the customer inquiry 4102, for example based on the complexity of the inquiry, a difficulty of the inquiry, an urgency of the inquiry, a brand value related to the inquiry, or the like, allowing for improved utilization of the response quality value 7704 and work history 7206 in determining or adjusting segments, in determining capability values on the platform, and/or in determining health values on the platform, for work elements having specific properties.

An example quality management component 7702 determines the response quality value 7704 by providing a quality review request 7710 to the work intake component 4104. In certain embodiments, the quality review request 7710 is provided as a work element, for example as a work request and/or customer inquiry to be processed by the platform 1202, where the tasks responsive to the quality review request 7710 are performed as a resolution action 420 and/or as a peer review action 7708. In certain embodiments, the quality review request 7710 is differentially offered to a number of worker segments 1230 that are built for the quality review request 7710 (e.g., including a freelance work group that is qualified to perform the quality review, excluding the freelance worker whose tasks are the subject of the quality review, etc.), and the differentially offering is repeated until at least one freelance worker accepts the peer review action 7708 for the quality review request 7710. In certain embodiments, the freelance work group that is qualified to perform the quality review request 7710 for a completed resolution action 7706 may be similar to the freelance work group that was qualified to perform the original resolution action for the work element, but the worker segments 1230 utilized to differentially offer the peer review action 7708 may be quite different from the worker segments 1230 originally utilized to offer the original resolution action. For example, in addition to excluding the freelance worker whose tasks are the subject of the quality review, some freelance workers may demonstrate a different capability or quality performance for work elements of quality reviews relative to work elements for original tasks such as customer inquiries. Further, the quality reviews may have distinct properties from original tasks, such as a different quantity or rate of work elements, different response or resolution time targets, requirements that are more or less strict (e.g., the original task may require handling of PII, where the review task may not; alternatively some review tasks may require handling of PII where the original task did not), and/or significant differences in execution (e.g., a difference in customer communication requirements, execution of tools versus evaluation of tool outputs, etc.).

Example operations of the quality management component 7702 to determine the response quality value 7704 include operations such as: determining the response quality value 7704 in response to a customer feedback value 7712 for the resolution action (e.g., utilizing the customer feedback value 7712 as an input to determine the response quality value 7704, and/or utilizing the customer feedback value 7712 as a trigger to initiate the quality review request 7710, e.g., flagging completed resolution actions 7706 where a customer feedback value 7712 is high or low, includes certain keywords, and/or has a particular mood, sentiment, or topic); performing an automated quality check operation; determining the response quality value 7704 in response to a mood value for at least one of the customer inquiry or a customer feedback value (e.g., where the customer inquiry or related communications include certain mood values, and/or indicate a change in the mood value); and/or determining the response quality value 7704 in response to a sentiment value for at least one of the customer inquiry or a customer feedback value (e.g., where the customer inquiry or related communications include certain sentiment values, and/or indicate a change in the sentiment value). In certain embodiments, the quality management component 7702 determines the response quality value 7704 in response to a completed resolution action 7706, for example determining the response quality value 7704 once a resolution action is completed, and/or determining whether to determine a response quality value 7704 once the resolution action is completed. In certain embodiments, the quality management component 7702 determines the response quality value 7704 for a resolution action that is in process, for example: as a part of a random sampling of resolution actions; in response to a detected event, such as a value (e.g., certain moods may always be responded o, such as “anger”) or change in value to a mood or sentiment (e.g., degradation of a mood on a scale, for example between “good” to “bad”, “happy” to “disappointed”, etc.), or utilization of specific keywords; and/or in response to a delay period for the resolution of the action, progression between steps or stages of the resolution action, and/or response to a message from the customer that provided the customer inquiry. In certain embodiments, the quality management component 7702 determines response quality value(s) 7704 for a selected fraction of all resolution tasks on the platform (e.g., to ensure a random sampling to avoid a systematic bias in checking resolution actions). In certain embodiments, the fraction to be checked depends upon the type of resolution action, properties of the work element, according to contractual obligations, or the like. An example quality management component 7702 determines response quality values 7704 for a selected fraction of resolution tasks for a given freelance worker, for a given worker segment, for a given customer (e.g., a customer that utilizes the platform 1202 to assist with resolving customer inquiries for their own customers), and/or for any target group of resolution tasks (e.g., resolution actions 420 sharing any characteristic of interest, for example associated skills, tools, brands, source devices, source operating systems, etc.).

In certain embodiments, thresholds for checks to determine whether response quality values 7704 should be determined may be set according to contractual obligations, according to statistical determinations (e.g., a two standard deviation delay for an action, message, or the like, relative to other similar actions or messages), according to expert analysis, and/or may be dynamically determined (e.g., making more frequent checks where the quality is low or decreasing, and making less frequent checks where the quality is high or increasing). It will be understood that in one aspect, the quality management component 7702 is configured to detect potential low quality responses or resolution actions. However, an example quality management component 7702 is configured to, additionally or alternatively, detect high quality responses or resolution actions, for example to provide opportunities for positive incentive feedback for desired response behavior to freelance workers, to generate candidates for model responses or training, or the like.

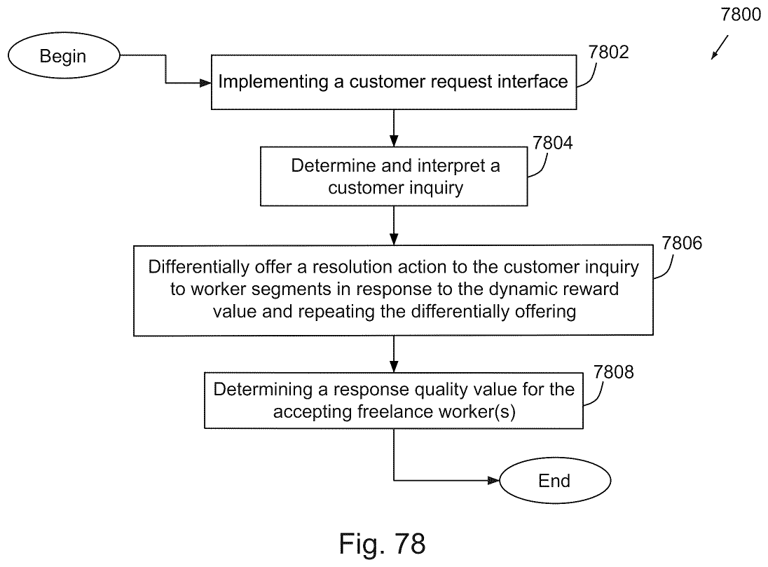

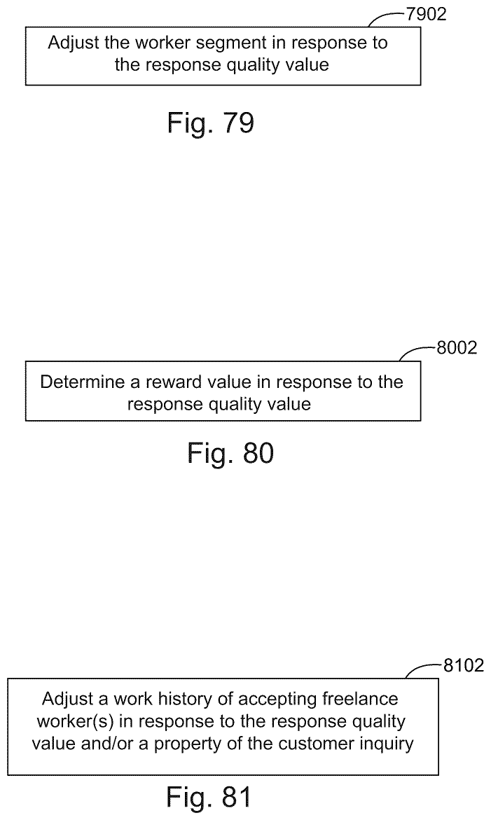

Referencing FIG. 78, an example procedure 7800 for determining a response quality value is schematically depicted. The example procedure 7800 includes an operation 7802 to implement a customer request interface, an operation 7804 to determine and interpret a customer inquiry in response to interactions of a customer with the customer request interface, and an operation 7806 to differentially offer a resolution action to the customer inquiry to a plurality of worker segments, and repeating the differentially offering until at least one freelance worker accepts the resolution action. The example procedure 7800 includes an operation 7808 to determine a response quality value for the at least one freelance worker that accepted the resolution action. Referencing FIGS. 79-81, in certain embodiments the procedure 7800 additionally includes an operation 7902 to adjust the worker segments in response to the response quality value(s), an operation 8002 to determine a reward value in response to the response quality value, and/or an operation 8102 to adjust a work history of the accepting freelance worker(s) in response to the response quality values, and/or further in response to a property of the customer inquiry (or work element).

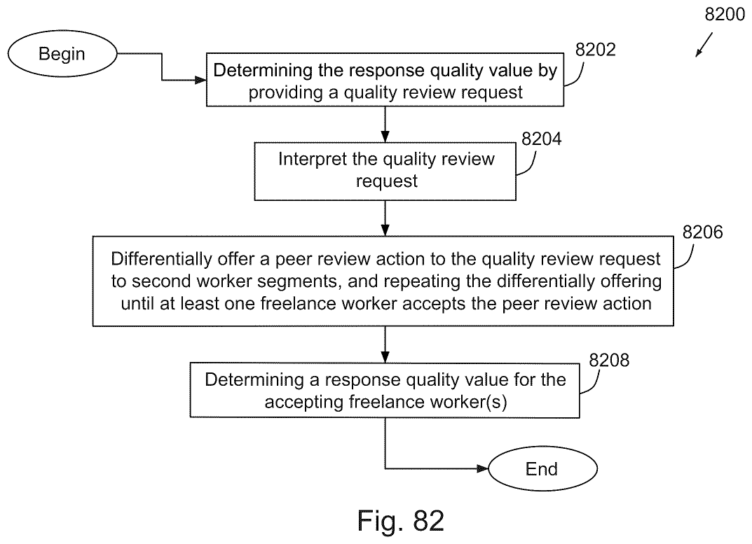

Referencing FIG. 82, an example procedure for determining a response quality value is schematically depicted. The example procedure 8200 includes an operation 8202 to determine a response quality value by providing a quality review request, for example as a work element to the platform 1202 to be completed by freelance workers of the freelance worker corpus. The example procedure 8200 includes an operation 8204 to interpret the quality review request, and an operation 8206 to differentially offer the peer review action to the quality review request to a group of worker segments, for example worker segments determined from a freelance work group of workers that are qualified and capable to perform the resolution action for the quality review request, and to repeat the differentially offering of the peer review action until at least one freelance worker accepts the peer review action.

In some aspects, the techniques described herein relate to a method, further including an operation 8208 of determining the response quality value by providing a quality review request; interpreting the quality review request; and differentially offering a peer review action to the quality review request to a second plurality of worker segments, and repeating the differentially offering until at least one freelance worker accepts the peer review action.

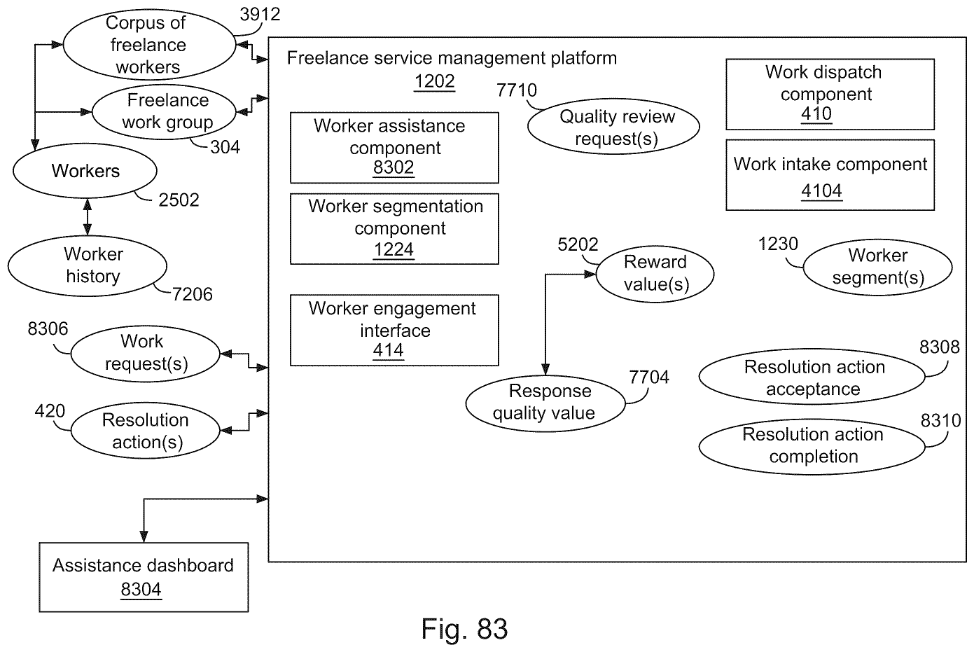

Referencing FIG. 83, an example system includes a freelance service management platform 1202 including a worker assistance component 8302 that implements a worker engagement interface 414, and provides an assistance dashboard 8304 for a freelance worker on the worker engagement interface 414. The example platform 1202 includes a work dispatch component 410 that differentially offers a resolution action 420 to a work request 8306 (e.g., a customer inquiry, peer review request, or any type of work element as set forth throughout the present disclosure) to a plurality of worker segments, and repeating the differentially offering until at least one freelance worker of a plurality of freelance workers accepts the resolution action. In the example of FIG. 83, the assistance dashboard 8304 is provided to one of the freelance workers accepting the work request 8306. The worker assistance component 8302 further updates the assistance dashboard 8304 for the freelance worker on the worker engagement interface 414 in response to at least one of an acceptance 8308 of the resolution action or a completion 8310 of the resolution action. In certain embodiments, the worker assistance component 8302 updates the assistance dashboard 8304 during the performance of a resolution action, for example in response to receiving a customer communication or message, in response to a request from the worker for assistance, in response to progressing between steps or stages of the resolution action, and/or in response to a delay period, for example determined from the acceptance time for the work request 8306, since receiving a customer communication, since progress to a current stage or step of the resolution action, or the like.

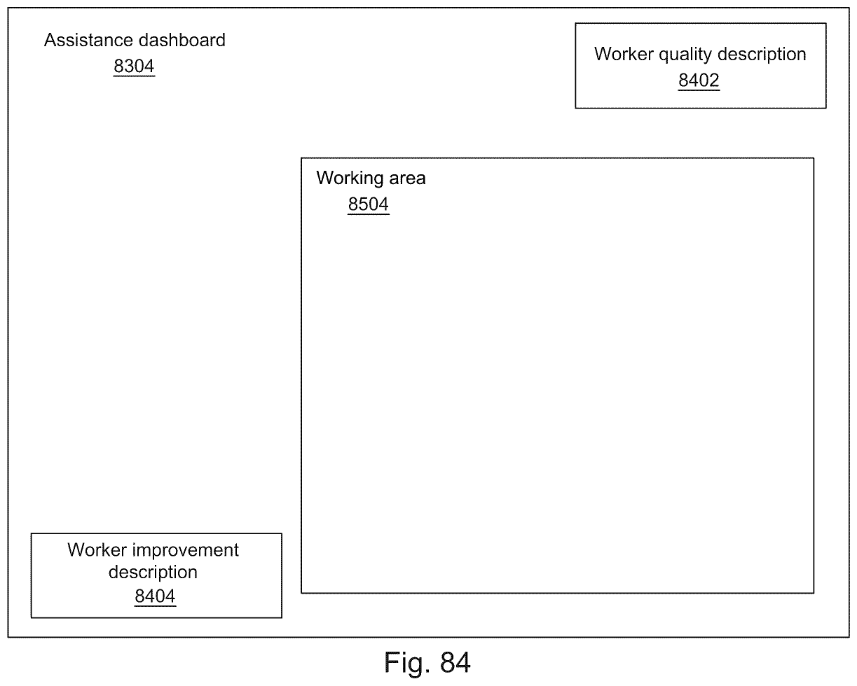

An example worker assistance component 8302 depicts a worker quality description 8402 on the assistance dashboard 8304. Referencing FIG. 84, the example worker quality description 8402 is provided in a location on the dashboard 8304 (e.g., in the upper right corner for the example of FIG. 84). The worker quality description 8402 provides a quality description for the worker, for example based on response quality values 7704 determined for that worker, for example based on an average of response quality values, a latest response quality value for a completed resolution action, a response quality value for a recent interaction (e.g., completion of a message, process stage, last response action, etc.). The worker quality description 8402 allows the freelance worker to track their quality progress, to receive a quick indication when a quality issue may be present for the freelance worker, and/or to assist the worker in maintaining work quality targets. The worker quality description 8402 may be a number, for example a quality scoring average and/or quality score for a latest resolution action and/or completed task for a resolution action. The worker quality description 8402 may additionally or alternatively include a categorical description (e.g., high quality, acceptable quality, etc.), one or more quality aspects of interest for the worker (e.g., proper communication tone, word selection, response time, etc.), and/or a scope description (e.g., quality representation for all tasks, a rolling average of recent tasks, a last task, etc.). In certain embodiments, the worker quality description 8402 may rotate through a number of description options, and/or display a most relevant one of the description options, for example in accordance with the current activity of the worker on the platform 1202.

An example worker assistance component 8302 depicts a worker improvement description 8404 on the assistance dashboard 8304. Referencing FIG. 84, the example worker improvement description 8404 is provided on a location on the dashboard 8304 (e.g., in the lower left corner for the example of FIG. 84). The worker improvement description 8404 provides information for the freelance worker that is configured to assist the freelance worker in improving the completion of resolution actions and/or related tasks with the platform 1202. In certain embodiments, the worker improvement description 8404 includes any aspects of task completion that relate to response quality values for the worker, including for example any aspects that are contributing to abnormally high or low response quality values for actions or tasks related to the freelance worker. For example, a worker improvement description 8404 may include a response time description (e.g., where the response time of the worker to individual tasks or responses, and/or to total completion time for resolution actions, contributes to a higher or lower than average contribution to response quality values for the freelance worker), word choice description, mood or sentiment description, and/or quality of the work product description (e.g., where customer inquiries are resolved sub-optimally, with a low or high customer satisfaction score, etc.). The worker improvement description 8404 helps reinforce positive behaviors by the freelance worker, and/or assist the freelance worker to rapidly respond to negative behaviors by the freelance worker. The example assistance dashboard 8304 may also include a working area 8504.

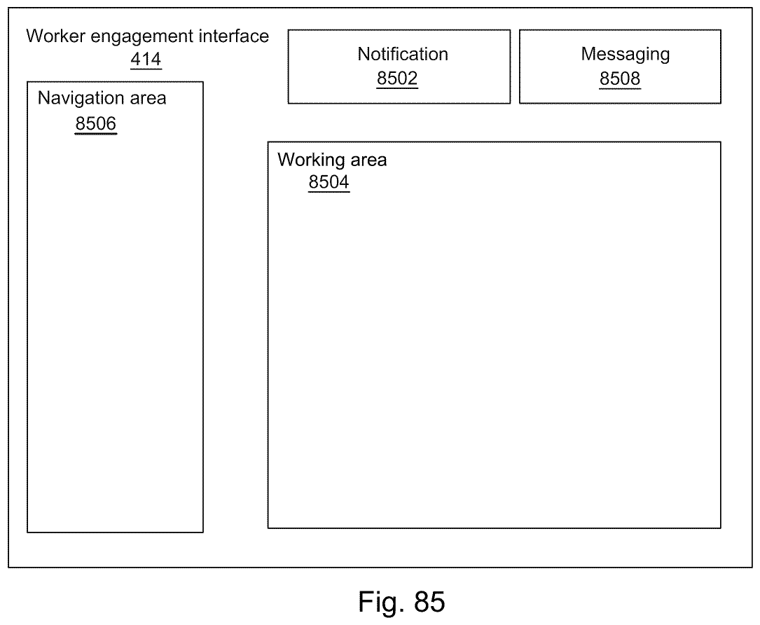

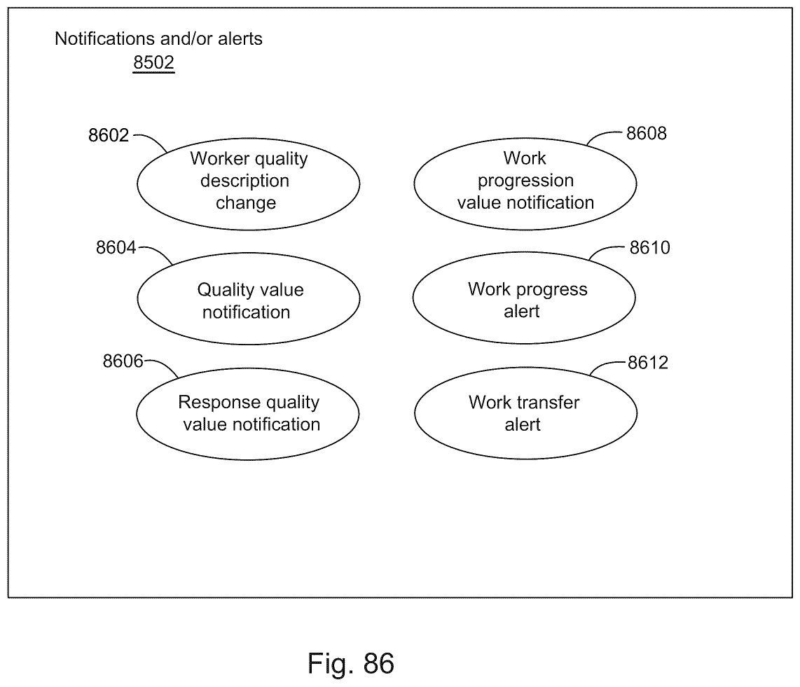

Referencing FIG. 85, an example worker assistance component 8302 provides a notification to the freelance worker on the worker engagement interface 414 in response to a change in the worker quality description 8402. For example, where a particular resolution action or a related task causes an increase or decrease in the worker quality description 8402, and/or includes an unusual value for the worker (e.g., a low quality response, high quality response, utilization of particular keywords, etc.), and/or represents an outlier for the freelance worker, the worker assistance component 8302 provides the notification 8502 to the freelance worker to allow the worker to rapidly respond to potential constructive feedback, and/or to confirm positive action that will assist the freelance worker to rapidly converge on work activity that will result in higher quality response actions on the platform 1202. In certain embodiments, the notification 8502 may be provided on a dashboard, home page, in a specified location on multiple pages of the worker interface on the platform, or the like. In certain embodiments, the worker assistance component 8302 provides the notification in response to a change in the worker quality description 8402, in response to a quality value for the freelance worker (e.g., a specific quality value determined for a resolution action, a communication, a peer review value, and/or an automated quality value), and/or in response to a response quality value 7704 for the freelance worker. An example worker assistance component 8302 provides a notification 8502 to the freelance worker engagement interface 414 in response to a work progression value for the resolution action (e.g., providing a notification that a recent action may have been exceptionally good or bad, and/or which aspects of the recent action are relevant to the action being exceptionally good or bad). An example worker assistance component 8302 provides a notification 8502 to the freelance worker in response to a work progress alert—for example an indication that a particular task, stage progression, response to a customer, or the like, is taking longer than an expected time, and/or is due for activity (e.g., to assist the freelance worker in making a timely response and/or taking a timely action for a particular resolution action). An example worker assistance component 8302 provides a notification 8502 to the freelance worker including a work transfer alert—for example, providing an offer to the freelance worker to transfer the resolution action to another worker, providing a notification that the resolution action is being transferred to another freelance worker, and/or providing a notification to another freelance worker that the resolution action is being transferred to. The example worker engagement interface 414 may include a location for messaging 8508, a navigation area 8506, and a working area 8504.

Referencing FIG. 86, example notification 8502, and/or alerts, are schematically depicted, and described briefly without limitation to any other aspect of the present disclosure. The example notifications 8502 include one or more notifications such as: a worker quality description change 8602 (e.g., a change in a worker quality description, and/or a recent quality description); a quality value notification 8604 (e.g., a quality value for a task, response, or the like); a response quality value notification 8606 (e.g., a determined response quality value for the freelance worker); a work progression value notification 8608 (e.g., a notification to raise awareness of a delayed or upcoming response, task, or resolution action); a work progress alert 8610 (e.g., providing a notification to a user that progress on a resolution task is delayed or will be due soon); and/or a work transfer alert 8612 (e.g., a notification indicating that a task or resolution action will be transferred soon, and/or is being transferred).

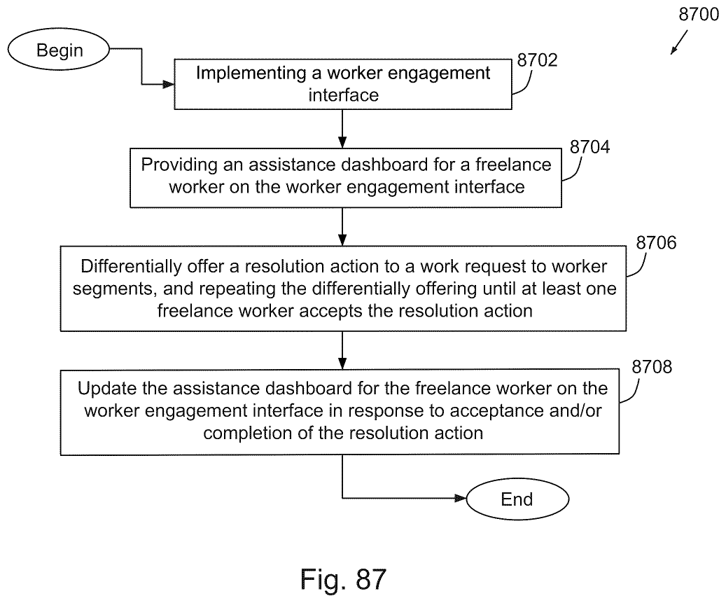

Referencing FIG. 87, an example procedure 8700 for updating an assistance dashboard for a freelance worker is schematically depicted. The example procedure 8700 includes an operation 8702 to implement a worker engagement interface, an operation 8704 to provide an assistance dashboard for a freelance worker on the worker engagement interface, and an operation 8706 to differentially offer a resolution action to a work request to worker segments, and repeating the differentially offering until at least one freelance worker accepts the resolution action. The example procedure 8700 includes an operation 8708 to update the assistance dashboard for the freelance worker on the worker engagement interface in response to the acceptance and/or completion of a resolution action for the freelance worker. In certain embodiments, the operation 8708 includes updating the assistance dashboard in response to completion of a task for a resolution action, a delay period for completing a resolution action and/or a task or response related thereto, and/or a determination of a quality value, response quality value, and/or peer review for a resolution action, task, communication, or response related to a resolution action for the freelance worker.

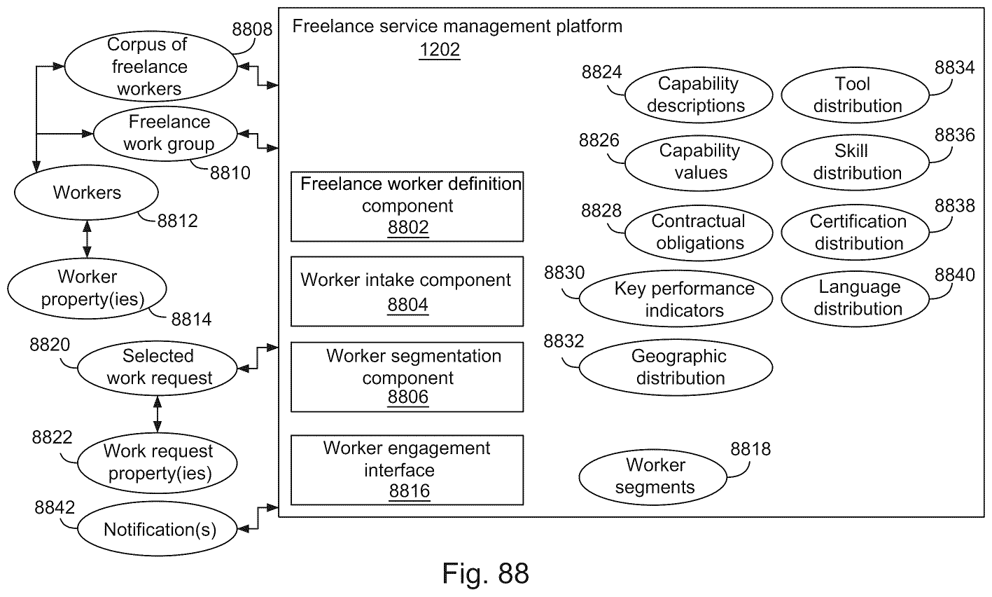

Referencing FIG. 88, an example system includes a freelance service management platform 1202 having a freelance worker definition component 8802 that interprets a corpus of freelance workers 8808 including a plurality of freelance workers 8812, a worker intake component 8804 that implements a worker engagement interface 8816, and registers a new user as one of the plurality of freelance workers of the corpus of freelance workers 8808 in response to interactions with the worker engagement interface 8816. The platform 1202 further includes a worker segmentation component 8806 that assigns the new user to at least one worker segment 8818 in response to a property 8814 of the new user.

Without limitation to any other aspect of the present disclosure, the corpus of freelance workers includes all workers registered on the platform 1202 to perform resolution actions on the platform 1202. In certain embodiments, the corpus of freelance workers may include all workers that have registered on the platform, all workers that have indicated they are “active” (e.g., available to work on actual resolution actions), and/or workers may be retired from the corpus of freelance workers 8808 in response to either an indication that the worker is no longer active, and/or due to inactivity (e.g., not accepting any resolution actions for an extended period of time). The freelance work group 8810 includes all workers that are available to work on resolution actions of a given type—for example according to properties of customer inquiries, work requests, or any other work element, the worker is potentially qualified to work on such work elements. In certain embodiments, the freelance work group 8810 may be screened from the skills, available tools, applicability for work elements based on the performance of the freelance worker for mood values, sentiment values, tone of communications, word selection, availability to work on particular brands or for particular customers, and/or quality thresholds applicable for particular work elements. In certain embodiments, the utilization of the freelance work group 8810 provides for enhanced operations of the platform 1202, for example allowing for the platform 1202 to screen freelance workers, and reduce the workload (e.g., processing operations, memory utilization, and/or communication resources) of the platform 1202 to determine the best workers available to perform resolution actions for particular work elements. In certain embodiments, the worker segments 8818 are each a subset of the freelance work group 8810 available to perform resolution actions for work elements. The worker segments 8818 provide an efficient framework for ensuring that resolution actions are accepted by appropriate workers on the platform 1202, to ensure that resolution actions are accepted quickly, that they will be resolved at a high quality, and that the freelance nature of the freelance workers (e.g., fully capability to accept or decline resolution actions at any time, including after a resolution action is commenced) is preserved. The utilization of worker segments 8818 provides for a number of benefits, including for example dividing capability determinations for the segments, greatly reducing the processing operations and intermediate memory requirements to determine the capability of the individual segments, and increasing the performance of the platform 1202 (e.g., improving the confidence that a work element will be accepted for resolution, for example by stacking statistical odds of acceptance; and/or improving the likely quality of the response through the ability to generate higher confidence in quality by providing management segments to perform high resolution statistical analysis). The utilization of segments combines the benefits of serial offerings of resolution actions, offering resolution actions to statistically significant groups of workers together, and configuring segments to take advantage of work habits between freelance workers (e.g., workers that prefer to respond rapidly to resolution actions, workers that prefer tasks of higher complexity or difficulty, etc.). These improvements are directly related to the technical implementation of the platform 1202 as set forth herein, and directly benefit the operations of computing devices implementing the platform 1202, for example by reducing the number of processor operations, memory utilization, and communications overhead for implementing the platform 1202.

An example freelance worker definition component 8802 interprets a freelance work group 8810 including at least a portion of the corpus of freelance workers 8808 in response to a capability value 8826 associated with a selected work request 8820. The selected work request 8820 may be a model work request, for example including certain skills, tools, or certifications that would be required for some run-time actual work request to be serviced by the platform 1202. In certain embodiments, the selected work request 8820 may be an actual work request that is representative of the properties 8822 and/or other aspects of the work request to be serviced by the platform 1202. In certain embodiments, the selected work request 8829 may, additionally or alternatively, be a selected customer inquiry 8821 (e.g., reference FIG. 91).

An example worker intake component 8804 provides a notification 8842 to a prospective new user in response to a capability description 8824 for the freelance work group 8810. For example, the freelance work group 8810 may not include enough workers having certain skills, certifications, available tools, communication profile (e.g., word selection, mood values, sentiment values, word sophistication, or the like) to provide sufficient capability for the freelance work group 8810, or to create enough worker segments 8818 of sufficient size and capability, to service work requests for the platform 1202. The notification 8842 to a prospective new user may be a direct communication, for example providing a specific offer to an individual that is believed to have the relevant skills or other properties, for example based on publicly available information such as degrees, described skills, analysis of comments on technical forums, or the like. In certain embodiments, the notification 8842 to a prospective new user may be provided to a former user, an inactive user, or the like, where some information about the user is already stored on the platform 1202. In certain embodiments, the notification 8842 to a prospective new user may include an advertisement or solicitation, for example a general notification (e.g., a general advertisement to a social media platform), a specific notification (e.g., an advertisement to a social media platform that is configured for the specific user, for example based on publicly available information about the user, hidden information about the user that may be available to the social media platform, or the like), and/or a general notification provided in a location that is likely to expose the notification to prospective new users of interest (e.g., a college newspaper, a relevant forum, an advertisement in an academic or professional journal, an advertisement on a web site associated with the appropriate skills, etc.).

In certain embodiments, the worker intake component 8804 provides a notification 8842 to prospective new user(s) in response to one or more aspects such as: a capability description 8824 (e.g., for the corpus, a work group, and/or worker segments); a capability value 8826; contractual obligations 8828 (e.g., performance obligations based on contractual obligations, such as response time to accept, completion time for resolution actions, quality values for resolution actions, response time to individual customer messages, etc.); KPIs 8830 (e.g., for the platform, for particular customers, etc.); a geographic distribution 8832 (e.g., where geographic distribution of freelance workers is relevant to sufficient platform capability in the hard sense—e.g., where certain work elements require that available workers are in a specified geographic region, or in the soft sense—e.g., where certain work elements benefit from geographic similarity of workers for the work requests, for example due to quality outcomes, time of day relevance to communications, and/or due to regional language aspects); a tool distribution 8834 (e.g., availability of workers to perform certain resolution actions and/or tasks thereof, for the corpus, a work group, and/or segments); a skill distribution 8836 (e.g., availability of workers to perform certain resolution actions and/or tasks thereof, for the corpus, a work group, and/or segments); a certification distribution 8838; and/or a language distribution 8840. The distributions and/or any other determinations on the platform 1202 to determine whether additional workers should be added to the corpus of freelance workers 8808 and/or freelance work group 8810 may be made at the corpus level, work group level, segment level, and/or individual worker level.

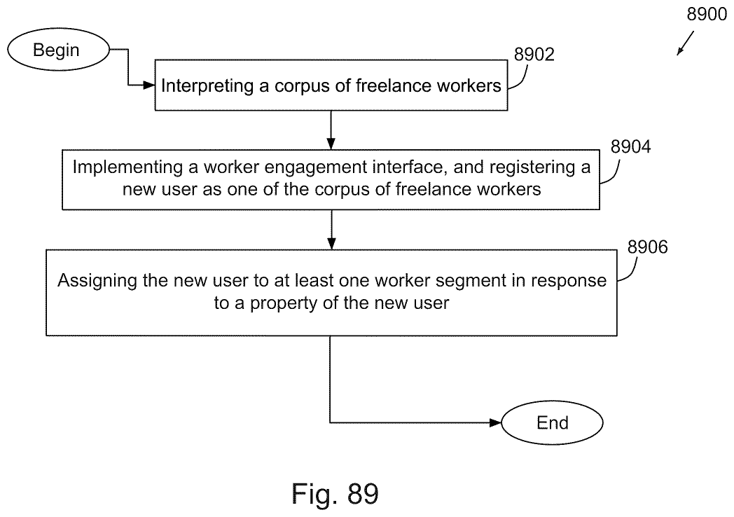

Referencing FIG. 89, an example procedure 8900 for assigning a new user to worker segments on a freelance service management platform is schematically depicted. The example procedure 8900 includes an operation 8902 to interpret a corpus of freelance workers, and an operation 8904 to implement a worker engagement interface, and to register a new user as one of the corpus of freelance workers in response to the corpus of freelance workers. In certain embodiments, operation 8902 may relate, additionally or alternatively, to a freelance worker group and/or a freelance worker segment. The example procedure 8900 includes an operation 8906 to assign the new user to at least one worker segment in response to a property of the new user (e.g., the user's skill set, certifications, capability to work with PII, tools available to the user, responsiveness of the user, desired work capacity of the user, geographic location of the user, available languages for the user, etc.).

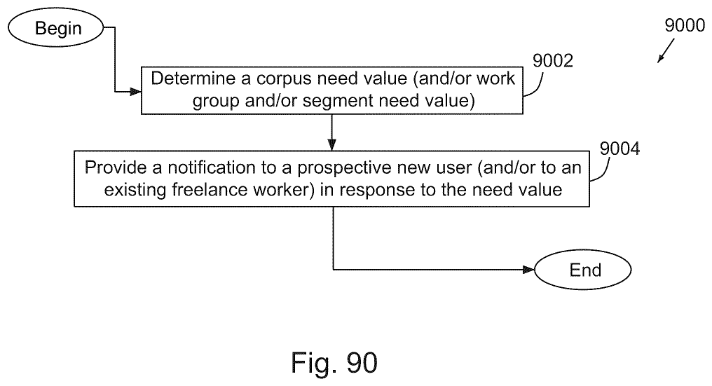

Referencing FIG. 90, an example procedure 9000 includes an operation 9002 to determine a corpus need value, for example a capability gap, KPI gap, contractual obligation gap, geographic distribution gap, certification distribution gap, language distribution gap, etc., and an operation 9004 to provide a notification to a prospective new user in response to the corpus need value. In certain embodiments, the procedure 9000 may utilize a freelance work group need value and/or worker segment need value, instead of or in addition to the corpus need value.

Referencing FIG. 91, an example system includes a freelance service management platform 1202 having a freelance worker definition component 8802 that interprets a corpus of freelance workers 8808 including a plurality of freelance workers 8812, a platform health component 9102 that interprets a crowd health value 9108 in response to the corpus of freelance workers 8808 (e.g., utilizing worker counts, worker properties, worker histories, and/or worker activity), and a platform corpus management component 9104 that performs a crowd health management operation 9106 in response to the crowd health value 9108. The freelance service management platform 1202 may interpret a differential offering scheme 9110.

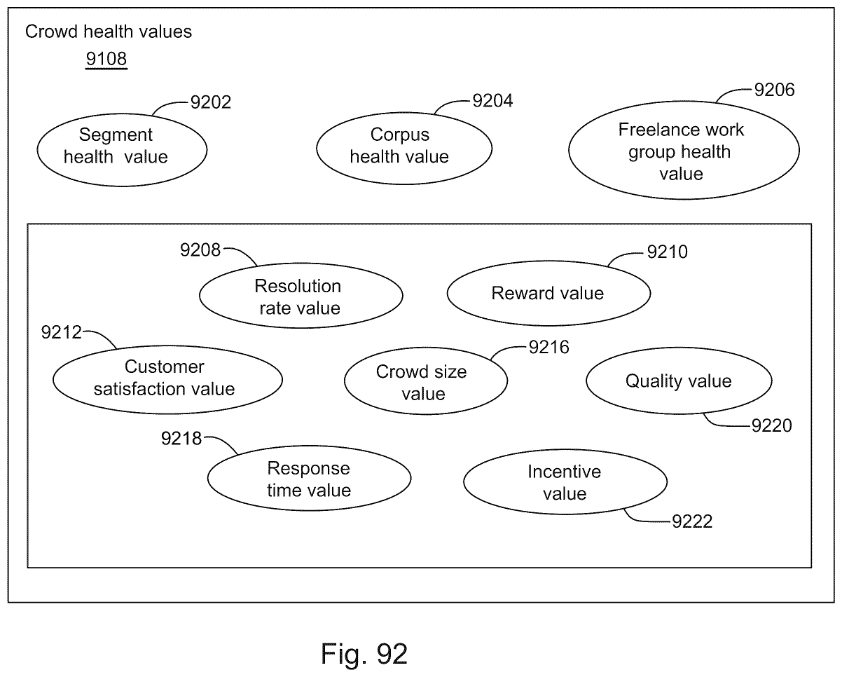

Referencing FIG. 92, example and non-limiting crowd health values 9108 are schematically depicted. The example crowd health values 9108 include a segment health value 9202 (e.g., a health value for a particular worker segment), a corpus health value 9204 (e.g., a health value for the entire platform), and/or a freelance work group health value 9206 (e.g., a health value corresponding to a particular group of workers, for example workers having a particular skill, authorization, or capability to perform certain tasks, and/or appropriate for a selected customer inquiry and/or a selected work request). In certain embodiments, a crowd health value 9108 may be directed to a particular aspect of the associated crowd (e.g., the associated segment, corpus, and/or work group), for example having distinct health values for different aspects such as quality, work rate, throughput capacity, etc., for the associated crowd. In certain embodiments, a crowd health value 9108 may be based upon observed performance (e.g., completion rate for resolution actions over a selected period of time) and/or may be based upon predicted performance (e.g., predicted completion rate for resolution actions over a selected period of time, for example based upon historical performance of the constituent freelance workers of the associated crowd). In certain embodiments, a crowd health value 9108 (and/or any other health values herein) may be quantitative (e.g., a specific number such as a rate number, a capacity number, quality score values, etc., and/or which may be an index value to allow quantitative comparisons between health states), qualitative (e.g., a crowd health name, such as good/bad, high/medium/low, etc.), and/or a combination of these. In certain embodiments, the number of health categories, the numbers utilized for quantitative health descriptions, or the like, are design choices that depend upon the purpose of utilizing the health value for the given system. For example, certain categories may be associated with different crowd health management operations 9106, certain numerical values may be utilized to perform different crowd health management operations 9106, and/or the categories and/or numerical values may be utilized to adjust crowd health management operations 9106 (e.g., to respond more strongly and/or with multiple actions based on the health category and/or numerical value). In certain embodiments, a transition or rate of change of the crowd health value 9108 may be utilized to determine and perform the crowd health management operation(s) 9106.

Example and non-limiting crowd health values 9108 include one or more aspects such as: a resolution rate value 9208, a reward value 9210, a customer satisfaction value 9212, a crowd size value 9216, a response time value 9218, a quality value 9220, and/or an incentive value 9222.

An example resolution rate value 9208 includes a rate value for the selected aspect, for example resolution action completion rate, resolution action acceptance rate, action time utilization rate (e.g., providing an overall amount of activity the associated crowd is capable of), customer messaging rate, or the like. In certain embodiments, the rate may be determined based upon the constituent freelance workers of the associated crowd (e.g., the associated segment, work group, and/or corpus), for example by adding the capabilities of the individual freelance workers in the constituency. In certain embodiments, statistical techniques may be utilized to account for variability (e.g., providing a mean and standard deviation to the individual capability of the freelance workers, and/or combined capability for sub-sets of the workers, where the variability may be managed utilizing a Monte Carlo analysis, using optimistic or pessimistic variation assumptions, or the like) and/or to account for clustering (e.g., utilizing higher granularity capability data for freelance workers, for example using hourly time buckets instead of daily buckets, and/or utilizing a Poisson distribution analysis to determine optimistic or pessimistic clustering scenarios based on individual freelance workers and/or sub-sets of the workers) of worker capabilities over time.

An example customer satisfaction value 9212 includes a description of the ability of the crowd to provide target customer satisfaction performance. The customer satisfaction value 9212 may be based on direct customer feedback (e.g., a survey and/or review provided by the customer for a particular customer inquiry and/or work request), mood values for customer communications, sentiment values for customer communications, or the like.

An example response time value 9218 includes a response time for accepting resolution actions (e.g., time from submitting the work element until a freelance worker accepts the associated resolution action), a response time for completing resolution actions (e.g., time from submitting the work element until the resolution action is completed, and/or time from acceptance of the resolution action until the resolution action is completed), and/or a response time for customer messages (e.g., response time performance for a freelance worker to respond to customer messages, for example messages exchanged during the performance of the resolution action). In certain embodiments, the response time value 9218 may be determined based on information such as that set forth to determine the resolution rate value 9208, for example if the resolution rate value 9208 is “5000 units/day”, then a useful estimate of the response time value 9218 may be 1/5000^{th} of a day, or 17.3 seconds. In certain embodiments, the response time value 9218 may be determined utilizing historical data and appropriate granularity of time buckets, which may provide a superior estimate for highly transient systems, significant variability and/or clustering in freelance worker performance, or the like. In certain embodiments, the response time value 9218 may be determined utilizing statistical techniques to account for freelance worker performance variability and/or clustering, providing a higher resolution estimate of the estimated response time for the response time value 9218.

An example crowd size value 9216 includes a number of freelance workers within a corpus, work group, or segment, where the crowd health value 9108 is determined based on the crowd size value 9216. In certain embodiments, the crowd size value 9216 may be used as the crowd health value 9108, and/or the crowd health value 9108 may be determined in response to the crowd size value 9216 (e.g., comparing the current crowd size against a target crowd size, utilizing a ratio of these, and/or utilizing a difference between these).

An example reward value 9210 includes a description of rewards paid and/or rewards that are estimated to be paid to freelance workers completing resolution actions. In certain embodiments, excessively high or low reward values 9210 may be an indicator of performance of the platform 1202 to service work elements. In certain embodiments, a comparison of the reward value 9210 to other aspects, such as the crowd size value 9216, may be utilized to determine the crowd health values 9108.

An example quality value 9220 includes a description of the quality of output for the associated crowd, for example based on response quality values 7704 for the related work elements. The response quality values 7704 may be determined as throughout the disclosure, including for example from automated reviews, peer reviews, quality reviews, customer feedback, or the like. In certain embodiments, the quality values 9220 are distinct from the customer satisfaction values 9212, even where the quality value 9220 is optionally based, at least in part, on the customer feedback.

An example incentive value 9222 includes a description of incentive payments, incentive communications, or other incentive based aspects of the platform. In certain embodiments, excessive incentive values may be an indicator of crowd health, for example where high incentives may indicate insufficient capacity to perform work elements (e.g., due to incentives utilize to motivate freelance workers to accept additional resolution actions), exceptional performance for quality, responsiveness of freelance workers to incentive levers of the platform, continuity of availability of freelance workers, and/or high predictability of freelance worker performance. Accordingly, depending on the incentive structure of the platform, and the source of incentive values and incentive communications, a high incentive value 9222 may be an indicator of high crowd health or low crowd health.

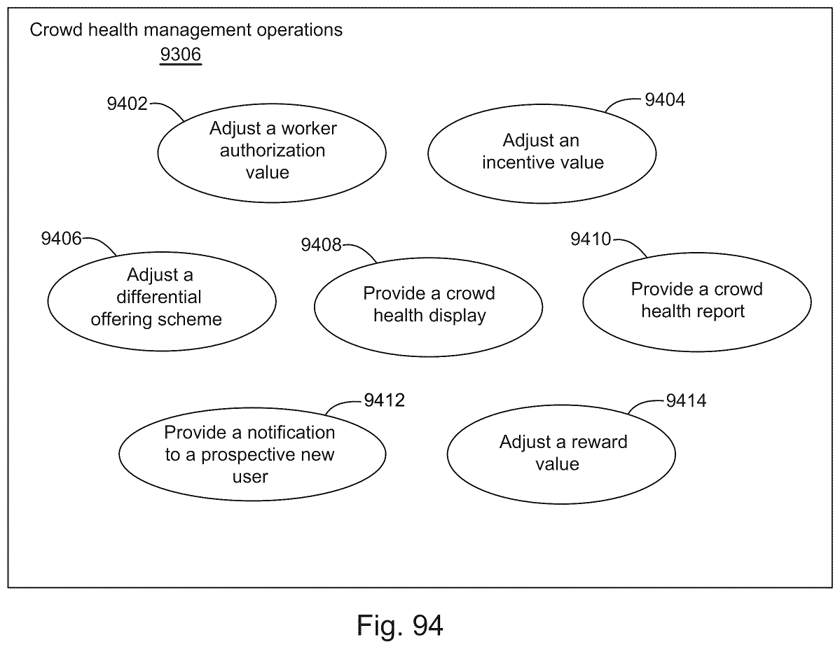

Referencing FIG. 94, an example platform corpus management component 9104 performs the crowd health management operation 9306 by performing one or more operations such as: adjusting 9402 a worker authorization value (e.g., qualifying or disqualifying a worker for resolution actions of a certain type, as a part of a freelance work group, or the like; for example to adjust the quality pool of workers, to add or remove the worker from particular work elements such as for a particular brand, etc.); adjusting a differential offering scheme 9406 (e.g., adjusting a number of segments, sequencing of offers between segments, reward differentials between segments, offering time for segments, etc.), adjusting 9404 an incentive value (e.g., adjusting rewards for high quality actions, adjusting rewards to adjust responsiveness of work groups and/or segments, adjusting rewards to attract greater capacity, providing incentive communications relevant to the freelance worker contribution to the health value, etc.); providing 9408 a crowd health display (e.g., providing an indicator of crowd health onto an interface of a monitoring user, for example an administrator of the platform 1202, an account manager, etc., where the display could be one or more charts or graphical elements on a dashboard, a numerical indicator, a message or text notifying the user of the health value and/or changes in the health value, or the like); providing a crowd health report 9410 (e.g., a display indicating the crowd health and/or elements of determining the crowd health that may be of interest, where the report may be provided in a communication, placed on the platform 1202 in a location accessible to relevant users, prepared as a document or presentation, etc.); providing 9412 a notification to a prospective new user (e.g., reference FIG. 88 and the related description); and/or adjusting 9414 a reward value (e.g., adjusting rewards to increase or decrease the capacity of the crowd). Crowd health management operations 9306 may be provided to improve the crowd health value(s) 9108, for example by increasing a capacity, throughput, responsiveness, and/or quality performance of the associated crowd, and/or to mitigate the impact of the crowd health value(s) 9108, for example by accepting a higher reward value to maintain quality until the crowd capacity can be built up to a target level.

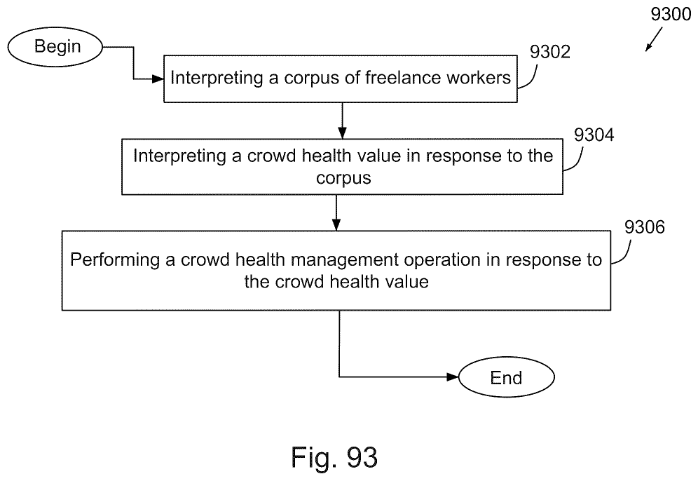

Referencing FIG. 93, an example procedure 9300 for performing a crowd health management operation is schematically depicted. The example procedure 9300 includes an operation 9302 to interpret a corpus of freelance workers, and an operation 9304 to interpret a crowd health value (e.g., for the corpus, a work group, and/or a segment) in response to the corpus of freelance workers. The example procedure 9300 includes an operation 9306 to perform a crowd health management operation in response to the crowd health value.

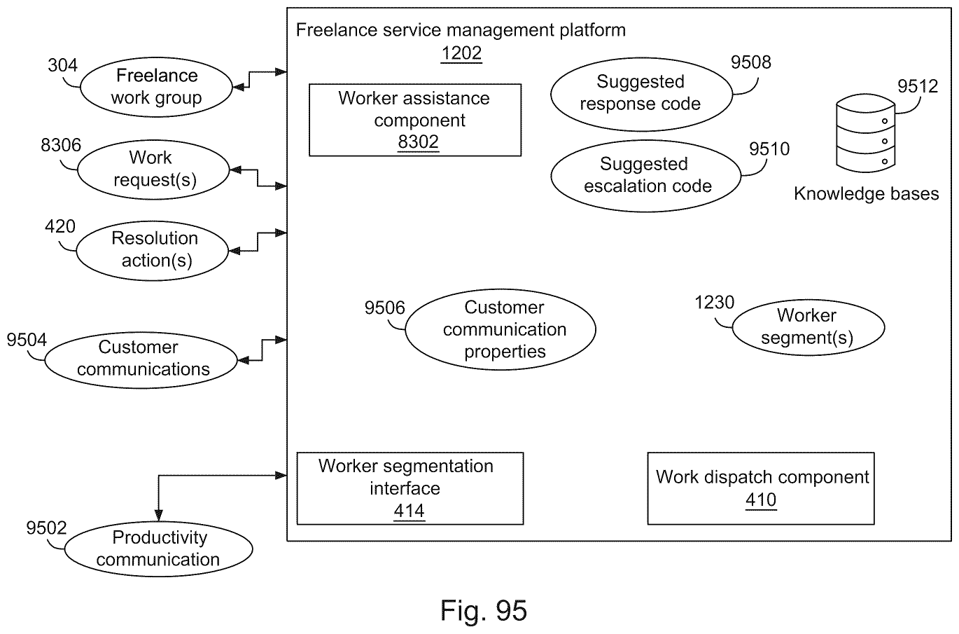

Referencing FIG. 95, an example system includes a freelance service management platform 1202 having a work dispatch component 410 that differentially offers a resolution action 420 to a customer inquiry (e.g., as a customer communication 9504) to a plurality of worker segments 1230, and repeating the differentially offering until at least one freelance worker of a plurality of freelance workers accepts the resolution action for the customer inquiry, and where the work dispatch component 410 monitors customer communications 9504 of the resolution action 420 (e.g., communications to and from the customer related to the resolution action 420); and a worker assistance component 8302 that implements a worker engagement interface 414, and provides a productivity communication 9502, to the freelance worker that accepted the resolution action 420, on the worker engagement interface 414.

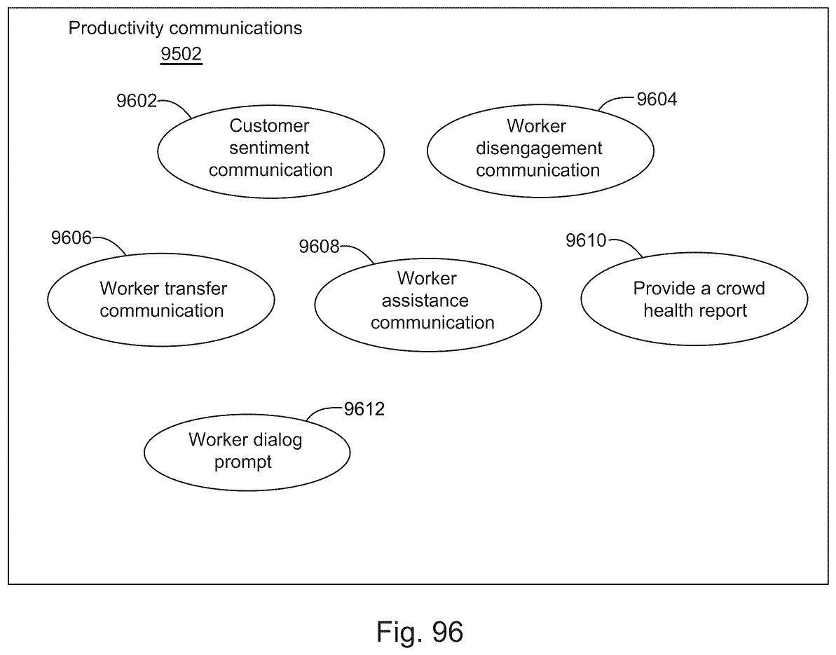

Referencing FIG. 96, example and non-limiting productivity communications 9502 are schematically depicted. An example productivity communication 9502 includes a customer sentiment communication 9602—for example an indication of a sentiment of a customer message and/or the customer inquiry (e.g., allowing the freelance worker to confirm their own assessment of the sentiment, to highlight a change in sentiment that the freelance worker may not have noticed, and/or to provide the freelance worker with additional tools to confirm sentiments where there are complicating factors for the communication such as cultural differences, dialects, second language communications for the customer or freelance worker, and/or divergent neuro processing between the customer and the freelance worker). An example productivity communication 9502 includes a worker disengagement communication 9604, for example a communication confirming that the freelance worker has discontinued work on the resolution action 420, a notification to the user that the resolution action 420 may be moved to another worker (e.g., due to a delay period, a sentiment expressed by the customer, and/or a quality value determined for a response or other task of the resolution action 420) and/or that the resolution action 420 is being moved, or has been moved, to another freelance worker. An example productivity communication 9502 includes a worker transfer communication 9606, which may be a communication to the freelance worker and/or the customer, indicating that a different freelance worker is responsible for the resolution action 420 or related tasks. An example productivity communication 9502 includes a worker assistance communication 9608, for example including relevant reference text or figures (e.g., relevant to the resolution action 420, a next task in the resolution action 420, to a question provided by the freelance worker, and/or relevant to text or other aspects of a customer communication—for example expediting access to relevant reference material, historical information relevant to the customer, word definitions, studies, reference documentation, etc.) that may be useful to the freelance worker in responding to a specific communication, completing a next task for the resolution action 420, answering a customer question, or the like. An example productivity communication 9502 includes a crowd health report 9610, for example providing an administrator with an overview of any health value aspect(s) for the platform, such as a corpus health (e.g., capacity, responsiveness, quality indicators, sufficient worker counts, etc.), a work group health (e.g., health values related to a group of workers having certain characteristics and/or qualifications to perform resolution actions for work requests of any type), and/or a worker segment health (e.g., health values related to a worker segment). In certain embodiments, the crowd health report 9610 may highlight any gaps or low health values, relevant operating conditions (e.g., low support available for certain times of the day, etc.), and/or relevant work request properties (e.g., low health values for certain types of customer inquiries, low support for a particular brand or customer, etc.). An example productivity communication 9502 includes a worker dialog prompt 9612, for example including a suggested response to a customer communication, utilization of preferred formatting or organization of responses, utilization of preferred word selection, expression of a particular mood or sentiment, utilization of a selected word sophistication level, or the like. In certain embodiments, the worker dialog prompt 9612 may include options to confirm or edit the prompt before utilization. In certain embodiments, the worker dialog prompt 9612 includes a data entry prompt for a next task of the resolution action 420, for example filling known fields of a form, suggested entries for fields or text entries, or the like. An example worker dialog prompt 9612 includes a target tone value-for example utilizing a preferred tone for the platform, the customer, a related brand or product, or the like. An example worker dialog prompt 9612 includes a target word choice value. The target tone and/or target word choice values may include any aspects such as: expressed sentiment, expressed mood, word choice selection, word sophistication selection, and/or utilization or avoidance of jargon relevant to the resolution action 420. The example worker dialog prompt 9612 reduces the chance of errors, and facilitates speed and quality for responses and execution of tasks. An example worker assistance component 8302 utilizes a selected knowledge base 9512 to determine the worker dialog prompt 9612. For example, the selected knowledge base 9512 may be a knowledge base for a particular product, brand, customer, technical skill area, certification area, risk management area (e.g., proper treatment of PII, proper safety related communications, management of personal or inadvertent communications by the customer, etc.). In certain embodiments, the selected knowledge base 9512 may be queried for related text to a topic, provide a hyper-linked browsing interface to source materials, and/or the worker assistance component 8302 may operate a large language model (LLMs) trained on the knowledge base 9512 to limit extraneous, erroneous, or hallucinated information that may result from the utilization of a more general corpus of knowledge and/or documents. In certain embodiments, complex topics having a large and specific knowledge base may benefit from operating an LLM on the knowledge base. In certain embodiments, some topics may include a knowledge base and a limited topical search and return (and/or browse) interface to the knowledge base. In certain embodiments, combinations of these may be utilized for a knowledge base, including an interface to allow the freelance worker to utilize the knowledge base 9512 selectively between rules based interactions, search and return (and/or browse) interactions, and/or LLM interactions. In certain embodiments, the productivity communication 9502 is determined in response to one or more customer communication properties 9506.

An example worker assistance component 8302 provides the productivity communication 9502 in response to a suggested response code 9508. For example, a customer communication may be classified and may have one or more customer communication properties 9506, and the suggested response may be determined according to a code for the customer communication, and a selected code (or several suggested codes) for the response. In certain embodiments, the freelance worker may select from suggested codes to generate a worker dialog prompt 9612 for a response. An example worker assistance component 8302 provides the productivity communication 9502 in response to a suggested escalation code 9510. For example, certain events such as utilization of keywords from the customer, specific customer moods or sentiments expressed in customer communications, a change in customer moods or sentiments expressed in customer communications, and/or any one or more of these expressed in communications from the freelance worker, may be utilized to determine a suggested escalation code. The example suggested escalation code(s) may be provided to the freelance worker, allowing the freelance worker to identify the potential escalation, and to rapidly respond to the escalation (e.g., tagging a resolution action 420 for further review, for transfer to a different worker, for manual management with a special or administrative worker, etc.). The example suggested escalation code(s) may be provided to another user, for example an administrator of the platform 1202, additionally or alternatively to providing the suggested escalation code(s) to the freelance worker.

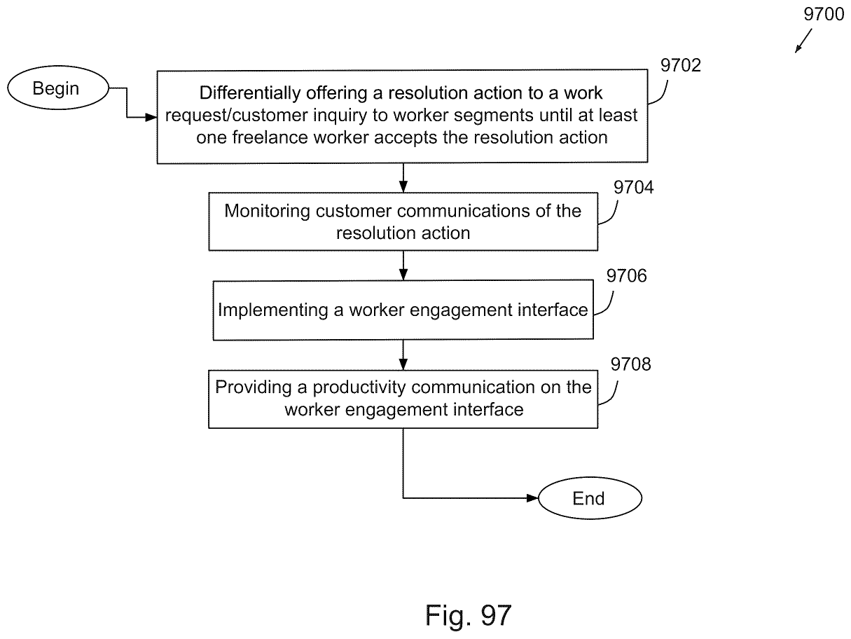

Referencing FIG. 97, an example procedure 9700 to provide a productivity communication to a freelance worker is schematically depicted. The example procedure 9700 includes an operation 9702 to differentially offer a resolution action to a work element to worker segments, and repeating the differentially offering until at least one freelance worker accepts the resolution action. The example procedure 9700 includes an operation 9704 to monitor customer communications of the resolution actions (e.g., including communications to and from the customer), an operation 9706 to implement a worker engagement interface, and an operation 9708 to provide a productivity communication on the worker engagement interface.

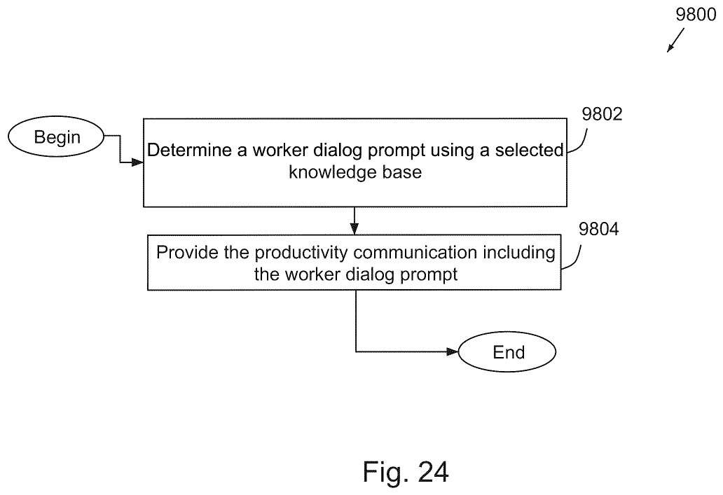

Referencing FIG. 24, an example procedure 9800 to provide a productivity communication including a worker dialog prompt is schematically depicted. The example procedure 9800 includes an operation 9802 to determine the worker dialog prompt utilizing a selected knowledge base, and an operation 9804 to provide the productivity communication including the worker dialog prompt.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems herein. The terms computer, computing device, processor, circuit, platform, component, and/or server, (“computing device”) as utilized herein, should be understood broadly.

An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general-purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

A computing device may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above, and combinations thereof, may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are intended to fall within the scope of the present disclosure.

While the disclosure has been disclosed in connection with certain embodiments shown and described in detail, various modifications and improvements thereon will become readily apparent to those skilled in the art. Accordingly, the scope of the present disclosure is not to be limited by the foregoing examples but is to be understood in the broadest sense allowable by law.

1.-51. (canceled)

52. A system, comprising:
a freelance service management platform, comprising:
a freelance worker definition component configured to interpret a freelance work group comprising a plurality of freelance workers, and a plurality of worker properties corresponding to the plurality of freelance workers;
a customer interaction component configured to implement a customer request interface, and to determine a customer inquiry in response to customer interactions with the customer request interface;
a work intake component configured to interpret the customer inquiry;
a worker segmentation component configured to determine a plurality of worker segments in response to the freelance work group, the plurality of worker properties, and the customer inquiry;
a work dispatch component configured to differentially offer a resolution action to the customer inquiry to the plurality of worker segments, and repeating the differentially offering until at least one freelance worker accepts the resolution action; and
wherein the customer interaction component is further configured to communicatively couple the customer with the at least one freelance worker that accepted the resolution action.

53. The system of claim 52, further comprising:
wherein the worker segmentation component is further configured to determine the plurality of worker segments by selecting a predetermined worker segmentation in response to a comparison of properties between a selected customer inquiry and the customer inquiry.

54. The system of claim 53, further comprising:
wherein the worker segmentation component is further configured to determine the plurality of worker segments by adjusting the predetermined worker segmentation in response to the comparison of properties between the selected customer inquiry and the customer inquiry.

55. The system of claim 52, further comprising:
wherein the worker segmentation component is further configured to determine a plurality of predetermined worker segmentations in response to properties of a plurality of selected customer inquires; and
determine the plurality of worker segments by selecting one of the plurality of predetermined worker segmentations in response to a comparison of properties between the customer inquiry and at least one of the plurality of selected customer inquiries.

56. The system of claim 55, wherein the properties of the plurality of selected customer inquiries comprise at least one of: a brand value, a worker skill value, or a tool description.

57. The system of claim 56, wherein the worker segmentation component is further configured to update the selected one of the plurality of predetermined worker segmentations in response to properties of the customer inquiry.

58. A method, comprising:
interpreting a freelance work group comprising a plurality of freelance workers, and a plurality of worker properties corresponding to the plurality of freelance workers;
implementing a customer request interface, and determining a customer inquiry in response to customer interactions with the customer request interface;
interpreting the customer inquiry;
determining a plurality of worker segments in response to the freelance work group, the plurality of worker properties, and the customer inquiry;
differentially offering a resolution action to the customer inquiry to the plurality of worker segments, and repeating the differentially offering until at least one freelance worker accepts the resolution action; and
communicatively coupling the customer with the at least one freelance worker that accepted the resolution action.

59. The method of claim 58, further comprising determining the plurality of worker segments by selecting a predetermined worker segmentation in response to a comparison of properties between a selected customer inquiry and the customer inquiry.

60. The method of claim 59, further comprising determining the plurality of worker segments by adjusting the predetermined worker segmentation in response to the comparison of properties between the selected customer inquiry and the customer inquiry.

61. The method of claim 58, further comprising:
determining a plurality of predetermined worker segmentations in response to properties of a plurality of selected customer inquires; and
determining the plurality of worker segments by selecting one of the plurality of predetermined worker segmentations in response to a comparison of properties between the customer inquiry and at least one of the plurality of selected customer inquiries.

62. The method of claim 61, further comprising updating the selected one of the plurality of predetermined worker segmentations in response to properties of the customer inquiry.

63.-298. (canceled)
